(19) United States
(12) Patent Application Publication
(10) Pub. No.: US 2024/0242100 A1
(43) Pub. Date: Jul. 18, 2024

(54) INTERLEAVING MODULE FOR FAULT-TOLERANT QUANTUM COMPUTER

(71) Applicant: Psiquantum, Corp., Palo Alto, CA (US)

(72) Inventors: Naomi Nickerson, San Francisco, CA (US); Daniel Litinski, Palo Alto, CA (US)

(73) Assignee: Psiquantum, Corp., Palo Alto, CA (US)

(21) Appl. No.: 18/274,957

(22) PCT Filed: Jan. 31, 2022
(86) PCT No.: PCT/US2022/070447

§ 371 Date: Jul. 28, 2023

Related U.S. Application Data
(60) Provisional application No. 63/143,727, filed on Jan. 29, 2021.

(51) Int. Cl. G06N 10/20; G06N 10/40

(52) U.S. Cl. CPC G06N 10/20; G06N 10/40

(57) ABSTRACT

Fusion-based quantum computations can be implemented using a network of interleaving modules. Each interleaving module can receive or produce resource states consisting of entangled physical qubits and can include a set of reconfigurable fusion circuits that can be controlled to perform either fusion operations or single qubit measurements on pairs of qubits from different resource states, routing paths connected to the reconfigurable fusion circuits, and delay lines and routing switches that operate to select routing paths for qubits of the resource states, thereby implementing a desired combination of fusion operations and single qubit measurements. The routing paths can include local routing paths that couple to reconfigurable fusion circuits in the same interleaving module and network routing paths that couple a routing switch in one interleaving module to a reconfigurable fusion circuit in a different interleaving module within the network.

### CROSS-REFERENCE TO RELATED APPLICATION

This application claims the benefit of U.S. Provisional Application No. 63/143,727, filed Jan. 29, 2021, the disclosure of which is incorporated herein by reference.

### BACKGROUND

Quantum computing is distinguished from “classical” computing by its reliance on structures referred to as “qubits.” At the most general level, a qubit is a quantum system that can exist in one of two orthogonal states (denoted as |0 [symbol] and |1 [symbol] in the conventional bra/ket notation) or in a superposition of the two states (e.g.,

$$\frac{1}{\sqrt{2}} ( \vert 0 〉 + \vert 1 〉 ) .$$

By operating on a system (or ensemble) of qubits, a quantum computer can quickly perform certain categories of computations that would require impractical amounts of time in a classical computer.

Practical realization of a quantum computer, however, remains a daunting task. One challenge is the reliable creation and entangling of qubits.

### SUMMARY

According to some embodiments, fusion-based quantum computations can be implemented using a network (also referred to as a network array) of interleaving modules. Each interleaving module can receive or produce resource states consisting of entangled physical qubits and can include a set of reconfigurable fusion circuits that can be controlled to perform either fusion operations or single qubit measurements on pairs of qubits from different resource states, routing paths connected to the reconfigurable fusion circuits, and delay lines and routing switches that operate to select routing paths for qubits of the resource states, thereby implementing a desired combination of fusion operations and single qubit measurements. The routing paths can include local routing paths that couple to reconfigurable fusion circuits in the same interleaving module and network routing paths that couple a routing switch in one interleaving module to a reconfigurable fusion circuit in a different interleaving module within the network.

The following detailed description, together with the accompanying drawings, will provide a better understanding of the nature and advantages of the claimed invention.

### BRIEF DESCRIPTION OF THE DRAWINGS

FIG. 1 shows two representations of a portion of a pair of waveguides corresponding to a dual-rail-encoded photonic qubit.

FIG. 2A shows a schematic diagram for coupling of two modes.

FIG. 2B shows, in schematic form, a physical implementation of mode coupling in a photonic system that can be used in some embodiments.

FIGS. 3A and 3B show, in schematic form, examples of physical implementations of a Mach-Zehnder Interferometer (MZI) configuration that can be used in some embodiments.

FIG. 4A shows another schematic diagram for coupling of two modes.

FIG. 4B shows, in schematic form, a physical implementation of the mode coupling of FIG. 4A in a photonic system that can be used in some embodiments.

FIG. 5 shows a four-mode coupling scheme that implements a “spreader,” or “mode-information erasure,” transformation on four modes in accordance with some embodiments.

FIG. 6 illustrates an example optical device that can implement the four-mode mode-spreading transform shown schematically in FIG. 5 in accordance with some embodiments.

FIG. 7 shows a circuit diagram for a dual-rail-encoded Bell state generator that can be used in some embodiments.

FIG. 8A shows a circuit diagram for a dual-rail-encoded type I fusion gate that can be used in some embodiments.

FIG. 8B shows example results of type I fusion operations using the gate of FIG. 8A.

FIG. 9A shows a circuit diagram for a dual-rail-encoded type II fusion gate that can be used in some embodiments.

FIG. 9B shows an example result of a type II fusion operation using the gate of FIG. 9A.

FIG. 10 illustrates an example of a qubit entangling system in accordance with some embodiments.

FIG. 11 shows an example of a resource state that can be used in some embodiments.

FIG. 12A shows an example of a fusion graph that can be used in some embodiments.

FIGS. 12B-12D shows examples of how fusion graphs (shown in FIG. 12D) can be generated from surface-code spacetime diagrams (shown in FIG. 12B) and time-slice diagrams (shown in FIG. 12C) for various logical operations on logical qubits. FIG. 12E shows a legend for the fusion-graph notation used in FIG. 12D.

FIGS. 13A-13C show views of a fusion graph representing a computation on four logical qubits according to some embodiments.

FIGS. 14A-14D show simplified schematic diagram of circuit components for an interleaving module including a reconfigurable fusion circuit according to some embodiments.

FIG. 15 shows a simplified schematic diagram of a network of unit cells according to some embodiments.

FIG. 16 shows a simplified fusion graph illustrating patch-based generation of a layer using a network of unit cells according to some embodiments.

FIG. 17 shows a simplified schematic diagram of a network of interleaving modules according to some embodiments.

FIGS. 18A and 18B show examples of assignment of interleaving coordinates to vertices within a layer of a fusion graph according to some embodiments.

FIG. 19A shows a view of a representative layer of a fusion graph, with interleaving coordinates overlaid thereon, according to some embodiments. FIG. 19B shows a detailed view of one patch of the layer shown in FIG. 19A.

FIG. 20 shows a table illustrating configuration settings for an interleaving module that can be determined from a patch of a fusion graph according to some embodiments.

FIGS. 21A and 21B show examples of fusion graphs for operations that change the lattice structure.

FIG. 22 shows a simplified schematic diagram of an interleaving module according to some embodiments.

FIG. 23A shows an example of a fusion graph for moving a logical qubit.

FIG. 23B shows a fusion graph for a more efficient implementation of moving a logical qubit.

FIG. 24 shows a simplified schematic diagram of an interleaving module according to some embodiments.

FIG. 25 shows a simplified schematic drawing of the connectivity of network paths between interleaving modules in a network array according to some embodiments.

FIGS. 26A-26D are conceptual illustrations of a toric surface code with periodic

boundary conditions.

FIG. 27 shows a simplified schematic diagram of a networked array of interleaving modules according to some embodiments.

FIG. 28 shows a simplified schematic diagram of an interleaving module according to some embodiments.

FIGS. 29A and 29B show fusion graphs for stellated surface codes.

FIGS. 30A and 30B show examples of connectivity structures for stellated surface code patches that can be implemented using a network of interleaving modules according to some embodiments.

FIG. 31 shows a simplified schematic of a networked array of interleaving modules that can be used to produce a stellated surface code according to some embodiments.

FIG. 32 shows an example system architecture for a quantum computer system that can implement FBQC according to some embodiments.

FIG. 33 shows a flow diagram of a process for operating an array of interleaving modules using classical control logic according to some embodiments.

### DETAILED DESCRIPTION

Disclosed herein are examples (also referred to as “embodiments”) of systems and methods for performing operations on ensembles of qubits based on various physical quantum systems, including photonic systems. Such embodiments can be used, for example, in quantum computing as well as in other contexts (e.g., quantum communication) that exploit quantum entanglement. To facilitate understanding of the disclosure, an overview of relevant concepts and terminology is provided in Section 1, and an overview of fusion based quantum computing (FBQC) is provided in Section 2. With this context established, Section 3 describes examples of interleaving modules according to various embodiments, and Section 4 describes examples of using a network of interleaving modules to implement FBQC. Sections 5-7 describe additional example embodiments of interleaving modules and networks of interleaving modules, and Section 8 describes an example embodiment of a computing system that can implement FBQC using a network of interleaving modules. Although embodiments are described with specific detail to facilitate understanding, those skilled in the art with access to this disclosure will appreciate that the claimed invention can be practiced without these details.

Further, embodiments are described herein as creating and operating on systems of qubits, where the quantum state space of a qubit can be modeled as a 2-dimensional vector space. Those skilled in the art with access to this disclosure will understand that techniques described herein can be applied to systems of “qudits,” where a qudit can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit.

### 1. Overview of Quantum Computing

Quantum computing relies on the dynamics of quantum objects, e.g., photons, electrons, atoms, ions, molecules, nanostructures, and the like, which follow the rules of quantum theory. In quantum theory, the quantum state of a quantum object is described by a set of physical properties, the complete set of which is referred to as a mode. In some embodiments, a mode is defined by specifying the value (or distribution of values) of one or more properties of the quantum object. For example, in the case where the quantum object is a photon, modes can be defined by the frequency of the photon, the position in space of the photon (e.g., which waveguide or superposition of waveguides the photon is propagating within), the associated direction of propagation (e.g., the k-vector for a photon in free space), the polarization state of the photon (e.g., the direction (horizontal or vertical) of the photon's electric and/or magnetic fields), a time window in which the photon is propagating, the orbital angular momentum state of the photon, and the like.

For the case of photons propagating in a waveguide, it is convenient to express the state of the photon as one of a set of discrete spatio-temporal modes. For example, the spatial mode kᵢ of the photon is determined according to which one of a finite set of discrete waveguides the photon is propagating in, and the temporal mode tⱼ is determined by which one of a set of discrete time periods (referred to herein as “bins”) the photon is present in. In some photonic implementations, the degree of temporal discretization can be provided by a pulsed laser which is responsible for generating the photons. In examples below, spatial modes will be used primarily to avoid complication of the description. However, one of ordinary skill will appreciate that the systems and methods can apply to any type of mode, e.g., temporal modes, polarization modes, and any other mode or set of modes that serves to specify the quantum state. Further, in the description that follows, embodiments will be described that employ photonic waveguides to define the spatial modes of the photon. However, persons of ordinary skill in the art with access to this disclosure will appreciate that other types of mode, e.g., temporal modes, energy states, and the like, can be used without departing from the scope of the present disclosure. In addition, persons of ordinary skill in the art will be able to implement examples using other types of quantum systems, including but not limited to other types of photonic systems.

For quantum systems of multiple indistinguishable particles, rather than describing the quantum state of each particle in the system, it is useful to describe the quantum state of the entire many-body system using the formalism of Fock states (sometimes referred to as the occupation number representation). In the Fock state description, the many-body quantum state is specified by how many particles there are in each mode of the system. For example, a multi-mode, two particle Fock state |1001 [symbol] _{1,2,3,4} specifies a two-particle quantum state with one particle in mode 1, zero particles in mode 2, zero particles in mode 3, and one particle in mode 4. Again, as introduced above, a mode can be any property of the quantum object. For the case of a photon, any two modes of the electromagnetic field can be used, e.g., one may design the system to use modes that are related to a degree of freedom that can be manipulated passively with linear optics. For example, polarization, spatial degree of freedom, or angular momentum could be used. The four-mode system represented by the two-particle Fock state |1001 [symbol] _{1,2,3,4} can be physically implemented as four distinct waveguides with two of the four waveguides having one photon travelling within them. Other examples of a state of such a many-body quantum system include the four-particle Fock state |1111 [symbol] _{1,2,3,4} that represents each mode occupied by one particle and the four-particle Fock state |2200 [symbol] _{1,2,3,4} that represents modes 1 and 2 respectively occupied by two particles and modes 3 and 4 occupied by zero particles. For modes having zero particles present, the term “vacuum mode” is used. For example, for the four-particle Fock state |2200 [symbol] _{1,2,3,4} modes 3 and 4 are referred to herein as “vacuum modes.” Fock states having a single occupied mode can be represented in shorthand using a subscript to identify the occupied mode. For example, |0010 [symbol] _{1,2,3,4} is equivalent to |1₃ [symbol] .

### 1.1. Qubits

As used herein, a “qubit” (or quantum bit) is a quantum system with an associated quantum state that can be used to encode information. A quantum state can be used to encode one bit of information if the quantum state space can be modeled as a (complex) two-dimensional vector space, with one dimension in the vector space being mapped to logical value 0 and the other to logical value 1. In contrast to classical bits, a qubit can have a state that is a superposition of logical values 0 and 1. More generally, a “qudit” can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit. Qubits (or qudits) can be implemented in a variety of quantum systems. Examples of qubits include: polarization states of photons; presence of photons in waveguides; or energy states of molecules, atoms, ions, nuclei, or photons. Other examples include other engineered quantum systems such as flux qubits, phase qubits, or charge qubits (e.g., formed from a superconducting Josephson junction); topological qubits (e.g., Majorana fermions); or spin qubits formed from vacancy centers (e.g., nitrogen vacancies in diamond).

A qubit can be “dual-rail encoded” such that the logical value of the qubit is encoded by occupation of one of two modes of the quantum system. For example, the logical 0 and 1 values can be encoded as follows:

$${{\vert 0 〉}_{L} = \vert 10 〉}_{1 , 2} \qquad ( 1 )$$

$${{\vert 1 〉}_{L} = \vert 01 〉}_{1 , 2} \qquad ( 2 )$$

where the subscript “L” indicates that the ket represents a logical state (e.g., a qubit value) and, as before, the notation |ij [symbol] _{1,2} on the right-hand side of the equations above indicates that there are i particles in a first mode and j particles in a second mode, respectively (e.g., where i and j are integers). In this notation, a two-qubit system having a logical state |0 [symbol] |1 [symbol] _{L} (representing a state of two qubits, the first qubit being in a ‘0’ logical state and the second qubit being in a ‘1’ logical state) may be represented using occupancy across four modes by |1001 [symbol] _{1,2,3,4} (e.g., in a photonic system, one photon in a first waveguide, zero photons in a second waveguide, zero photons in a third waveguide, and one photon in a fourth waveguide). In some instances throughout this disclosure, the various subscripts are omitted to avoid unnecessary mathematical clutter.

### 1.2. Entangled States

Many of the advantages of quantum computing relative to “classical” computing (e.g., conventional digital computers using binary logic) stem from the ability to create entangled states of multi-qubit systems. In mathematical terms, a state |ψ [symbol] of n quantum objects is a separable state if |ψ [symbol] =|ψ₁ [symbol] ⊗ . . . ⊗|ψₙ [symbol] , and an entangled state is a state that is not separable. One example is a Bell state, which, loosely speaking, is a type of maximally entangled state for a two-qubit system, and qubits in a Bell state may be referred to as a Bell pair. For example, for qubits encoded by single photons in pairs of modes (a dual-rail encoding), examples of Bell states include:

$$\vert {Φ}^{+} 〉 = \frac{{{{{\vert 0 〉}_{L} \vert 0 〉}_{L} + \vert 1 〉}_{L} \vert 1 〉}_{L}}{\sqrt{2}} = \frac{\vert 10 〉 \vert 10 〉 + \vert 01 〉 \vert 01 〉}{\sqrt{2}} \qquad ( 3 )$$

$$\vert {Φ}^{-} 〉 = \frac{{{{{\vert 0 〉}_{L} \vert 0 〉}_{L} - \vert 1 〉}_{L} \vert 1 〉}_{L}}{\sqrt{2}} = \frac{\vert 10 〉 \vert 10 〉 - \vert 01 〉 \vert 01 〉}{\sqrt{2}} \qquad ( 4 )$$

$$\vert {Ψ}^{+} 〉 = \frac{{{{{\vert 0 〉}_{L} \vert 1 〉}_{L} + \vert 1 〉}_{L} \vert 0 〉}_{L}}{\sqrt{2}} = \frac{\vert 10 〉 \vert 01 〉 + \vert 01 〉 \vert 10 〉}{\sqrt{2}} \qquad ( 5 )$$

$$\vert {Ψ}^{-} 〉 = \frac{{{{{\vert 0 〉}_{L} \vert 1 〉}_{L} - \vert 1 〉}_{L} \vert 0 〉}_{L}}{\sqrt{2}} = \frac{\vert 10 〉 \vert 01 〉 - \vert 01 〉 \vert 10 〉}{\sqrt{2}} \qquad ( 6 )$$

More generally, an n-qubit Greenberger-Horne-Zeilinger (GHZ) state (or “n-GHZ state”) is an entangled quantum state of n qubits. For a given orthonormal logical basis, an n-GHZ state is a quantum superposition of all qubits being in a first basis state superposed with all qubits being in a second basis state:

$$\vert GHZ 〉 = \frac{{{\vert 0 〉}^{⊗ M} + \vert 1 〉}^{⊗ M}}{\sqrt{2}} \qquad ( 7 )$$

where the kets above refer to the logical basis. For example, for qubits encoded by single photons in pairs of modes (a dual-rail encoding), a 3-GHZ state can be written:

$$\vert GHZ 〉 = \frac{{{{{{{\vert 0 〉}_{L} \vert 0 〉}_{L} \vert 0 〉}_{L} - \vert 1 〉}_{L} \vert 1 〉}_{L} \vert 1 〉}_{L}}{\sqrt{2}} = \frac{\vert 10 〉 \vert 10 〉 \vert 10 〉 + \vert 01 〉 \vert 01 〉 \vert 01 〉}{\sqrt{2}} \qquad ( 8 )$$

where the kets above refer to photon occupation number in six respective modes (with mode subscripts omitted).

### 1.3. Physical Implementations

Qubits (and operations on qubits) can be implemented using a variety of physical systems. In some examples described herein, qubits are provided in an integrated photonic system employing waveguides, beam splitters, photonic switches, and single photon detectors, and the modes that can be occupied by photons are spatiotemporal modes that correspond to presence of a photon in a waveguide. Modes can be coupled using mode couplers, e.g., optical beam splitters, to implement transformation operations, and measurement operations can be implemented by coupling single-photon detectors to specific waveguides. One of ordinary skill in the art with access to this disclosure will appreciate that modes defined by any appropriate set of degrees of freedom, e.g., polarization modes, temporal modes, and the like, can be used without departing from the scope of the present disclosure. For instance, for modes that only differ in polarization (e.g., horizontal (H) and vertical (V)), a mode coupler can be any optical element that coherently rotates polarization, e.g., a birefringent material such as a waveplate. For other systems such as ion trap systems or neutral atom systems, a mode coupler can be any physical mechanism that can couple two modes, e.g., a pulsed electromagnetic field that is tuned to couple two internal states of the atom/ion.

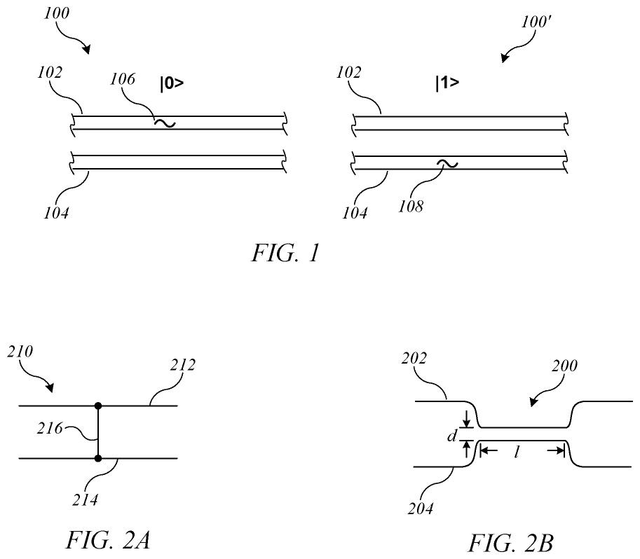

In some embodiments of a photonic quantum computing system using dual-rail encoding, a qubit can be implemented using a pair of waveguides. FIG. 1 shows two representations (100, 100′) of a portion of a pair of waveguides 102, 104 that can be used to provide a dual-rail-encoded photonic qubit. At 100, a photon 106 is in waveguide 102 and no photon is in waveguide 104 (also referred to as a vacuum mode); in some embodiments, this corresponds to the |0 [symbol] _{L} state of a photonic qubit. At 100′, a photon 108 is in waveguide 104, and no photon is in waveguide 102; in some embodiments this corresponds to the |1 [symbol] _{L} state of the photonic qubit. To prepare a photonic qubit in a known logical state, a photon source (not shown) can be coupled to one end of one of the waveguides. The photon source can be operated to emit a single photon into the waveguide to which it is coupled, thereby preparing a photonic qubit in a known state. Photons travel through the waveguides, and by periodically operating the photon source, a quantum system having qubits whose logical states map to different temporal modes of the photonic system can be created in the same pair of waveguides. In addition, by providing multiple pairs of waveguides, a quantum system having qubits whose logical states correspond to different spatiotemporal modes can be created. It should be understood that the waveguides in such a system need not have any particular spatial relationship to each other. For instance, they can be but need not be arranged in parallel.

Occupied modes can be created by using a photon source to generate a photon that then propagates in the desired waveguide. A photon source can be, for instance, a resonator-based source that emits photon pairs, also referred to as a heralded single photon source. In one example of such a source, the source is driven by a pump, e.g., a light pulse, that is coupled into a system of optical resonators that, through a nonlinear optical process (e.g., spontaneous four wave mixing (SFWM), spontaneous parametric down-conversion (SPDC), second harmonic generation, or the like), can generate a pair of photons. Many different types of photon sources can be employed. Examples of photon pair sources can include a microring-based spontaneous four wave mixing (SPFW) heralded photon source (HPS). However, the precise type of photon source used is not critical and any type of nonlinear source, employing any process, such as SPFW, SPDC, or any other process can be used. Other classes of sources that do not necessarily require a nonlinear material can also be employed, such as those that employ atomic and/or artificial atomic systems, e.g., quantum dot sources, color centers in crystals, and the like. In some cases, sources may or may not be coupled to photonic cavities, e.g., as can be the case for artificial atomic systems such as quantum dots coupled to cavities. Other types of photon sources also exist for SPWM and SPDC, such as optomechanical systems and the like.

In such cases, operation of the photon source may be non-deterministic (also sometimes referred to as “stochastic”) such that a given pump pulse may or may not produce a photon pair. In some embodiments, coherent spatial and/or temporal multiplexing of several non-deterministic sources (referred to herein as “active” multiplexing) can be used to allow the probability of having one mode become occupied during a given cycle to approach 1. One of ordinary skill will appreciate that many different active multiplexing architectures that incorporate spatial and/or temporal multiplexing are possible. For instance, active multiplexing schemes that employ log-tree, generalized Mach-Zehnder interferometers, multimode interferometers, chained sources, chained sources with dump-the-pump schemes, asymmetric multi-crystal single photon sources, or any other type of active multiplexing architecture can be used. In some embodiments, the photon source can employ an active multiplexing scheme with quantum feedback control and the like.

Measurement operations can be implemented by coupling a waveguide to a single-photon detector that generates a classical signal (e.g., a digital logic signal) indicating that a photon has been detected by the detector. Any type of photodetector that has sensitivity to single photons can be used. In some embodiments, detection of a photon (e.g., at the output end of a waveguide) indicates an occupied mode while absence of a detected photon can indicate an unoccupied mode.

Some embodiments described below relate to physical implementations of unitary transform operations that couple modes of a quantum system, which can be understood as transforming the quantum state of the system. For instance, if the initial state of the quantum system (prior to mode coupling) is one in which one mode is occupied with probability 1 and another mode is unoccupied with probability 1 (e.g., a state |10 [symbol] in the Fock notation introduced above), mode coupling can result in a state in which both modes have a nonzero probability of being occupied, e.g., a state α₁|10 [symbol] +α2|01 [symbol] , where |α₁|²+|α₂|²=1. In some embodiments, operations of this kind can be implemented by using beam splitters to couple modes together and variable phase shifters to apply phase shifts to one or more modes. The amplitudes α₁ and α₂ depend on the reflectivity (or transmissivity) of the beam splitters and on any phase shifts that are introduced.

FIG. 2A shows a schematic diagram 210 (also referred to as a circuit diagram or circuit notation) for coupling of two modes. The modes are drawn as horizontal lines 212, 214, and the mode coupler 216 is indicated by a vertical line that is terminated with nodes (solid dots) to identify the modes being coupled. In the more specific language of linear quantum optics, the mode coupler 216 shown in FIG. 2A represents a 50/50 beam splitter that implements a transfer matrix:

$$T = \frac{1}{\sqrt{2}} ( \begin{matrix}1 & i \\ i & 1\end{matrix} ) , \qquad ( 9 )$$

where T defines the linear map for the photon creation operators on two modes. (In certain contexts, transfer matrix T can be understood as implementing a first-order imaginary Hadamard transform.) By convention the first column of the transfer matrix corresponds to creation operators on the top mode (referred to herein as mode 1, labeled as horizontal line 212), and the second column corresponds to creation operators on the second mode (referred to herein as mode 2, labeled as horizontal line 214), and so on if the system includes more than two modes. More explicitly, the mapping can be written as:

$${( \begin{matrix}{a}_{1}^{†} \\ {a}_{2}^{†}\end{matrix} )}_{input} ↦ \frac{1}{\sqrt{2}} ( \begin{matrix}1 & - i \\ - i & 1\end{matrix} ) {( \begin{matrix}{a}_{1}^{†} \\ {a}_{2}^{†}\end{matrix} )}_{output} , \qquad ( 10 )$$

where subscripts on the creation operators indicate the mode that is operated on, the subscripts input and output identify the form of the creation operators before and after the beam splitter, respectively and where:

$${a}_{i} \vert {n}_{i} , {n}_{j} 〉 = \sqrt{{n}_{i}} \vert {n}_{i} - 1 , {n}_{j} 〉 \qquad ( 11 )$$

$${a}_{j} \vert {n}_{i} , {n}_{j} 〉 = \sqrt{{n}_{j}} \vert {n}_{i} , {n}_{j} - 1 〉$$

$${a}_{j}^{†} \vert {n}_{i} , {n}_{j} 〉 = \sqrt{{n}_{j} + 1} \vert {n}_{i} , {n}_{j} + 1 〉$$

For example, the application of the mode coupler shown in FIG. 2A leads to the following mappings:

$${{a}_{1}^{†}}_{input} ↦ \frac{1}{\sqrt{2}} ( {{a}_{1}^{†}}_{output} - {{a}_{2}^{†}}_{output} ) \qquad ( 12 )$$

$${{a}_{2}^{†}}_{input} ↦ \frac{1}{\sqrt{2}} ( - i {{a}_{1}^{†}}_{output} + {{a}_{2}^{†}}_{output} )$$

Thus, the action of the mode coupler described by Eq. (9) is to take the input states |10 [symbol] , |01 [symbol] , and |11 [symbol] to

$$\vert 10 〉 ↦ \frac{\vert 10 〉 - i \vert 01 〉}{\sqrt{2}} \qquad ( 13 )$$

$$\vert 01 〉 ↦ \frac{- i \vert 10 〉 + \vert 01 〉}{\sqrt{2}}$$

$$\vert 11 〉 ↦ \frac{- i}{2} ( \vert 20 〉 + \vert 02 〉 )$$

FIG. 2B shows a physical implementation of a mode coupling that implements the transfer matrix T of Eq. (9) for two photonic modes in accordance with some embodiments. In this example, the mode coupling is implemented using a waveguide beam splitter 200, also sometimes referred to as a directional coupler or mode coupler. Waveguide beam splitter 200 can be realized by bringing two waveguides 202, 204 into close enough proximity that the evanescent field of one waveguide can couple into the other. By adjusting the separation d between waveguides 202, 204 and/or the length l of the coupling region, different couplings between modes can be obtained. In this manner, a waveguide beam splitter 200 can be configured to have a desired transmissivity. For example, the beam splitter can be engineered to have a transmissivity equal to 0.5 (i.e., a 50/50 beam splitter for implementing the specific form of the transfer matrix T introduced above). If other transfer matrices are desired, the reflectivity (or the transmissivity) can be engineered to be greater than 0.6, greater than 0.7, greater than 0.8, or greater than 0.9 without departing from the scope of the present disclosure.

In addition to mode coupling, some unitary transforms may involve phase shifts applied to one or more modes. In some photonic implementations, variable phase-shifters can be implemented in integrated circuits, providing control over the relative phases of the state of a photon spread over multiple modes. Examples of transfer matrices that define such a phase shifts are given by (for applying a +i and −i phase shift to the second mode, respectively):

$$s = ( \begin{matrix}1 & 0 \\ 0 & i\end{matrix} ) \qquad ( 14 )$$

$${s}^{†} = ( \begin{matrix}1 & 0 \\ 0 & - i\end{matrix} )$$

For silica-on-silicon materials some embodiments implement variable phase-shifters using thermo-optical switches. The thermo-optical switches use resistive elements fabricated on the surface of the chip, that via the thermo-optical effect can provide a change of the refractive index n by raising the temperature of the waveguide by an amount of the order of 10⁻⁵ K. One of skill in the art with access to the present disclosure will understand that any effect that changes the refractive index of a portion of the waveguide can be used to generate a variable, electrically tunable, phase shift. For example, some embodiments use beam splitters based on any material that supports an electro-optic effect, so-called χ² and χ³ materials such as lithium niobite, BBO, KTP, and the like and even doped semiconductors such as silicon, germanium, and the like.

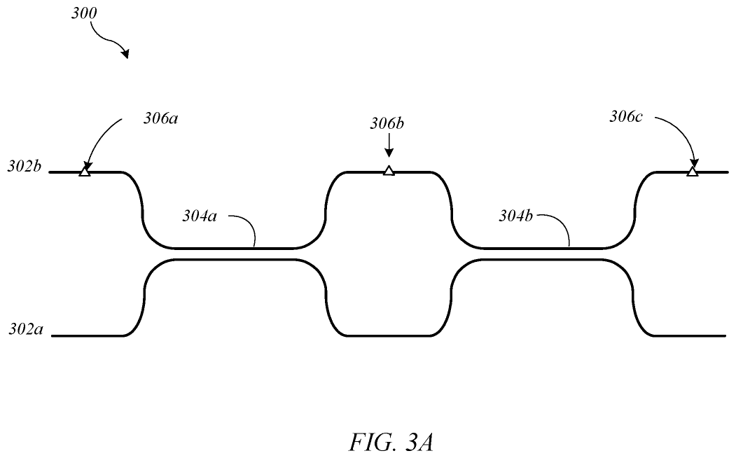

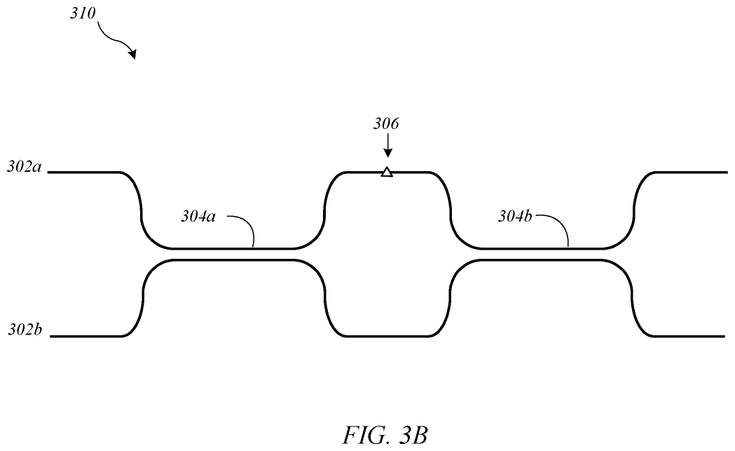

Beam-splitters with variable transmissivity and arbitrary phase relationships between output modes can also be achieved by combining directional couplers and variable phase-shifters in a Mach-Zehnder Interferometer (MZI) configuration 300, e.g., as shown in FIG. 3A. Complete control over the relative phase and amplitude of the two modes 302a, 302b in dual rail encoding can be achieved by varying the phases imparted by phase shifters 306a, 306b, and 306c and the length and proximity of coupling regions 304a and 304b. FIG. 3B shows a slightly simpler example of a MZI 310 that allows for a variable transmissivity between modes 302a, 302b by varying the phase imparted by the phase shifter 306. FIGS. 3A and 3B are examples of how one could implement a mode coupler in a physical device, but any type of mode coupler/beam splitter can be used without departing from the scope of the present disclosure.

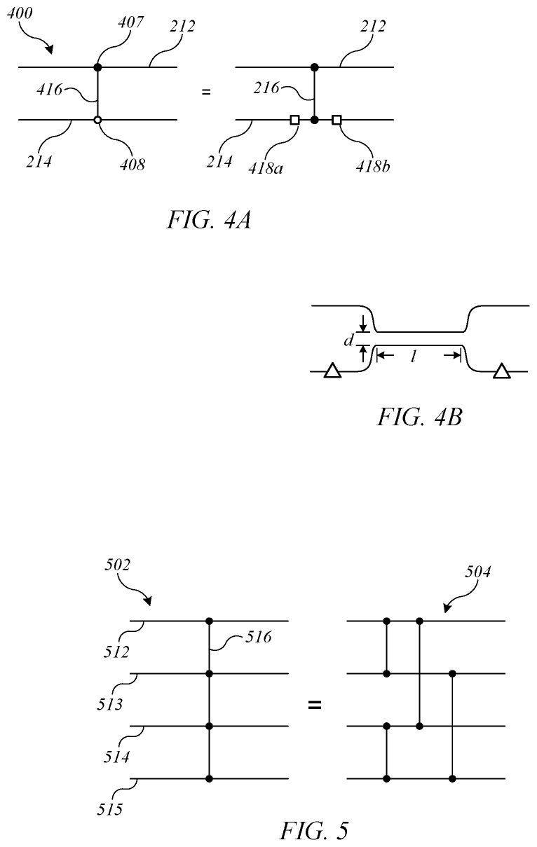

In some embodiments, beam splitters and phase shifters can be employed in combination to implement a variety of transfer matrices. For example, FIG. 4A shows, in a schematic form similar to that of FIG. 2A, a mode coupler 400 implementing the following transfer matrix:

$${T}_{r} = \frac{1}{\sqrt{2}} ( \begin{matrix}1 & 1 \\ 1 & - 1\end{matrix} ) . \qquad ( 15 )$$

Thus, mode coupler 400 applies the following mappings:

$$\vert 10 〉 ↦ \frac{\vert 10 〉 + \vert 01 〉}{\sqrt{2}} \qquad ( 16 )$$

$$\vert 01 〉 ↦ \frac{\vert 10 〉 - \vert 01 〉}{\sqrt{2}}$$

$$\vert 11 〉 ↦ \frac{1}{2} ( \vert 20 〉 + \vert 02 〉 ) .$$

The transfer matrix Tᵣ of Eq. (15) is related to the transfer matrix T of Eq. (9) by a phase shift on the second mode. This is schematically illustrated in FIG. 4A by the closed node 407 where mode coupler 416 couples to the first mode (line 212) and open node 408 where mode coupler 416 couples to the second mode (line 214). More specifically, Tᵣ=sTs, and, as shown at the right-hand side of FIG. 4A, mode coupler 416 can be implemented using mode coupler 216 (as described above), with a preceding and following phase shift (denoted by open squares 418a, 418b). Thus, the transfer matrix Tᵣ can be implemented by the physical beam splitter shown in FIG. 4B, where the open triangles represent +i phase shifters.

Similarly, networks of mode couplers and phase shifters can be used to implement couplings among more than two modes. For example, FIG. 5 shows a four-mode coupling scheme that implements a “spreader,” or “mode-information erasure,” transformation on four modes, i.e., it takes a photon in any one of the input modes and delocalizes the photon amongst each of the four output modes such that the photon has equal probability of being detected in any one of the four output modes. (The well-known Hadamard transformation is one example of a spreader transformation.) As in FIG. 2A, the horizontal lines 512-515 correspond to modes, and the mode coupling is indicated by a vertical line 516 with nodes (dots) to identify the modes being coupled. In this case, four modes are coupled. Circuit notation 502 is an equivalent representation to circuit diagram 504, which is a network of first-order mode couplings. More generally, where a higher-order mode coupling can be implemented as a network of first-order mode couplings, a circuit notation similar to notation 502 (with an appropriate number of modes) may be used.

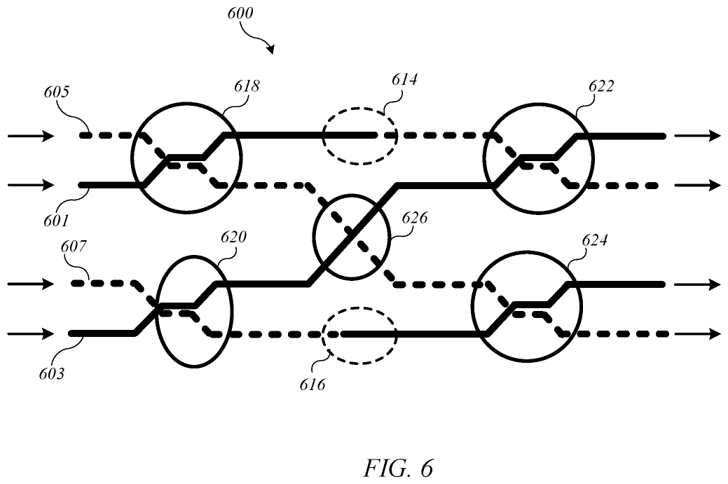

FIG. 6 illustrates an example optical device 600 that can implement the four-mode mode-spreading transform shown schematically in FIG. 5 in accordance with some embodiments. Optical device 600 includes a first set of optical waveguides 601, 603 formed in a first layer of material (represented by solid lines in FIG. 6) and a second set of optical waveguides 605, 607 formed in a second layer of material that is distinct and separate from the first layer of material (represented by dashed lines in FIG. 6). The second layer of material and the first layer of material are located at different heights on a substrate. One of ordinary skill will appreciate that an interferometer such as that shown in FIG. 6 could be implemented in a single layer if appropriate low loss waveguide crossing were employed.

At least one optical waveguide 601, 603 of the first set of optical waveguides is coupled with an optical waveguide 605, 607 of the second set of optical waveguides with any type of suitable optical coupler, e.g., the directional couplers described herein (e.g., the optical couplers shown in FIGS. 2B, 3A, 3B). For example, the optical device shown in FIG. 6 includes four optical couplers 618, 620, 622, and 624. Each optical coupler can have a coupling region in which two waveguides propagate in parallel. Although the two waveguides are illustrated in FIG. 6 as being offset from each other in the coupling region, the two waveguides may be positioned directly above and below each other in the coupling region without offset. In some embodiments, one or more of the optical couplers 618, 620, 622, and 624 are configured to have a coupling efficiency of approximately 50% between the two waveguides (e.g., a coupling efficiency between 49% and 51%, a coupling efficiency between 49.9% and 50.1%, a coupling efficiency between 49.99% and 50.01%, and a coupling efficiency of 50%, etc.). For example, the length of the two waveguides, the refractive indices of the two waveguides, the widths and heights of the two waveguides, the refractive index of the material located between two waveguides, and the distance between the two waveguides are selected to provide the coupling efficiency of 50% between the two waveguides. This allows the optical coupler to operate like a 50/50 beam splitter.

In addition, the optical device shown in FIG. 6 can include two inter-layer optical couplers 614 and 616. Optical coupler 614 allows transfer of light propagating in a waveguide on the first layer of material to a waveguide on the second layer of material, and optical coupler 616 allows transfer of light propagating in a waveguide on the second layer of material to a waveguide on the first layer of material. The optical couplers 614 and 616 allow optical waveguides located in at least two different layers to be used in a multi-channel optical coupler, which, in turn, enables a compact multi-channel optical coupler.

Furthermore, the optical device shown in FIG. 6 includes a non-coupling waveguide crossing region 626. In some implementations, the two waveguides (603 and 605 in this example) cross each other without having a parallel coupling region present at the crossing in the non-coupling waveguide crossing region 626 (e.g., the waveguides can be two straight waveguides that cross each other at a nearly 90-degree angle).

Those skilled in the art will understand that the foregoing examples are illustrative and that photonic circuits using beam splitters and/or phase shifters can be used to implement many different transfer matrices, including transfer matrices for real and imaginary Hadamard transforms of any order, discrete Fourier transforms, and the like. One class of photonic circuits, referred to herein as “spreader” or “mode-information erasure (MIE)” circuits, has the property that if the input is a single photon localized in one input mode, the circuit delocalizes the photon amongst each of a number of output modes such that the photon has equal probability of being detected in any one of the output modes. Examples of spreader or MIE circuits include circuits implementing Hadamard transfer matrices. (It is to be understood that spreader or MIE circuits may receive an input that is not a single photon localized in one input mode, and the behavior of the circuit in such cases depends on the particular transfer matrix implemented.) In other instances, photonic circuits can implement other transfer matrices, including transfer matrices that, for a single photon in one input mode, provide unequal probability of detecting the photon in different output modes.

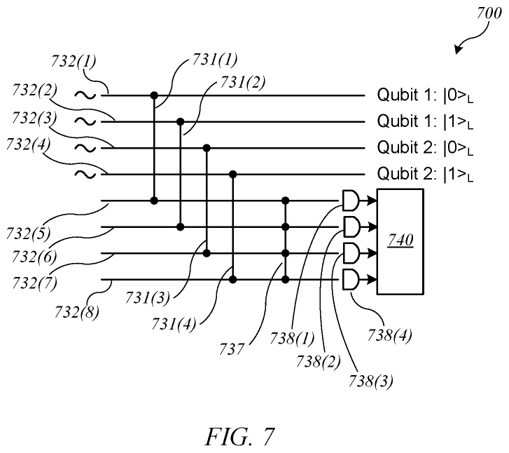

In some embodiments, entangled states of multiple photonic qubits can be created by coupling modes of two (or more) qubits and performing measurements on other modes. By way of example, FIG. 7 shows a circuit diagram for a Bell state generator 700 that can be used in some dual-rail-encoded photonic embodiments. In this example, modes 732(1)-732(4) are initially each occupied by a photon (indicated by a wavy line); modes 732(5)-732(8) are initially vacuum modes. (Those skilled in the art will appreciate that other combinations of occupied and unoccupied modes can be used.)

A first-order mode coupling (e.g., implementing transfer matrix T of Eq. (9)) is performed on pairs of occupied and unoccupied modes as shown by mode couplers 731(1)-731(4). Thereafter, a mode-information erasure coupling (e.g., implementing a four-mode mode spreading transform as shown in FIG. 5) is performed on four of the modes (modes 732(5)-732(8)), as shown by mode coupler 737. Modes 732(5)-732(8) act as “heralding” modes that are measured and used to determine whether a Bell state was successfully generated on the other four modes 732(1)-732(4). For instance, detectors 738(1)-738(4) can be coupled to the modes 732(5)-732(8) after second-order mode coupler 737. Each detector 738(1)-738(4) can output a classical data signal (e.g., a voltage level on a conductor) indicating whether it detected a photon (or the number of photons detected). These outputs can be coupled to classical decision logic circuit 740, which determines whether a Bell state is present on the other four modes 732(1)-732(4). For example, decision logic circuit 740 can be configured such that a Bell state is confirmed (also referred to as “success” of the Bell state generator) if and only if a single photon was detected by each of exactly two of detectors 738(1)-738(4). Modes 732(1)-732(4) can be mapped to the logical states of two qubits (Qubit 1 and Qubit 2), as indicated in FIG. 7. Specifically, in this example, the logical state of Qubit 1 is based on occupancy of modes 732(1) and 732(2), and the logical state of Qubit 2 is based on occupancy of modes 732(3) and 732(4). It should be noted that the operation of Bell state generator 700 can be non-deterministic; that is, inputting four photons as shown does not guarantee that a Bell state will be created on modes 732(1)-732(4). In one implementation, the probability of success is 4/32.

In some embodiments, it is desirable to form quantum systems of multiple entangled qubits (two or more qubits). One technique for forming multi-qubit quantum systems is through the use of an entangling measurement, which is a projective measurement that can be employed to create entanglement between systems of qubits. As used herein, “fusion” (or “a fusion operation” or “fusing”) refers to a projective entangling measurement. A “fusion gate” is a structure that receives two (or more) input qubits, each of which is typically part of a different quantum system. Prior to applying the fusion gate, the different quantum systems need not be entangled with each other. In the case of two input qubits, the fusion gate performs a projective measurement operation on the input qubits that produces either one (“type I fusion”) or zero (“type II fusion”) output qubits in a manner such that the initial two quantum systems are fused into a single quantum system of entangled qubits. Fusion gates are specific examples of a general class of projective entangling measurements and are particularly suited for photonic architectures. Examples of type I and type II fusion gates will now be described.

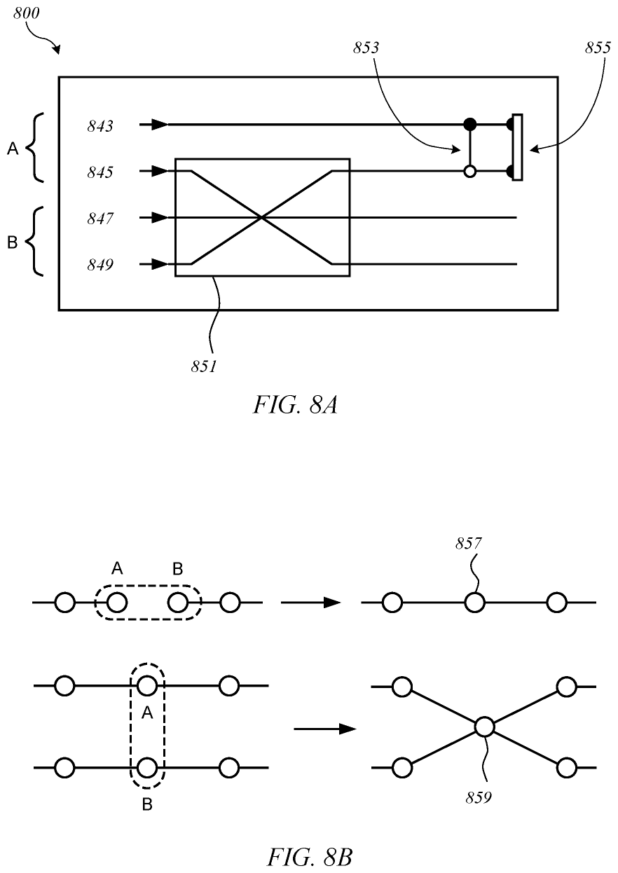

FIG. 8A shows a circuit diagram illustrating a type I fusion gate 800 in accordance with some embodiments. The diagram shown in FIG. 8A is schematic with each horizontal line representing a mode of a quantum system, e.g., a photon. In a dual-rail encoding, each pair of modes represents a qubit. In a photonic implementation of the gate the modes in diagrams such as that shown in FIG. 8A can be physically realized using single photons in photonic waveguides. Most generally, a type I fusion gate like that shown in FIG. 8A takes qubit A (physically realized, e.g., by photon modes 843 and 845) and qubit B (physically realized, e.g., by photon modes 847 and 849) as input and outputs a single “fused” qubit that inherits the entanglement with other qubits that were previously entangled with either (or both) of input qubit A or input qubit B.

For example, FIG. 8B shows the result of type-I fusing of two qubits A and B that are each, respectively, a qubit located at the end (i.e., a leaf) of some longer entangled cluster state (only a portion of which is shown). The qubit 857 that remains after the fusion operation inherits the entangling bonds from the original qubits A and B thereby creating a larger linear cluster state. FIG. 8B also shows the result of type-I fusing of two qubits A and B that are each, respectively, an internal qubit that belongs to some longer entangled cluster of qubits (only a portion of which is shown). As before, the qubit 859 that remains after fusion inherits the entangling bonds from the original qubits A and B thereby creating a fused quantum system. In this case, the qubit that remains after the fusion operation is entangled with the larger quantum system by way of four other nearest neighbor qubits as shown.

Returning to the schematic illustration of type I fusion gate 800 shown in FIG. 8A, qubit A is dual-rail encoded by modes 843 and 845, and qubit B is dual-rail encoded by modes 847 and 849. For example, in the case of path-encoded photonic qubits, the logical zero state of qubit A (denoted |0 [symbol] _{A}) occurs when mode 843 is a photonic waveguide that includes a single photon and mode 845 is a photonic waveguide that includes zero photons (and likewise for qubit B). Thus, type I fusion gate 800 can take as input two dual-rail-encoded photon qubits thereby resulting in a total of four input modes (e.g., modes 843, 845, 847, and 849). To accomplish the fusion operation, a mode coupler (e.g., 50/50 beam splitter) 853 is applied between a mode of each of the input qubits, e.g., between mode 843 and mode 849 before performing a detection operation on both modes using photon detectors 855 (which includes two distinct photon detectors coupled to modes 843 and 849 respectively). In addition, to ensure that the output modes are adjacently positioned, a mode swap operation 851 can be applied that swaps the position of the second mode of qubit A (mode 845) with the position the second mode of qubit B (mode 849). In some embodiments, mode swapping can be accomplished through a physical waveguide crossing as described above or by one or more photonic switches or by any other type of physical mode swap.

FIG. 8A shows only an example arrangement for a type I fusion gate and one of ordinary skill will appreciate that the position of the mode coupler and the presence of the mode swap region 851 can be altered without departing from the scope of the present disclosure. For example, beam splitter 853 can be applied between modes 845 and 847. Mode swaps are optional and are not necessary if qubits having non-adjacent modes can be dealt with, e.g., by tracking which modes belong to which qubits by storing this information in a classical memory.

Type I fusion gate 800 is a nondeterministic gate, i.e., the fusion operation succeeds with a certain probability less than 1, and in other cases the quantum state that results is not a larger quantum system that comprises the original quantum systems fused together to form a larger quantum system. More specifically, gate 800 “succeeds,” with probability 50%, when only one photon is detected by detectors 855, and “fails” if zero or two photons are detected by detectors 855. When the gate succeeds, the two quantum systems that qubits A and B were a part of become fused into a single larger quantum system with a fused qubit remaining as the qubit that links the two previously unlinked quantum systems (see, e.g., FIG. 8B). However, when the fusion gate fails, it has the effect of removing both qubits from the original quantum systems without generating a larger quantum system.

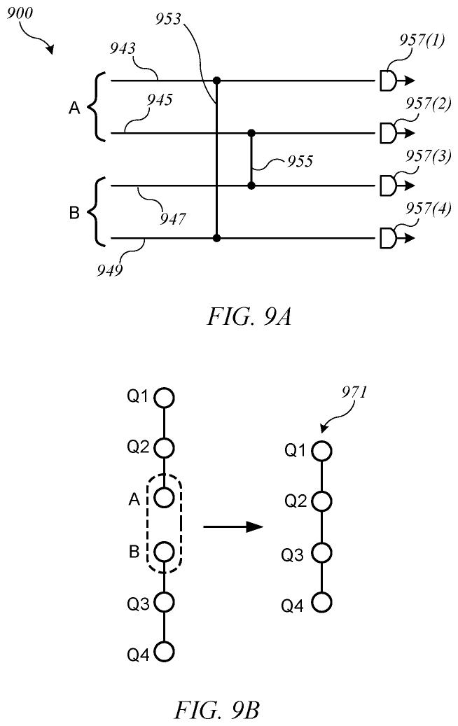

FIG. 9A shows a circuit diagram illustrating a type II fusion gate 900 in accordance with some embodiments. Like other diagrams herein, the diagram shown in FIG. 9A is schematic with each horizontal line representing a mode of a quantum system, e.g., a photon. In a dual-rail encoding, each pair of modes represents a qubit. In a photonic implementation of the gate the modes in diagrams such as that shown in FIG. 9A can be physically realized using single photons in photonic waveguides. Most generally, a type II fusion gate such as gate 900 takes qubit A (physically realized, e.g., by photon modes 943 and 945) and qubit B (physically realized, e.g., by photon modes 947 and 949) as input and outputs a quantum state that inherits the entanglement with other qubits that were previously entangled with either (or both) of input qubit A or input qubit B. (For type II fusion, if the input quantum states had a total of N qubits between them, the output quantum state has N−2 qubits. This is different from type I fusion where input quantum states having a total of N qubits between them leads to an output quantum state having N−1 qubits.)

For example, FIG. 9B shows the result of type-II fusing of two qubits A and B that are each, respectively, a qubit located at the end (i.e., a leaf) of some longer entangled cluster state (only a portion of which is shown). The resulting quantum system 971 inherits the entangling bonds from qubits A and B thereby creating a larger linear quantum system.

Returning to the schematic illustration of type II fusion gate 900 shown in FIG. 9A, qubit A is dual-rail encoded by modes 943 and 945, and qubit B is dual-rail encoded by modes 947 and 949. For example, in the case of path encoded photonic qubits, the logical zero state of qubit A (denoted |0 [symbol] _{A}) occurs when mode 943 is a photonic waveguide that includes a single photon and mode 945 is a photonic waveguide that includes zero photons (and likewise for qubit B). Thus, type II fusion gate 900 takes as input two dual-rail-encoded photon qubits thereby resulting in a total of four input modes (e.g., modes 943, 945, 947, and 949). To accomplish the fusion operation, a first mode coupler (e.g., 50/50 beam splitter) 953 is applied between a mode of each of the input qubits, e.g., between mode 943 and mode 949, and a second mode coupler (e.g., 50/50 beam splitter) 955 is applied between the other modes of each of the input qubits, e.g., between modes 945 and 947. A detection operation is performed on all four modes using photon detectors 957(1)-957(4). In some embodiments, mode swap operations (not shown in FIG. 9A) can be performed to place modes in adjacent positions prior to mode coupling. In some embodiments, mode swapping can be accomplished through a physical waveguide crossing as described above or by one or more photonic switches or by any other type of physical mode swap. Mode swaps are optional and are not necessary if qubits having non-adjacent modes can be dealt with, e.g., by tracking which modes belong to which qubits by storing this information in a classical memory.

FIG. 9A shows only an example arrangement for the type II fusion gate and one of ordinary skill will appreciate that the positions of the mode couplers and the presence or absence of mode swap regions can be altered without departing from the scope of the present disclosure.

The type II fusion gate shown in FIG. 9A is a nondeterministic gate, i.e., the fusion operation succeeds with a certain probability less than 1, and in other cases the quantum state that results is not a larger quantum system that comprises the original quantum systems fused together to a larger quantum system. More specifically, the gate “succeeds” in the case where one photon is detected by one of detectors 957(1) and 957(4) and one photon is detected by one of detectors 957(2) and 957(3); in all other cases, the gate “fails.” When the gate succeeds, the two quantum systems that qubits A and B were a part of become fused into a single larger quantum system; unlike type-I fusion, no fused qubit remains (compare FIG. 8B and FIG. 9B). When the fusion gate fails, it has the effect of removing both qubits from the original quantum systems without generating a larger quantum system.

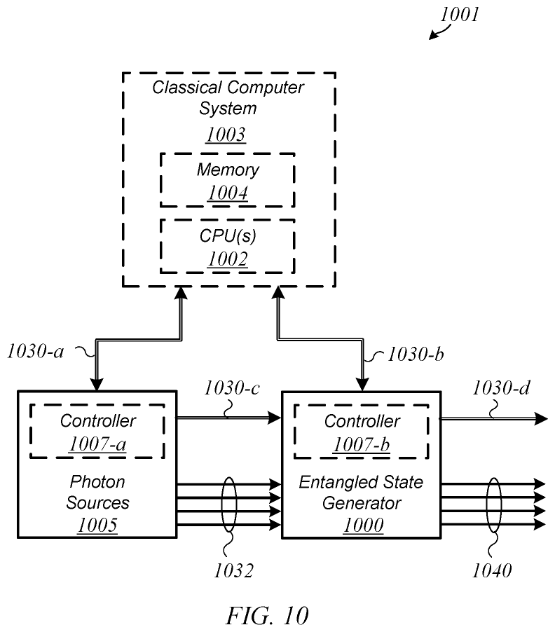

FIG. 10 illustrates an example of a qubit entangling system 1001 in accordance with some embodiments. Such a system can be used to generate qubits (e.g., photons) in an entangled state (e.g., a GHZ state, Bell pair, and the like), in accordance with some embodiments. In some embodiments, qubit entangling system 1001 can operate as a resource state generator as described below.

In an illustrative photonic architecture, qubit entangling system 1001 can include a photon source module 1005 that is optically connected to entangled state generator 1000. Both the photon source module 1005 and the entangled state generator 1000 may be coupled to a classical processing system 1003 such that the classical processing system 1003 can communicate and/or control (e.g., via the classical information channels 1030a-b) the photon source module 1005 and/or the entangled state generator 1000. Photon source module 1005 may include a collection of single-photon sources that can provide output photons to entangled state generator 1000 by way of interconnecting waveguides 1032. Entangled state generator 1000 may receive the output photons and convert them to one or more entangled photonic states and then output these entangled photonic states into output waveguides 1040. In some embodiments, output waveguide 1040 can be coupled to some downstream quantum photonic circuit that may use the entangled states, e.g., for performing a quantum computation. For example, the entangled states generated by the entangled state generator 1000 may be used as resource states for one or more interleaving modules as described below.

In some embodiments, system 1001 may include classical channels 1030 (e.g., classical channels 1030-a through 1030-d) for interconnecting and providing classical information between components. It should be noted that classical channels 1030-a through 1030-d need not all be the same. For example, classical channel 1030-a through 1030-c may comprise a bi-directional communication bus carrying one or more reference signals, e.g., one or more clock signals, one or more control signals, or any other signal that carries classical information, e.g., heralding signals, photon detector readout signals, and the like.

In some embodiments, qubit entangling system 1001 includes the classical computer system 1003 that communicates with and/or controls the photon source module 1005 and/or the entangled state generator 1000. For example, in some embodiments, classical computer system 1003 can be used to configure one or more circuits, e.g., using a system clock that may be provided to photon sources 1005 and entangled state generator 1000 as well as any downstream quantum photonic circuits used for performing quantum computation. In some embodiments, the quantum photonic circuits can include optical circuits, electrical circuits, or any other types of circuits. In some embodiments, classical computer system 1003 includes memory 1004, one or more processor(s) 1002, a power supply, an input/output (I/O) subsystem, and a communication bus or interconnecting these components. The processor(s) 1002 may execute modules, programs, and/or instructions stored in memory 1004 and thereby perform processing operations.

In some embodiments, memory 1004 stores one or more programs (e.g., sets of instructions) and/or data structures. For example, in some embodiments, entangled state generator 1000 can attempt to produce an entangled state over successive stages, any one of which may be successful in producing an entangled state. In some embodiments, memory 1004 stores one or more programs for determining whether a respective stage was successful and configuring the entangled state generator 1000 accordingly (e.g., by configuring entangled state generator 1000 to switch the photons to an output if the stage was successful, or pass the photons to the next stage of the entangled state generator 1000 if the stage was not yet successful). To that end, in some embodiments, memory 1004 stores detection patterns (described below) from which the classical computing system 1003 may determine whether a stage was successful. In addition, memory 1004 can store settings that are provided to the various configurable components (e.g., switches) described herein that are configured by, e.g., setting one or more phase shifts for the component.

In some embodiments, some or all of the above-described functions may be implemented with hardware circuits on photon source module 1005 and/or entangled state generator 1000. For example, in some embodiments, photon source module 1005 includes one or more controllers 1007-a (e.g., logic controllers) (e.g., which may comprise field programmable gate arrays (FPGAs), application specific integrated circuits (ASICS), a “system on a chip” that includes classical processors and memory, or the like). In some embodiments, controller 1007-a determines whether photon source module 1005 was successful (e.g., for a given attempt on a given clock cycle, described below) and outputs a reference signal indicating whether photon source module 1005 was successful. For example, in some embodiments, controller 1007-a outputs a logical high value to classical channel 1030-a and/or classical channel 1030-c when photon source module 1005 is successful and outputs a logical low value to classical channel 1030-a and/or classical channel 1030-c when photon source module 1005 is not successful. In some embodiments, the output of control 1007-a may be used to configure hardware in controller 1007-b.

Similarly, in some embodiments, entangled state generator 1000 includes one or more controllers 1007-b (e.g., logical controllers) (e.g., which may comprise field programmable gate arrays (FPGAs), application specific integrated circuits (ASICS), or the like) that determine whether a respective stage of entangled state generator 1000 has succeeded, perform the switching logic described above, and output a reference signal to classical channels 1030-b and/or 1030-d to inform other components as to whether the entangled state generator 400 has succeeded.

In some embodiments, a system clock signal can be provided to photon source module 1005 and entangled state generator 1000 via an external source (not shown) or by classical computing system 1003 generates via classical channels 1030-a and/or 1030-b. In some embodiments, the system clock signal provided to photon source module 1005 triggers photon source module 1005 to attempt to output one photon per waveguide. In some embodiments, the system clock signal provided to entangled state generator 1000 triggers, or gates, sets of detectors in entangled state generator 1000 to attempt to detect photons. For example, in some embodiments, triggering a set of detectors in entangled state generator 1000 to attempt to detect photons includes gating the set of detectors.

It should be noted that, in some embodiments, photon source module 1005 and entangled state generator 1000 may have internal clocks. For example, photon source module 1005 may have an internal clock generated and/or used by controller 1007-a and entangled state generator 1000 has an internal clock generated and/or used by controller 1007-b. In some embodiments, the internal clock of photon source module 1005 and/or entangled state generator 1000 is synchronized to an external clock (e.g., the system clock provided by classical computer system 1003) (e.g., through a phase-locked loop). In some embodiments, any of the internal clocks may themselves be used as the system clock, e.g., an internal clock of the photon source may be distributed to other components in the system and used as the master/system clock.

In some embodiments, photon source module 1005 includes a plurality of probabilistic photon sources that may be spatially and/or temporally multiplexed, i.e., a so-called multiplexed single photon source. In one example of such a source, the source is driven by a pump, e.g., a light pulse, that is coupled into an optical resonator that, through some nonlinear process (e.g., spontaneous four wave mixing, second harmonic generation, and the like) may generate zero, one, or more photons. As used herein, the term “attempt” is used to refer to the act of driving a photon source with some sort of driving signal, e.g., a pump pulse, that may produce output photons non-deterministically (i.e., in response to the driving signal, the probability that the photon source will generate one or more photons may be less than 1). In some embodiments, a respective photon source may be most likely to, on a respective attempt, produce zero photons (e.g., there may be a 90% probability of producing zero photons per attempt to produce a single-photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources may be increased by using a plurality of single-photon sources and multiplexing the outputs of the plurality of photon sources.

The precise type of photon source used is not critical and any type of source can be used, employing any photon generating process, such as spontaneous four wave mixing (SPFW), spontaneous parametric down-conversion (SPDC), or any other process. Other classes of sources that do not necessarily require a nonlinear material can also be employed, such as those that employ atomic and/or artificial atomic systems, e.g., quantum dot sources, color centers in crystals, and the like. In some cases, sources may or may be coupled to photonic cavities, e.g., as can be the case for artificial atomic systems such as quantum dots coupled to cavities. Other types of photon sources also exist for SPWM and SPDC, such as optomechanical systems and the like. In some examples the photon sources can emit multiple photons already in an entangled state in which case the entangled state generator 400 may not be necessary, or alternatively may take the entangled states as input and generate even larger entangled states.

For the sake of illustration, an example which employs spatial multiplexing of several non-deterministic photon sources is described as an example of a MUX photon source. However, many different spatial MUX architectures are possible without departing from the scope of the present disclosure. Temporal MUXing can also be implemented instead of or in combination with spatial multiplexing. MUX schemes that employ log-tree, generalized Mach-Zehnder interferometers, multimode interferometers, chained sources, chained sources with dump-the-pump schemes, asymmetric multi-crystal single photon sources, or any other type of MUX architecture can be used. In some embodiments, the photon source can employ a MUX scheme with quantum feedback control and the like.

The foregoing description provides an example of how photonic circuits can be used to implement physical qubits and operations on physical qubits using mode coupling between waveguides. In these examples, a pair of modes can be used to represent each physical qubit. Examples described below can be implemented using similar photonic circuit elements.

In some embodiments, an entangled system of multiple physical qubits can be mapped to one or more “logical qubits,” and operations associated with a quantum computation can be defined as logical operations on logical qubits, which in turn can be mapped to physical operations on physical qubits. In general, the term “qubit,” when used herein without specifying physical or logical qubit, should be understood as referring to a physical qubit.

### 2. Overview of Fusion-Based Quantum Computing (FBQC)

“Quantum computation,” as used herein, refers generally to performing a sequence of operations (a “computation”) on an ensemble of qubits. Quantum computation is often considered in the framework of “circuit-based quantum computation” (CBQC), in which the operations are specified as a sequence of logical “gates” performed on qubits. Gates can be either single-qubit unitary operations (rotations), two-qubit entangling operations such as the CNOT gate, or other multi-qubit gates such as the Toffoli gate.

One challenge for CBQC, and for quantum computation generally, is that physical systems implementing qubits and operations on qubits are often non-deterministic and noisy. For example, the photonic Bell state generator and fusion circuits described above can create entanglement between photonic qubits, but they do so non-deterministically, with a probability of success that is considerably less than 1. In addition, the physical systems may be “noisy”; for instance, a waveguide propagating a photon may be somewhat less than perfectly efficient, resulting in occasional loss of photons. For reasons such as these, fault tolerant quantum computing is a desirable goal.

“Measurement-based quantum computation” (MBQC) is an approach to implementing quantum computing that allows for fault-tolerance. In MBQC, computation proceeds by first preparing a particular entangled state of many physical qubits, commonly referred to as a “cluster state,” then carrying out a series of single-qubit measurements to enact (or execute) the quantum computation. For instance, rather than implementing a sequence of gates operating on one or two physical qubits, a subset of the physical qubits in the cluster state can be mapped to a “logical” qubit, and a gate operation on logical qubits can be mapped to a particular set of measurements on physical qubits associated with one or more logical qubits. Entanglement between the physical qubits results in expected correlations among measurements on different physical qubits, which enables error correction. The cluster state can be prepared in a manner that is not specific to a particular computation (other than, perhaps, the size of the cluster state), and the choice of single-qubit measurements is determined by the particular computation. In the MBQC approach, fault tolerance can be achieved by careful design of the cluster state and by using the topology of the cluster state to encode logical qubits in a manner that protects against any logical errors that may be caused by errors on any of the physical qubits that make up the cluster state. The value (or state) of the logical qubit(s) can be determined, i.e., read out, based on the results (also referred to herein as measurement outcomes) of the single-particle measurements that are made on the cluster state's physical qubits as the computation proceeds.

For example, a cluster state suitable for MBQC can be defined by preparing a collection of physical qubits in a particular state (sometimes referred to as the |+ [symbol] state) and applying a controlled-phase gate (sometimes referred to as a “CZ gate”) between pairs of physical qubits to generate the cluster state. Graphically, a cluster state formed in this manner can be represented by a graph with vertices representing the physical qubits and edges that represent entanglement (e.g., the application of CZ gates) between pairs of qubits. The graph can be a three-dimensional graph having a regular structure formed from repeating unit cells and is sometimes referred to as a “lattice.” One example of a lattice is the Raussendorf lattice, which is described in detail in R. Raussendorf et al., “Fault-Tolerant One-Way Quantum Computer,” Annals of Physics 321(9):2242-2270 (2006). In such representations, two-dimensional boundaries of the lattice can be identified. Qubits belonging to those boundaries are referred to as “boundary qubits” while all other qubits are referred to as “bulk qubits.” Other cluster state structures can also be used. Logical operations are performed by making single-qubit measurements on qubits of the cluster state, with each measurement being made in a particular logical basis that is selected according to the particular quantum computation to be performed. The collection of measurement results across the cluster state can be interpreted as the result of a quantum computation on a set of logical qubits through the use of a decoder. Numerous examples of decoder algorithms are available, including the Union-Find decoder as described in International Patent Application Publication No. WO 2019/002934 A1.

However, the generation and maintenance of long-range entanglement across the cluster state and subsequent storage of large cluster states can be a challenge. For example, for any physical implementation of the MBQC approach, a cluster state containing many thousands, or more, of mutually entangled qubits must be prepared and then stored for some period of time before the single-qubit measurements are performed.

“Fusion-based quantum computing” (FBQC) is a technique related to MBQC in that a computation on a set of logical qubits can be defined as a set of measurements on a (generally much larger) number of physical qubits, with correlations among measurement results on the physical qubits enabling error correction. FBQC, however, avoids the need to first create, then subsequently manipulate, a large cluster state. In a photonic implementation of FBQC, entangled states consisting of a few physical qubits (referred to as “resource states”) are periodically generated and transported (via waveguides) to circuits that can perform measurement operations (e.g., type II fusion operations as described above, which can provide two-qubit measurements, and/or single-qubit measurements). The measurements destroy the measured qubits; however, the quantum information is preserved as it is transferred (teleported) to other qubits of other resource states. Thus, quantum information is not stored in a static array of physical qubits but is instead periodically teleported to freshly generated physical qubits.

In FBQC, somewhat similarly to MBQC, a computation can be mapped to an undirected graph, referred to as a fusion graph, that can have a lattice-like structure. The fusion graph can define operations to be performed on the physical qubits of the resource states, including fusion operations on selected qubits of different resource states (e.g., in the “bulk” region of a lattice) and individual qubit measurements (e.g., at boundaries of the lattice). Examples of FBQC techniques are described in WO 2021/155289, “Fusion Based Quantum Computing,” published Aug. 5, 2021. This section provides a conceptual description of FBQC, to provide context for interleaving modules and other hardware components described below.

### 2.1. Resource States

As noted, FBQC can use a “resource state” as a basic physical element to implement quantum computations. As used herein, a “resource state” refers to an entangled system of a number (n) of physical qubits in a non-separable entangled state (which is an entangled state that cannot be decomposed into smaller separate entangled states). In various embodiments, the number n can be a small number (e.g., between 3 and 30), although larger numbers are not precluded.

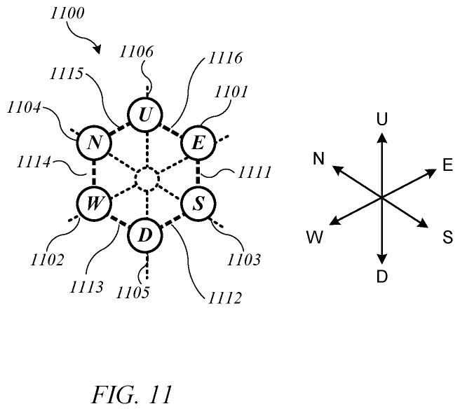

FIG. 11 shows a graph representation of a resource state 1100 that can be used according to some embodiments. In the graph representation of FIG. 11, each physical qubit 1101-1106 of resource state 1100 is represented as a circle, and entanglement between physical qubits is represented by lines 1111-1116 connecting pairs of qubits. Resource state 1100 is sometimes referred to as a “6-ring” resource state. In examples used herein, the entanglement geometry defines a three-dimensional space. For convenience, the cardinal directions in the entanglement space are referred to as North-South (N-S), East-West (E-W), and Up-Down (U-D). Resource state 1100 has one qubit associated with each cardinal direction (N, S, U, D, E, W) in the entanglement space. It should be understood that the directional labels refer to entanglement space and need not correspond to physical dimensions or directions in physical space. Further, in some instances qubits may be separated in time rather than in spatial dimensions. For example, each physical qubit can be implemented using photons propagating in waveguides, and a particular section of waveguide may propagate photons associated with different qubits at different times.

In some embodiments, resource state 1100 can be generated using photon sources and entanglement circuits of the kind described above. For example, Bell pairs can be generated using one or more photon sources (which can be MUX photon sources as described above) and a circuit such as circuit 700 of FIG. 7. A 3-GHZ state can be generated from two Bell pairs using a circuit such as type-I fusion 800 of FIG. 8A. From a set of six 3-GHZ states, 6-ring resource state 1100 can be formed using a circuit such as type-II fusion circuit 900 of FIG. 9A. As noted above, entanglement-generating circuits such as Bell state generator circuit 700 and fusion circuits 800 and 900 may operate non-deterministically. In some implementations, outputs of several such circuits can be multiplexed using temporal and/or spatial multiplexing techniques to increase the probability of producing a resource state.

Resource state 1100 is illustrative and not limiting. In some embodiments, the entanglement geometry of a resource state can be chosen based on a particular computation to be executed, and different resource states that are used in the same computation can have different entanglement geometries. Further, while resource state 1100 includes six qubits, the number of qubits in a resource state can also be varied. Accordingly, a resource state may be larger or smaller than the example shown. The circuitry used to generate a resource state can also be varied, depending on the particular entanglement geometry and/or the probability of success of various entanglement-generating operations. Error correcting codes may also be constructed to account for a nonzero probability of a resource state not being generated.

### 2.2. Logical Operations

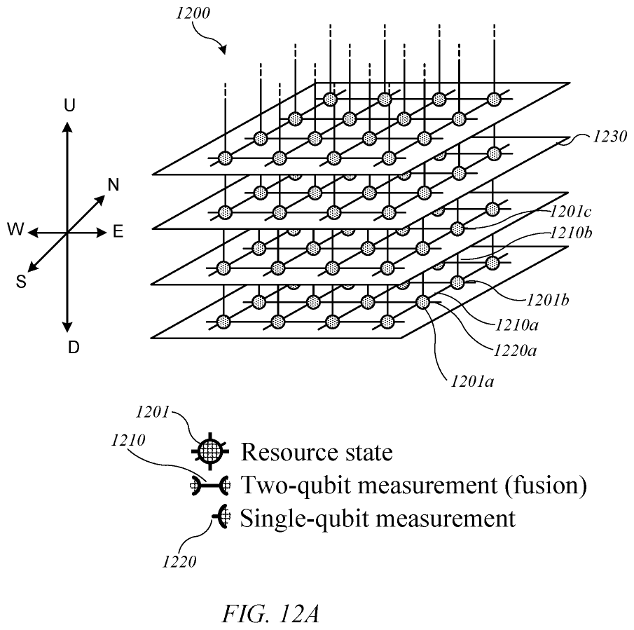

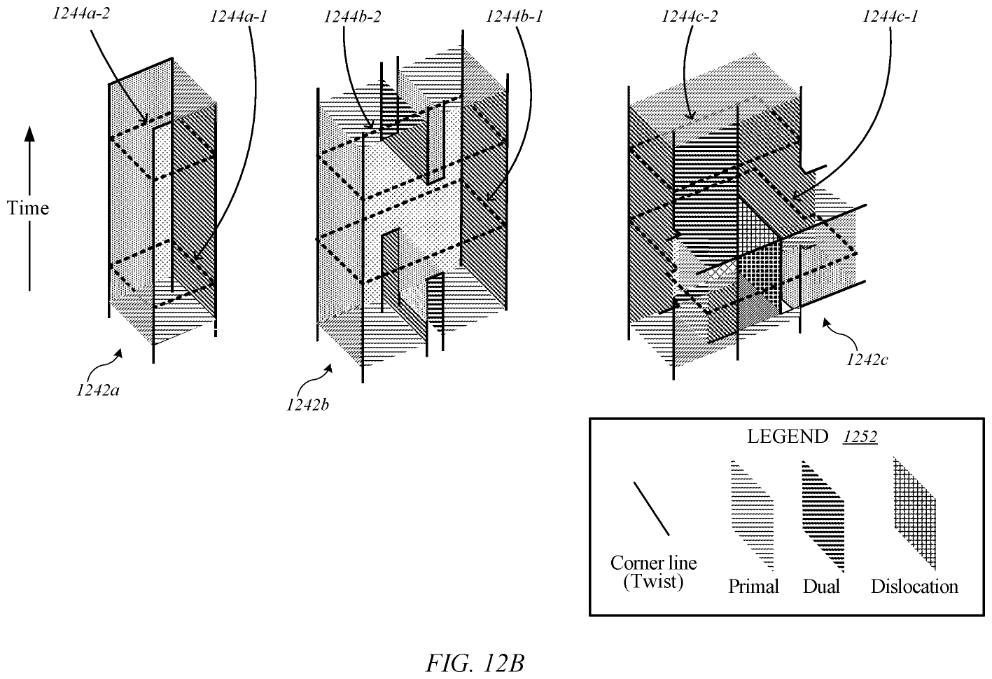

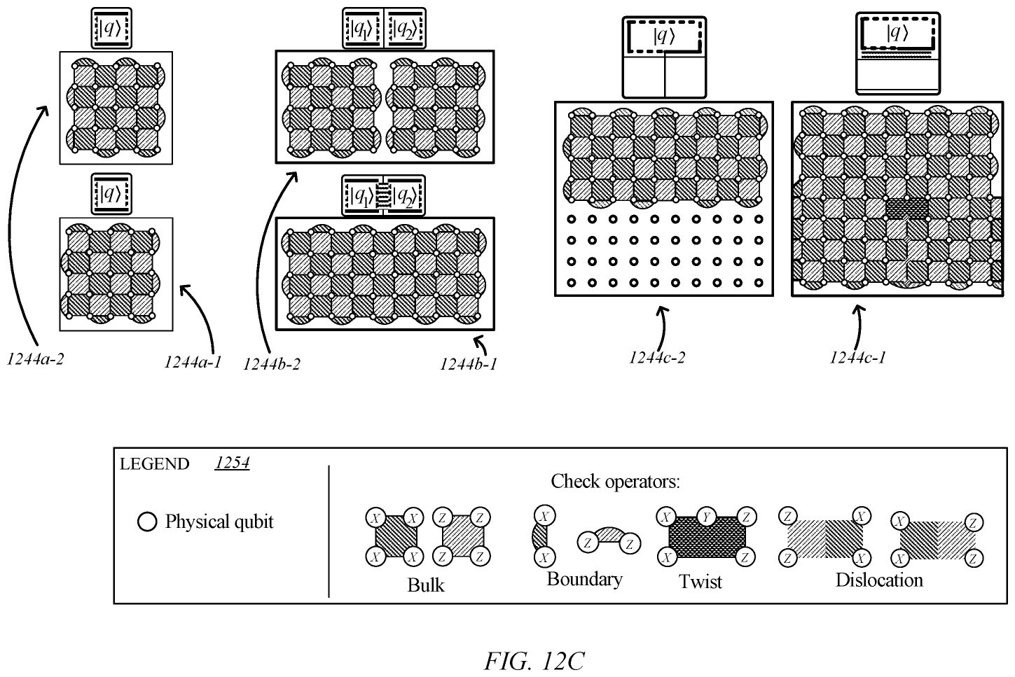

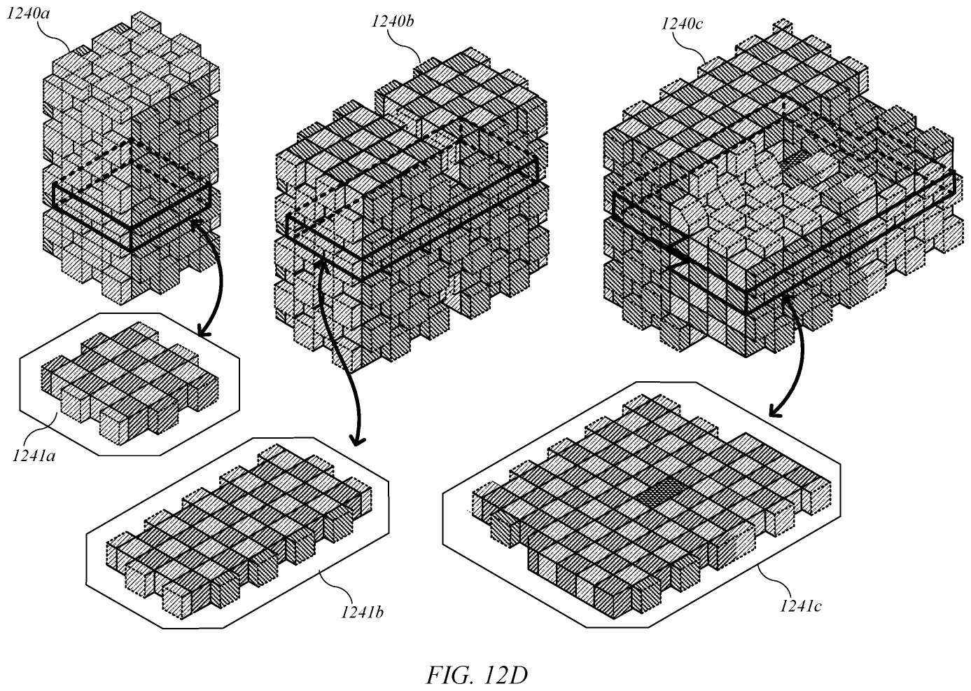

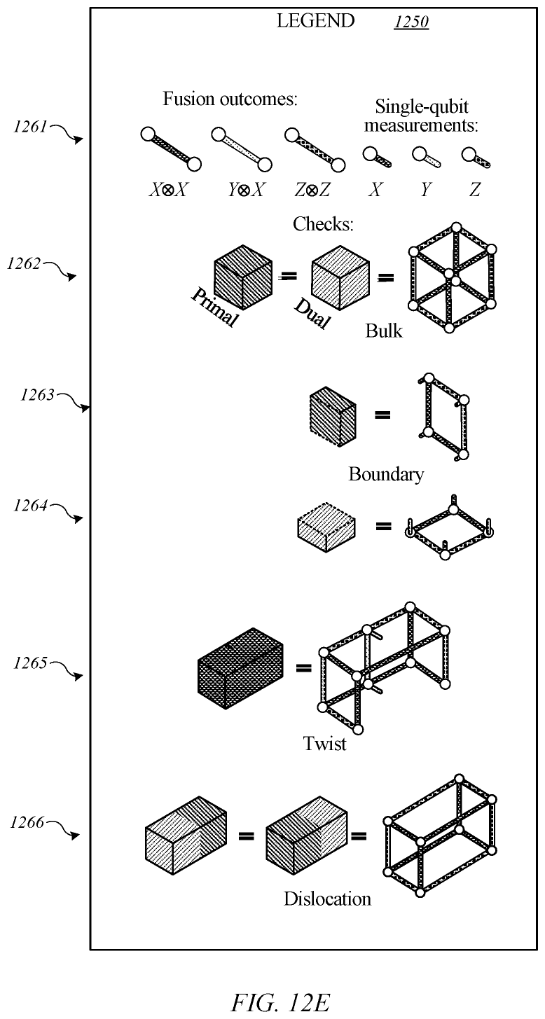

Operations to be performed on qubits of resource states in connection with FBQC can be represented conceptually using a fusion graph. FIG. 12A shows an example of a fusion graph 1200 according to some embodiments. The same three-dimensional entanglement space defined in FIG. 11 is used, with the same N-S, E-W, U-D naming convention (which need not correspond to any physical dimension or direction). However, unlike in FIG. 11, each vertex 1201 represents a resource state (e.g., 6-ring resource state 1100) rather than an individual qubit. Each vertex 1201 represents a physically distinct instance of the resource state. Each edge 1210 connecting two vertices 1201 corresponds to a fusion operation between qubits of different resource states. Each fusion operation can be, e.g., a type II fusion operation as described above that produces a two-qubit measurement. The particular qubits involved can be identified from the direction of the edges in the entanglement space. Thus, for example, edge 1210a corresponds to a fusion operation between the N qubit of a resource state represented by vertex 1201a and the S qubit of a (different) resource state represented by vertex 1201b, while edge 1210b corresponds to a fusion operation between the U qubit of the resource state represented by vertex 1201b and the D qubit of a (third) resource state represented by vertex 1201c. Each half-edge 1220 (a “half-edge” is connected to only one vertex 1201) represents a single-qubit measurement on the corresponding qubit of the resource state represented by that vertex 1201. Thus, for example, half-edge 1220a corresponds to a single-qubit measurement on the E qubit of the resource state represented by vertex 1201a.

In some embodiments, a fusion graph such as fusion graph 1200 can be viewed as a series of “layers” 1230, where each layer corresponds to a coordinate on the U-D axis. Implementing FBQC in a physical system can include successively generating resource states for each layer (e.g., in the direction from D to U) and performing the fusion and single-qubit measurement operations within each layer as specified by the edges and half-edges of the graph for that layer. As resource states for successive layers are generated, fusion operations can be performed between the U qubits of resource states in one layer and the D qubits of resource states in corresponding position of the next layer. In the description that follows, fusion operations may be referred to as “spacelike” or “timelike.” This terminology is evocative of particular implementations in which different qubits or resource states are generated or received at different times: spacelike fusion can be performed between qubits generated or received at the same time using different instances of hardware, while timelike fusion can be performed between qubits generated or received at different times using the same instance of hardware (or different instances of hardware). For photonic qubits, timelike fusion can be implemented by delaying an earlier-produced qubit (e.g., using additional lengths of waveguide material to create a longer propagation path for the photon), thereby allowing mode coupling with a later-produced qubit. By leveraging timelike fusion, the same hardware can be used to generate and/or process multiple instances of the resource states within a layer and/or to generate multiple layers of resource states. Examples are described below.

In some encoding schemes for sequences of operations on logical qubits, a logical qubit that is “at rest” (i.e., not interacting with other logical qubits or otherwise being operated on) can be mapped onto a fusion graph having a regular lattice pattern as shown in FIG. 12A. For the 6-ring resource state of FIG. 11, each resource state in the bulk of the lattice has each of its six qubits fused with a qubit of a neighboring resource state. (Two qubits that are input to a type II fusion circuit are sometimes colloquially described as being “fused with” each other.) For instance, E qubit 1101 of a first instance of resource state 1100 and W qubit 1102 of a second instance of resource state 1100 can be input into a fusion circuit (e.g., the type II fusion circuit of FIG. 9A), resulting in a two-qubit measurement. At the boundaries of the lattice, qubits that are not subject to fusion operations can be subject to single-qubit measurements.

Logical operations on logical qubits can be specified by modifying the regular lattice pattern of a fusion graph at selected positions, e.g., by replacing single-qubit measurements with fusion operations or vice versa. The choice of modifications depends on the particular computation to be performed. Some examples will now be described.

In some embodiments, fusion graphs such fusion graph 1200 can be used to specify logical operations to be performed on a set of logical qubits. For example, a fusion graph defining a logical operation implemented in FBQC can be generated from a surface-code spacetime or time-slice diagram of the kind used to define computations in fault-tolerant CBQC. FIGS. 12B-12D show examples of how fusion graphs can be generated from surface-code spacetime or time-slice diagrams for three different logical operations: (a) measurement of an idling logical qubit (i.e., a logical qubit that is not interacting with any other logical qubit); (b) two-qubit X⊗X measurements (“lattice surgery”); and (c) Y measurement with a twist. FIG. 12E shows a legend 1250 for the fusion-graph notation used in FIG. 12D.

FIG. 12B shows examples of surface-code spacetime diagrams 1242a-1242c, which can be constructed using techniques known in the art. As shown in legend 1252, surface-code spacetime diagrams can represent logical operations (e.g., twists, dislocations) on surfaces (e.g., primal and dual boundaries) that define logical qubits. Spacetime diagram 1242a corresponds to a logical qubit at rest. Spacetime diagram 1242b corresponds to a two-qubit X⊗X measurement. Spacetime diagram 1242c corresponds to a Y measurement with a twist. When performing fault-tolerant quantum computations with surface codes and CBQC, an entire quantum computation can proceed through a sequence of time slices (or time steps). At each time slice, a set of “check operator” measurements, is performed, where the check operator measurements are measurements of operators on physical qubits; the pattern of check operator measurements implements certain logical operations on logical qubits and enables the detection and correction of errors. The check operator measurements at a given time slice can be represented in a time-slice diagram. By way of example, for each logical operation in FIG. 12B, time-slice diagrams for two representative time slices are shown in FIG. 12C. Specifically, time slices 1244a-1 and 1244a-2 are selected from spacetime diagram 1242a; time slices 1244b-1 and 1244b-2 are selected from spacetime diagram 1242b; and time slices 1244c-1 and 1244c-2 are selected from spacetime diagram 1242c. In all time slice diagrams of FIG. 12C, a square code distance of 5 is used, and a logical qubit is mapped to a square patch of 5×5 physical qubits to which check operators are applied. (It should be understood that different code distances can be applied.) As shown in legend 1254, the check operators in each time slice include four-qubit operators X^{⊗4} and Z^{⊗4} in the bulk and two-qubit operators X^{⊗2} and Z^{⊗2} at the boundaries, where X, Y, and Z are the Pauli operators on physical qubits. Twist and dislocation operators are also defined as illustrated. As shown in time-slice diagrams 1244a-1, 1244a-2, 1244b-1, 1244b-2, 1244c-1, and 1244c-2, a time slice can be drawn in a simplified manner that omits notation of the physical-qubit operators; the correct operators can be inferred from the pattern of light and dark shading according to the legend.

A quantum computation can be expressed as a sequence of time slices such as the time slices of FIG. 12C. However, it is often more convenient to represent a sequence of 2D time slices in a 3D diagram, such as spacetime diagrams 1242a-1242c of FIG. 12B. The solid black lines in a spacetime diagram trace the trajectory of patch corners through spacetime. Shading-coded (or color-coded) surfaces track primal and dual boundaries through space time; the meaning of the various shading patterns is indicated in legend 1252. A 2D spacelike cross section through a spacetime diagram 1242 corresponds to a time-slice diagram 1244. The bulk has a regular pattern of primal and dual measurements (as seen in the various time slice diagrams of FIG. 12C), and measurements in the bulk can be inferred from the boundaries. Also shown in FIG. 12B are corner lines indicating the twist operation (applied in time slice 1244c-1) and associated dislocation of the boundary. Spacetime diagrams need not directly show the number of time slices (or the code distance) to which they correspond. Typically, though not necessarily, each change to the spatial configuration lasts for a number of time slices equal to the code distance.

For purposes of illustration, spacetime diagram 1242a shows a logical qubit that idles for a while until it is measured in the Z basis, as indicated by the corner lines and dual boundary capping off spacetime diagram 1242a. Spacetime diagram 1242b corresponds to a logical two-qubit measurement X⊗X via “lattice surgery.” Spacetime diagram 1242c corresponds to a logical qubit encoded in a rectangular patch contributing to a logical multi-qubit Pauli measurement with its Y operator. The details of these logical operations (including how the spacetime diagrams correspond to particular logical operations) are not relevant to understanding the present disclosure; those skilled in the art will be familiar with such details and techniques for constructing spacetime diagrams and time-slice diagrams.

In some embodiments for FBQC, a spacetime diagram can be translated to a fusion graph in a straightforward manner. For instance, FIG. 12D shows fusion graphs 1240a-1240c corresponding to spacetime diagrams 1242a-1242c. Fusion graphs 1240a-1240c can be generally similar to fusion graph 1200 in that both describe a cubic lattice of resource states. However, fusion graphs 1240 add additional information about the measurement operations to be performed, by assigning color or shading to certain cubic or cuboid volumes within the lattice. FIG. 12E shows a legend 1250 indicating how the shading (or color) of a cubic or cuboid volume in fusion graphs 1240a-1240c maps to a corresponding set of measurements on qubits of different resource states. In FIG. 12E, top row 1261 defines line styles representing specific two-qubit (fusion) and single-qubit measurements. Subsequent rows 1262-1266 indicate how each cubic or cuboid volume maps to a combination of fusion and single-qubit measurements. In some embodiments, each two-qubit fusion measurement (e.g., a type II fusion measurement) produces both X⊗X and Z⊗Z measurement outcomes; thus the primal and dual checks of a CBQC spacetime diagram, when translated to a fusion graph, can both correspond to the same measurement operations (and the same hardware) and combinations of outcomes, as shown in second row 1262 of legend 1250. The difference between primal and dual checks can be in how the measurement outcome data is used in decoding. Boundary checks, shown in rows 1263 and 1264 of legend 1250, correspond to half-cubes that involve a combination of fusion outcomes and two single-qubit measurements. Twists, shown in row 1265 of legend 1250, involve Y⊗Y fusion measurements (and skipping over certain lattice locations). In some implementations, the Y⊗Y fusion measurements do not require additional hardware, as they can be determined by multiplying the X⊗X and Z⊗Z fusion measurement outcomes. Dislocations, shown in row 1266 of legend 1250, skip over certain lattice locations and involve X⊗X and Z⊗Z fusion measurements.

The translation from spacetime diagram to fusion graph can be straightforward, as can be seen by comparing FIGS. 12C and 12D. The bulk of the fusion graph is filled with primal and dual bulk cubes in a 3D checkerboard pattern, and the primal and dual boundaries are decorated with primal or dual half-cubes. If twists or lattice dislocations are present, they are added using the cuboids shown in legend 1250. Slices of the fusion graph can mimic the pattern of the corresponding CBQC time slices, although the interpretation is different, as can be seen by comparing legend 1250 (FIG. 12E) and legend 1254 (in FIG. 12C). The number of cubes in the fusion graph depends on the code distance, and time slices of square patches having code distance d involve d² resource states.

Additional description related to generation of fusion graphs such as fusion graphs 1240 can be found in above-referenced WO 2021/155289 and in H. Bombin et al., “Interleaving: Modular architectures for fault-tolerant photonic quantum computing,” arXiv:2013.08612v1 [quant-ph], 15 Mar. 2021, available at https://arxiv.org/abs/2103.08612.

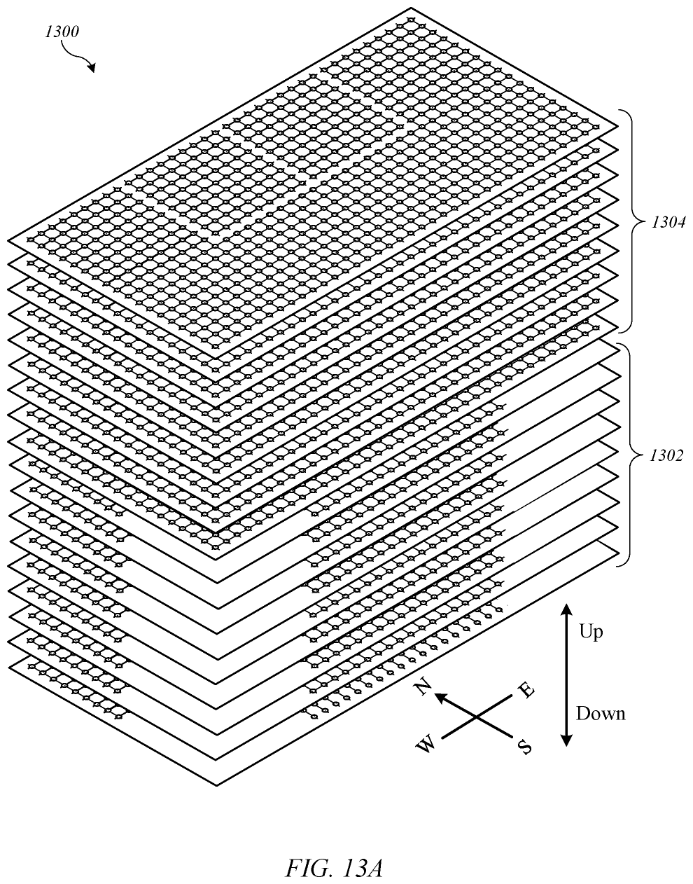

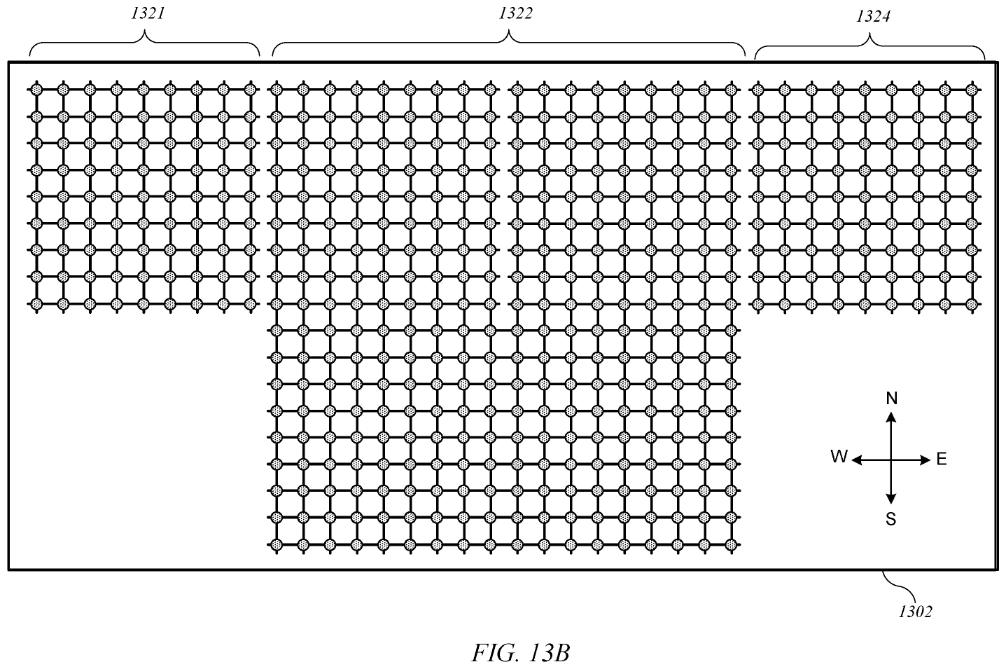

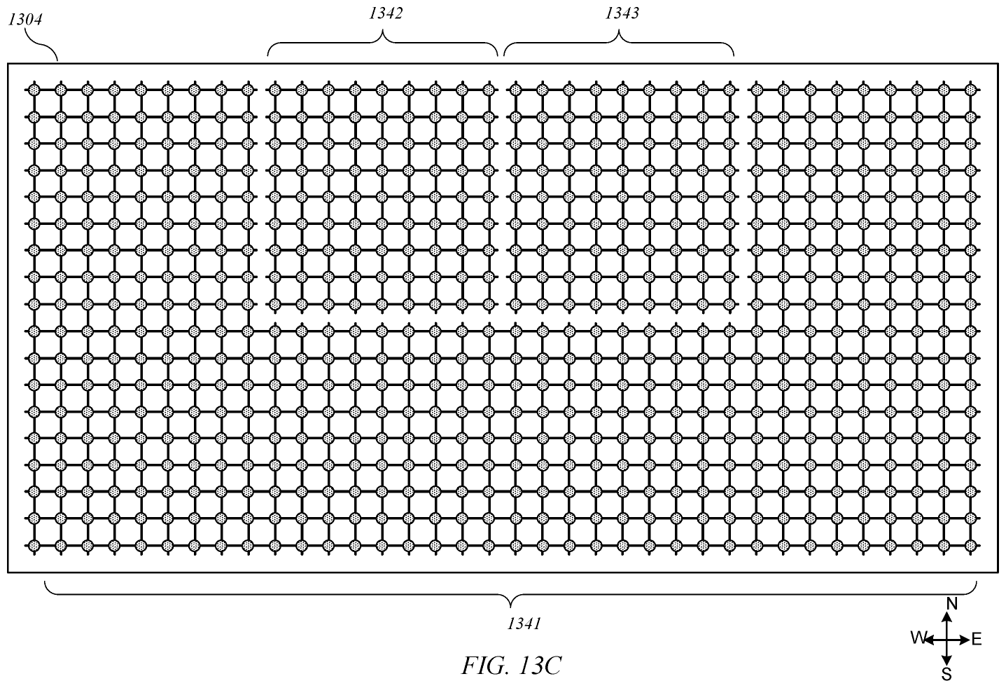

In some embodiments, fusion graphs can be “compiled” into “instructions” to perform a particular combination of fusion operations on a set of resource states. By way of example, FIGS. 13A-13C show views of a fusion graph implementing logical operations on four logical qubits (q₁, q₂, q₃, q₄) according to some embodiments. FIG. 13A shows a perspective view of fusion graph 1300, which includes a first set of nine layers 1302 and a second set of nine layers 1304. (For simplicity of illustration, FIG. 13A does not show fusion operations between resource states in different layers; however, it should be understood that fusion operations can be performed between resource states in corresponding locations in adjacent layers, as shown in FIG. 12A. Also for simplicity of illustration, the shading of FIG. 12B is not applied in FIGS. 13A-13C. The appropriate pattern of primal and dual bulk cubes and boundary half-cubes can be inferred.) FIG. 13B shows a representative one of layers 1302, and FIG. 13C shows a representative one of layers 1304. In this example, the computation includes performing a first Pauli product measurement Z₂Z₃ between logical qubits q₂ and q₃, then performing a second Pauli product measurement Z₁Z₄ between logical qubits q₁ and q₄. In this example, a “code distance” (or “code size”) of 9 is assigned. The code distance is a selectable parameter relating to the size of the bulk lattice used to provide a desired error correction code, and the choice of code distance can depend on the particular hardware implementation (e.g., expected photon losses and the success rate of the particular entanglement generating circuits used to provide the resource states) and a desired degree of fault tolerance. In this example, the number of layers associated with each logical operation corresponds to the code distance, and (as best seen in FIGS. 13B and 13C) the number of physical qubits between lattice modifications within a layer also corresponds to the code distance. The choice of code distance is not relevant to understanding the present disclosure, and embodiments described herein can support a range of code distances. Further, while this example uses cubic codes (same code distance in all three dimensions), cubic codes are not required, and the code distances along different dimensions (e.g., U-D, S-N, E-W) can be different from each other.

FIG. 13B shows a representative one of layers 1302, corresponding to the Z₂Z₃ measurement. It should be understood that all layers 1302 can have the same lattice pattern. Lattice section 1321 represents logical qubit q₁ at rest (i.e., not interacting with any other qubit), and lattice section 1324 represents logical qubit q₄ at rest. In this example, each logical qubit has a code distance of 9 and is represented as a 9×9 lattice in each layer. U-shaped lattice section 1322 represents the Z₂Z₃ measurement on logical qubits q₂ and q₃. As suggested by FIG. 13B, logical operations on logical qubits can involve introducing additional resource states and fusion operations, with the number of additional resource states and fusion operations depending at least in part on the code distance.

FIG. 13C shows a representative one of layers 1304, corresponding to the Z₁Z₄

measurement. It should be understood that all layers 1304 can have the same lattice pattern. Lattice sections 1342 and 1343 represent logical qubits q₂ and q₃ at rest. U-shaped lattice section 1341 represents the Z₁Z₄ measurement on logical qubits q₁ and q₄.

FIGS. 12A-12E and 13A-13C illustrate the principle of using a prescribed combination of single-qubit measurements (on physical qubits) and fusions between (physical) qubits of different resource states to implement logical operations on logical qubits. It should be understood that fusion graphs can specify operations in a manner that is agnostic to the particular implementation of the physical qubits. Some embodiments described below provide reconfigurable hardware modules that can implement operations on physical qubits of resource states. In some embodiments, such operations may correspond to operations specified in a fusion graph, and measurement data provided by the reconfigurable hardware modules can be decoded to determine the result of the logical operations. However, the operation of the reconfigurable hardware modules is not dependent on any particular manner of selecting or specifying operations to be performed or on any particular downstream use of measurement data generated by the reconfigurable hardware modules.

### 3. Interleaving Modules

According to some embodiments, a general-purpose “interleaving” hardware module (or circuit) can include a resource state interconnect (RSI) that provides resource states at its outputs at regular time intervals, a set of reconfigurable fusion circuits (as described below), and a combination of switches and/or delay lines to deliver qubits from the resource state interconnect to the appropriate reconfigurable fusion circuits. By using classical control logic to control the switch settings for each qubit of each resource state that is generated and the configuration of each reconfigurable fusion circuit that receives qubits, an interleaving module or a network of interleaving modules can be operated to provide a programmable quantum computer that executes programs, where the programs can be defined using fusion graphs or other techniques that specify the set of operations for each resource state. More generally, interleaving modules can be used to perform a variety of operations related to creating and measuring entangled systems of qubits.

### 3.1. Circuit Components for Interleaving Modules

### 3.1.1. Resource State Interconnect (RSI)

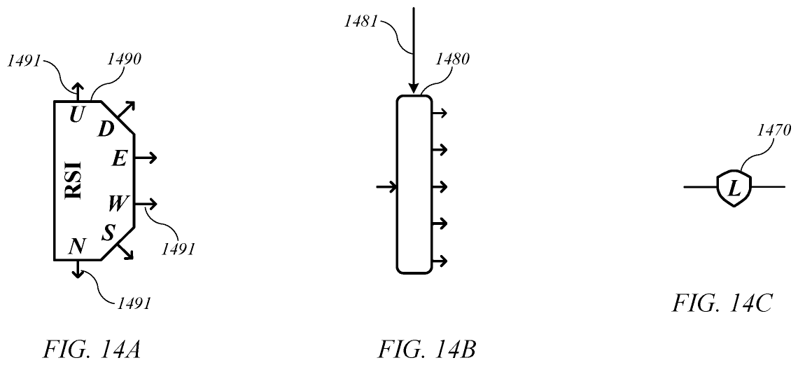

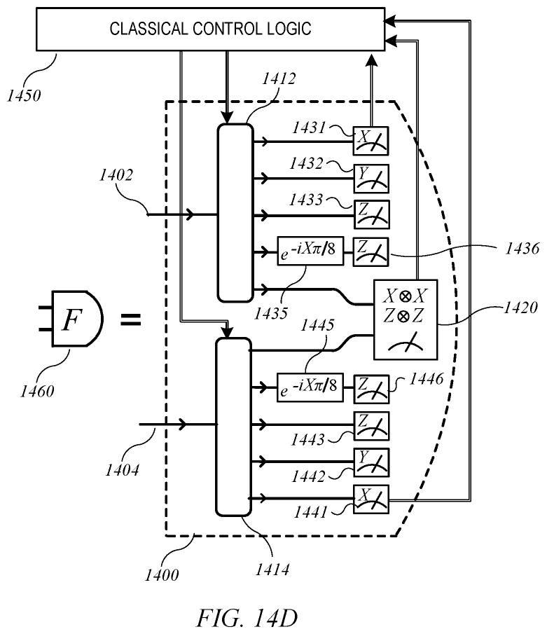

In some embodiments, an interleaving module includes a resource state interconnect, also referred to herein as an “RSI circuit” or “RSI”. FIG. 14A shows a circuit symbol denoting an RSI circuit 1490 in drawings herein. RSI circuit 1490 can be implemented using any circuit or components whose outputs are qubits of a resource state (which, as described above, is a quantum system of entangled qubits), with different output paths 1491 used to output different qubits of the resource state. In some embodiments, RSI circuit 1490 can be implemented as a circuit or other hardware device that generates one resource state per cycle of an “RSI clock.” In other embodiments, RSI circuit 1490 can be implemented as an input port that receives and distributes resource states that were generated in other hardware. For example, RSI circuit 1490 can include a set of waveguides coupled at one end to an external circuit or component (not shown) that generates resource states and at the other end to output paths 1491 of RSI circuit 1490. Any combination of photonic waveguides formed in integrated circuits, optical fibers, other waveguides, and/or other optical interconnects can be used. RSI circuit 1490 can receive resource states from an external resource state generator circuit and route the qubits to respective output paths 1491 at a rate of one resource state per RSI clock cycle. In this manner, RSI circuit 1490 can act as an input port for an interleaving module. For instance, one or more photonic circuits that generate resource states can be implemented at a separate location from the interleaving modules, and the number of such circuits can be equal to or large than the number of interleaving modules. Switching circuits can be provided to selectably route a given resource state from the circuit where it is generated to a particular RSI circuit 1490 in a particular interleaving module. A variety of circuits and couplings can be used, provided that, during a given RSI clock cycle each output path 1491 of RSI circuit 1490 provides a different qubit of the same resource state.

The duration of an RSI clock cycle (also referred to herein as an “operating cycle” or just “clock cycle”) can be chosen as desired, provided that the duration is long enough that the circuit(s) that generate resource states can complete the physical process of producing a resource state. In various embodiments, the operating cycle time can be ˜1 ns or ˜10 ns, although longer or shorter operating cycle times are not precluded.

The particular size and entanglement geometry of the resource states can be chosen as a design parameter. In some cases, the optimal size may depend on the particular physical implementation of the qubits. For example, as described above, qubits can be implemented using photons propagating in waveguides. The processes used to generate the photons and create entanglement may be stochastic (i.e., the probability of successfully generating a photon in any given instance is significantly less than 1). Where generation or entanglement of qubits is stochastic, multiplexing techniques or other techniques may be used to increase the probability of producing a resource state having a specified entanglement structure (for each attempt). In addition, the size of the resource state can be chosen for a particular implementation based in part on the rate of errors in resource state generation that can be tolerated and the particular probability of producing a resource state having a specified entanglement structure. Examples described herein refer to resource states having six qubits associated with different directions in entanglement space (e.g., 6-ring resource state 1100), and output paths 1491 of RSI circuit 1490 are sometimes labeled with directions (U, D, E, W, S, N) as an aid to visualization of entanglement patterns. Such labels are not intended to specify a physical arrangement. It should be understood that other resource states can be used, and that resource states can have more or fewer than six qubits and any desired entanglement structure. Each resource state provided to or by RSI circuit 1490 can be a distinct quantum system that is not entangled with other quantum systems. Entanglement between qubits from different resource states may be created through operation of interleaving modules, as in examples described below.

For purposes of understanding the present disclosure, it suffices to understand that generation of resource states can take place within RSI circuit 1490 or in a separate circuit or system whose output qubits are provided to RSI circuit 1490, as long as RSI circuit 1490 can output resource states at a rate of one resource state per RSI clock cycle. However, to provide additional context, examples of techniques for generating resource states will now be described.

In some embodiments, a resource state such as resource state 1100 can be generated using photonic and electronic circuits and components (e.g., of the type described in Section 1.3 above) to produce and manipulate individual photons. In some implementations, a resource state generator (which can be external or internal to RSI circuit 1490) can include one or more integrated circuits fabricated, e.g., using conventional silicon-based technologies. The resource state generator can include photon sources or can receive photons from an external source. The resource state generator can also include photonic circuits implementing Bell state generators and fusion operations as described above. To provide robustness, an external resource state generator can include multiple parallel instances of various photonic circuits with detectors and electronic control logic to select a successful instance of the resource state to propagate via RSI circuit 1490. One skilled in the art will know various ways to construct a photonic resource state generator capable of generating resource states having a desired entanglement geometry.

In some embodiments, resource states can be generated using techniques other than linear optical systems. For instance, various devices are known for generating and creating entanglement between systems of “matter-based” qubits, such as qubits implemented in ion traps, other qubits encoded in energy levels of an atom or ion, spin-encoded qubits, superconducting qubits, or other physical systems. It is also understood in the art that quantum information is fungible, in the sense that many different physical systems can be used to encode the same information (in this case, a quantum state). Thus, it is possible in principle to swap the quantum state of one system onto another system by inducing interactions between the systems. For example, the state of a qubit (or ensemble of entangled qubits) encoded in energy levels of an atom or ion can be swapped onto the electromagnetic field (i.e., photons). It is also possible to use transducer technologies to swap the state of a superconducting qubit onto a photonic state. In some instances, the initial swap may be onto photons having microwave frequencies; after the swap, the frequencies of the photons can be increased into the operation frequencies of optical fiber or other optical waveguides. As another example, quantum teleportation can be applied between matter-based qubits and Bell pairs in which one qubit of the Bell pair is a photon having frequency suitable for optical fiber (or other optical waveguides), thereby transferring the quantum state of the matter-based qubits to a system of photonic qubits. Accordingly, in some embodiments matter-based qubits can be used to generate a resource state that consists of photonic qubits.

### 3.1.2. Switching Circuit

FIG. 14B shows a symbol denoting a switching circuit (or “switch”) 1480. Inputs and outputs to switching circuit 1480 can include any number of qubits, and the number of inputs need not equal the number of outputs. Switching circuit 1400 can incorporate any combination of one or more active optical switches, mode couplers, phase shifters, or the like. A switching circuit can be configured to perform an active operation that reconfigures input modes (e.g., to effect a basis change for a qubit by coupling the modes of the qubit) and/or applies a phase to one or more of the input modes (which can affect subsequent coupling between modes). In some instances, a switching circuit 1480 implements a routing switch that can couple an input qubit to one of two or more alternative output paths. In some embodiments, operation of switching circuit 1480 (e.g., selection of a routing path) can be controlled dynamically in response to a classical control signal 1481, the state of which can be determined based on results of previous operations, a particular computation to be performed, a configuration setting, timing counters (e.g., for periodic switching), or any other parameter or information.

### 3.1.3. Delay Circuit

FIG. 14C shows a symbol denoting a delay circuit (also referred to as a “delay line”) 1470. A delay circuit delays a qubit for a fixed length of time and can serve as memory for the quantum information stored in the qubit. The length of time (in clock cycles) is indicated by a number, in this example L, meaning a delay of L clock cycles. In the case of photonic qubits, a delay circuit can be implemented, e.g., by providing one or more suitable lengths of optical fiber or other waveguide material, so that the photon of the delayed qubit travels a longer path than the photon of a non-delayed qubit.

### 3.1.4. Reconfigurable Fusion Circuit

FIG. 14D shows a simplified schematic diagram of a reconfigurable fusion circuit 1400 according to some embodiments. Reconfigurable fusion circuit 1400 receives two qubits on input paths 1402, 1404. It should be understood that the qubits can be photonic qubits using a dual-rail encoding (e.g., as described in Section 1.3 above) and that each path shown in FIGS. 14A-14D can be implemented using a pair of waveguides. More generally, the number of waveguides corresponding to each path can be selected according to a particular photonic encoding of qubits. Each qubit enters an active optical switch: input path 1402 enters switch 1412, and input path 1404 enters switch 1414. Each of switches 1412, 1414 can be a 1×5 routing switch that selectably routes the input to one of five possible output paths. Switch 1412 has output paths coupled to each of five “destinations”: fusion circuit 1420, Pauli X measurement circuit 1431, Pauli Y measurement circuit 1432, Pauli Z measurement circuit 1433, and phase rotation circuit 1435, which provides its output to Pauli Z measurement circuit 1436. Similarly, switch 1412 also has output paths coupled to each of five “destinations”: fusion circuit 1420, Pauli X measurement circuit 1441, Pauli Y measurement circuit 1442, Pauli Z measurement circuit 1443, and phase rotation circuit 1445, which provides its output to Pauli Z measurement circuit 1446. The Pauli X, Y, and Z measurements are defined for qubits, and each Pauli measurement circuit 1431-1433, 1436, 1441-1443, 1446 can include a basis rotation (for the X, Y, or Z basis as appropriate), which can be implemented using mode couplers and phase shifters as described above, followed by a detector coupled to each mode. For instance, where qubits are represented in a dual-rail encoding, a detector can be coupled to the end of each of the two waveguides representing a qubit. The measurement result can include a number of photons detected by each detector, or a binary-valued signal from each detector indicating whether a photon was detected or not.

Fusion circuit 1420 can be, e.g., a type II fusion circuit as described above with reference to FIGS. 9A and 9B. Fusion circuit 1420 can provide Pauli XX and ZZ joint measurements on a pair of input qubits, e.g., using detectors 957 as shown in FIG. 9A. As described above, each detector 957 can provide a classical output signal, which can be, e.g., a binary logic signal indicating whether a photon was detected or a count of the number of photons detected.

Phase shift circuits 1435, 1445 each apply a phase shift of e^{iπ/8} prior to a Pauli Z measurement circuits 1436, 1446. In some embodiments, this phase rotation path can be used in generating so-called “magic” states to support various implementations of FBQC. (Magic states and applications thereof in FBQC are described further in above-referenced WO 2021/155289.)

Switches 1412, 1414 are controlled by classical control logic 1450. Classical control logic 1450 can be implemented as a digital logic circuit with an arrangement of classical logic gates (AND, OR, NOR, XOR, NAND, NOT, etc.), such as a field programmable gate array (FPGA) or system-on-a-chip (SOC) having a programmable processor and memory, or an on-chip hard-wired circuit, such as an application specific integrated circuit (ASIC). In some embodiments, switches 1412, 1414 are coupled to an off-chip classical computer having a processor and a memory, and the off-chip classical computer is programmed to perform some or all of the operations of classical control logic 1450. In some embodiments, classical control logic 1450 (which can include an off-chip classical computer) can be provided with program code indicating the type of measurement desired for each pair of qubits input to reconfigurable fusion circuit 1400 (which can be determined from a fusion graph as described above), and classical control logic 1450 can send control signals to switches 1412, 1414 to configure reconfigurable fusion circuit 1400 to perform the desired measurements at the desired time.

Classical control logic 1450 can also receive the classical output signals (measurement outcome data) from all of measurement circuits 1431-1433, 1441-1443, 1436, 1446, and fusion circuit 1420. In some embodiments, classical control logic 1450 can execute decoding logic to interpret the results of quantum computations based on the measurement outcome data, and in some instances, results of the decoding logic can be used as inputs to determine subsequent settings for switches 1412, 1414. In addition or instead, classical control logic 1450 can provide measurement outcome data to other systems or devices, which can decode the measurement outcome data and/or perform other operations using the measurement outcome data.

Shown at the left side of FIG. 14D is a circuit symbol 1460 that is used in subsequent figures to represent an instance of reconfigurable fusion circuit 1400.

### 3.2. Fully Networked Unit Cells

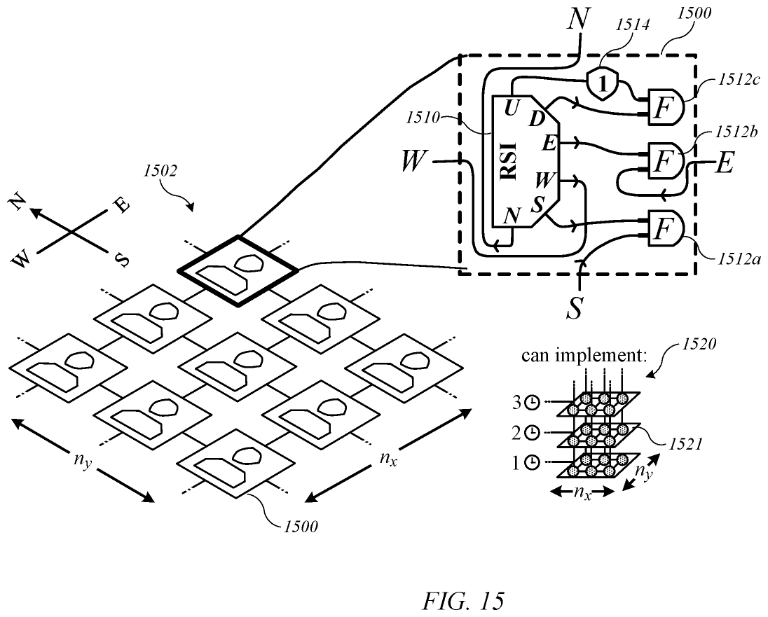

FIG. 15 shows a simplified schematic diagram of a “fully networked” implementation of unit cells to execute fusion graphs according to some embodiments. A number (nₓ×n_{y}) of unit cells 1500 are connected to form a network array (or network) 1502, with connections between adjacent unit cells 1500 as indicated in the drawing. The number nₓ×n_{y} can correspond to the dimensions of a layer in a fusion graph. For instance, for the fusion graph of FIG. 13A, the layer dimensions are 36×18. In some applications, the layer dimensions may be much larger (e.g., on the order of 10²×10² or 10³×10³). It should be understood that, as with all schematic diagrams herein, the arrangement of components in the schematic diagram need not imply any particular physical arrangement of hardware components.

Each unit cell 1500 can include an RSI circuit 1510, which can be an instance of RSI circuit 1490 of FIG. 14A, and three reconfigurable fusion circuits 1512a, 1512b, 1512c, each of which can be an instance of reconfigurable fusion circuit 1400 of FIG. 14D. Each unit cell 1500 can also include a delay line 1514 that introduces 1 RSI cycle of delay. Delay line 1514 can be implemented using a suitable length of waveguide (e.g., optical fiber), as described above.

As shown by fusion graph 1520, network array 1502 can implement a fusion graph in which one layer 1520 having dimension nₓ×n_{y} is generated on each RSI cycle. In each unit cell 1500, a resource state having six qubits (labeled N, S, E, W, U, and D as in diagrams above) is provided by each RSI 1510 during each RSI cycle. Each qubit is provided on a separate output path, either to one of reconfigurable fusion circuits 1512a-1512c or to a neighboring unit cell 1500. In the example shown, the N qubit is provided to the neighboring unit cell 1500 in the N direction. The S qubit is provided to reconfigurable fusion circuit 1512a, which also receives an N qubit from the neighboring unit cell 1500 in the S direction. Similarly, the W qubit is provided to the neighboring instance of unit cell 1500 in the W direction. The E qubit is provided to reconfigurable fusion circuit 1512b, which also receives a W qubit from the neighboring unit cell 1500 in the E direction. The U qubit is delayed by one RSI cycle using delay line 1514, then provided to reconfigurable fusion circuit 1512c synchronously with the D qubit of the resource state generated by the same RSI 1510 during the next RSI cycle. In some embodiments, computations can be implemented by controlling the switches in each reconfigurable fusion circuit 1512a-1512c in each unit cell 1500.

Although not shown in FIG. 15, in some embodiments, single-photon measurement circuits (similar to Pauli measurement circuits 1431-1433 shown in FIG. 14D) can be coupled to routing paths of unit cells 1500 at the boundaries of network array 1502 to perform single qubit measurements for qubits at the outer boundaries of the fusion graph. Other options for managing qubits at the outer boundaries of a fusion graph can also be provided.

### 3.3. Patch-Based Layer Generation

The fully networked configuration shown in FIG. 15 uses network array 1502 of nₓ×n_{y} unit cells 1500 to generate a layer of dimension nₓ×n_{y} at each RSI clock cycle. As noted above, the layer dimension may be quite large, and implementing a network array 1502 can require a considerable amount of hardware. To reduce the amount of hardware required, network array 1502 can be modified to generate a layer by producing a set of k “patches” of dimension P=nₓ×n_{y} for some integer k>1. The total layer size can be nₓ×n_{y}×k.

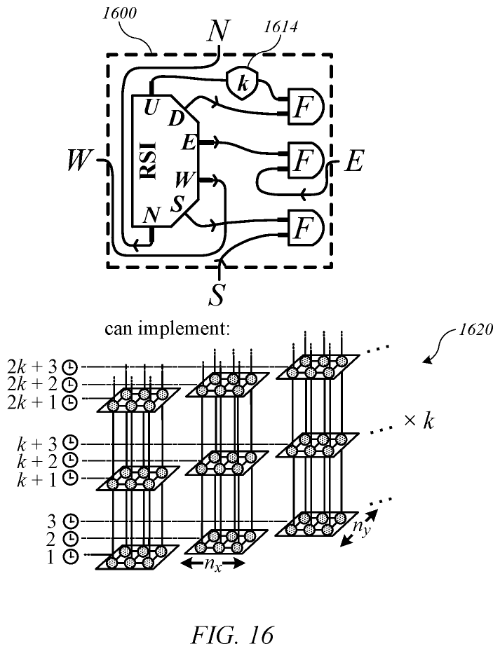

FIG. 16 shows a simplified fusion graph 1620 illustrating patch-based generation of a layer using a network array of unit cells 1600 according to some embodiments. Fusion graph 1620 shows that each layer is generated across a set of k RSI cycles. The unit cells 1600 used to implement fusion graph 1620 can be connected in a network similarly to network array 1502 of FIG. 15. Unit cells 1600 differ from unit cells 1500 of FIG. 15 in that the 1-cycle delay line 1514 is replaced with a k-cycle delay line 1614, so that the U qubit is delayed until the RSI cycle in which RSI 1610 generates the resource state for the corresponding position in the next layer.

Fusion graph 1620 shows a set of k disjoint cuboids. In some embodiments, adjacent patches in each layer can be “stitched” together using additional reconfigurable fusion circuits, switching circuits, and delay lines (not shown in FIG. 16). Suitable circuits for implementing stitching between patches will become apparent in view of the following sections.

### 3.4. Networks of Interleaving Modules

According to some embodiments, an alternative approach to executing a fusion graph involves the use of a network array of “interleaving modules,” where each interleaving module is configured to process a contiguous patch of size L² in L² RSI cycles, and patches produced by adjacent interleaving modules can be stitched together at the boundaries. Parameter L, sometimes referred to herein as the “interleaving length,” can be chosen as desired. Considerations relevant to the selection of an interleaving length are described below.

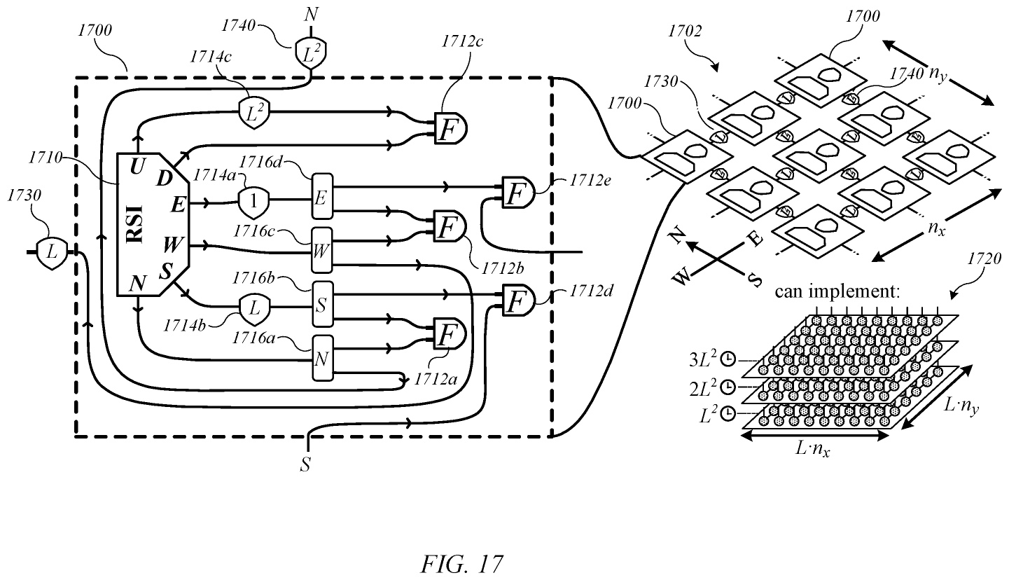

FIG. 17 shows a simplified schematic diagram of a network of interleaving modules according to some embodiments. A number (nₓ×n_{y}) of interleaving modules 1700 are connected to form a network array 1702, with adjacent interleaving modules 1700 connected by delay lines 1730, 1740 as indicated in the drawing. Delay line 1730 connects one instance of interleaving module 1700 to its neighbor in the W direction and introduces a delay of L RSI cycles. Delay line 1740 connects one instance of interleaving module 1700 to its neighbor in the N direction and introduces a delay of L² RSI cycles. Network array 1702 can be used to generate a fusion graph 1720 with layers having dimensions (L·nₓ)×(L·n_{y}).

Each interleaving module 1700 includes an RSI circuit 1710 that outputs, or provides, a resource state having six qubits (labeled N, S, W, E, D, U) during each RSI cycle. Reconfigurable fusion circuits 1712a, 1712b, 1712c, also referred to as “local” fusion circuits, can be instances of reconfigurable fusion circuit 1400 of FIG. 14 and can be used to selectably perform fusion operations or single-qubit measurement operations on qubits of different resource states provided by the RSI circuit 1710 in the same interleaving module 1700 during different RSI cycles. In addition, to allow entanglement between resource states provided by RSI circuits 1710 in neighboring instances of interleaving module 1700, additional “network” fusion circuits 1712d, 1712e can be provided. Network fusion circuits 1712d and 1712e can be additional instances of reconfigurable fusion circuit 1400 of FIG. 14D that selectably perform fusion operations or single-qubit measurement operations on a qubit of a locally generated resource state and a “networked” qubit received from a neighboring instance of interleaving module 1700. Routing switches 1716a-1716d can be switching circuits (e.g., as described above) that are configured to selectably route the N, S, W, and E qubits of a particular resource state to one of local fusion circuits 1712a, 1712b (which receives qubits of different resource states provided by the same RSI circuit 1710 in different operating cycles) or to one of network fusion circuits 1712d, 1712e (which receives qubits of different resource states provided by different RSI circuits 1710 in neighboring instances of interleaving module 1700).

In this example, each interleaving module 1700 constructs a “row” of a patch by proceeding from W to E during L successive RSI cycles, then constructs the next row in the S direction during the next L RSI cycles, and so on. Accordingly, delay line 1714a provides one RSI cycle of delay for the E qubit. If switch 1716d is set to select the local path (i.e., the path coupled to local fusion circuit 1712b) when the E qubit arrives, the E qubit of a first resource state output by RSI 1710 can arrive at local fusion circuit 1712b synchronously with the W qubit of the next resource state output by RSI 1710. Likewise, delay line 1714b provides L RSI cycles of delay for the S qubit. If switch 1716b is set to select the local path (i.e., the path coupled to local fusion circuit 1712a) when the S qubit arrives, the S qubit of the first resource state output by RSI 1710 can arrive at local fusion circuit 1712a synchronously with the N qubit of another resource state output by RSI 1710 L RSI cycles later, which enables fusion operations between qubits of resource states corresponding to adjacent lattice positions in different rows. As noted above, interleaving module 1700 constructs a patch for a layer in L² RSI cycles. Accordingly, delay line 1714c provides L² RSI cycles of delay for the U qubit, so that the U qubit of resource state output by RSI 1710 arrives at fusion circuit 1712c synchronously with the D qubit of a different resource state output by RSI 1710 for the corresponding position in the next layer.

Network fusion circuits 1712d, 1712e can each receive a “local” qubit output by the local RSI 1710 (i.e., the RSI 1710 in the same interleaving module with network fusion circuits 1712d, 1712e) and a “networked” qubit from a neighboring interleaving module 1700, enabling patches generated by different interleaving modules 1700 to be “stitched” together via fusion operations. The networked qubits can pass through delay lines 1730, 1740. Thus, for instance, a networked qubit from a neighboring interleaving module 1700 in the E direction can arrive at network fusion circuit 1712d synchronously with the “local” E qubit of the resource state that is adjacent in the fusion graph.

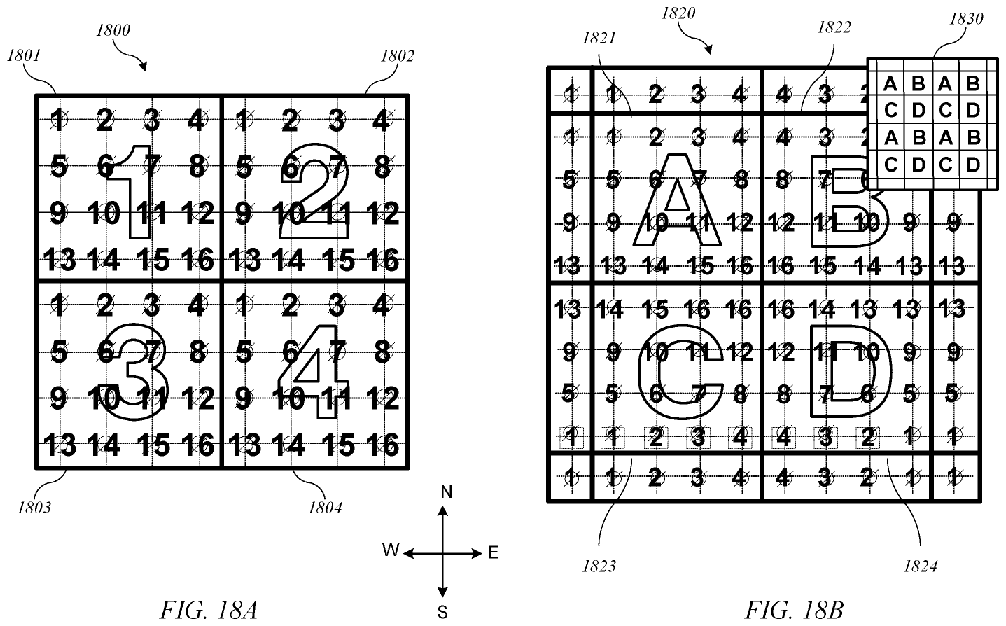

In this manner, each interleaving module 1700 can execute a contiguous patch within each layer of a fusion graph, and patches executed by different interleaving modules 1700 can be stitched together at the boundaries. In some embodiments, the order of operations for each interleaving module 1700 can be specified using “interleaving coordinates” assigned to vertices in a fusion graph. An interleaving coordinate can specify a layer number, a patch number within a layer (which identifies which interleaving module executes the patch), and a cycle number within the patch (which identifies the order of processing vertices, or resource states, within the patch). FIG. 18A shows an assignment of interleaving coordinates to vertices within a single layer 1800 of a fusion graph according to some embodiments. In this example, the interleaving length L is 4, and there are assumed to be four interleaving modules 1700 connected in a 2×2 network array; the layer dimensions are thus 8×8. As indicated by the large number in each patch, NW patch 1801 is assigned to a first interleaving module 1700, NE patch 1802 to a second interleaving module 1700, SW patch 1803 to a third interleaving module 1700, and SE patch 1804 to a fourth interleaving module 1700. Within each patch 1801-1804, vertices are numbered 1-16 to identify the RSI cycle during which the resource state corresponding to that vertex is generated. Thus, during RSI cycle 1, the NW-most vertex in each patch 1801-1804 is generated; during RSI cycle 2, the adjacent vertex in the E direction is generated, and so on through RSI cycle 4. During RSI cycle 5, the vertex adjacent in the S direction to the NW-most vertex in each patch is generated, and so on. For convenience, the W-E direction is sometimes referred to as a “row,” while the N-S direction is sometimes referred to as a “column.”

Delay lines 1730, 1740 connected between instances of interleaving module 1700 can provide appropriate delays so that qubits of resource states generated by neighboring instances of interleaving module 1700 arrive synchronously at network fusion circuits 1712d, 1712e. For example, during RSI cycle 1, the RSI circuit 1710 in the second interleaving module 1700 (assigned to NE patch 1802) outputs a resource state having a W qubit that is routed by switch 1716c onto the network path and into delay line 1730. In this example, delay line 1730 adds L=4 RSI cycles of delay, so that the W qubit arrives at network fusion circuit 1712e of the first interleaving module 1700 (assigned to NW patch 1801) during RSI cycle 5. In the meantime, during RSI cycle 4, the RSI circuit 1710 in the first interleaving module 1700 outputs a resource state having an E qubit that is delayed for one RSI cycle by delay line 1714a. During the next RSI cycle (cycle 5), the delayed E qubit is routed by switch 1716d to network fusion circuit 1712e. Thus, qubits from resource states output by RSI circuits 1710 in different interleaving modules can be correctly synchronized across patch boundaries. Similar considerations apply for patch boundaries in the N-S direction.

In some embodiments, delay lines 1730, 1740 can be omitted. For example, FIG. 18B shows an alternative assignment of interleaving coordinates to vertices within a layer 1820 of a fusion graph according to some embodiments. The notation is similar to the notation of FIG. 18A, except that the different interleaving modules 1700 are identified using letters A, B, C, and D, which indicate interleaving modules that are configured somewhat differently from each other, as will become apparent. Layer 1820 is also shown as being larger than 8×8, to illustrate how the pattern can be extended to interleaving module networks of arbitrary size. As indicated by the cycle numbers for each vertex, interleaving module A begins with the NW-most resource state in patch 1821 and proceeds along a row in the E direction, then to the next row in the S direction (as in FIG. 18A). Interleaving module B begins with the NE-most resource state in patch 1822 and proceeds along a row in the W direction, then to the next row in the S direction. Instance C of interleaving module 1700 begins with the SW-most resource state in patch 1823 and proceeds along a row in the E direction, then to the next row in the N direction. Instance D of interleaving module 1700 begins with the SE-most resource state in patch 1823 and proceeds along a row in the W direction, then to the next row in the N direction. As the cycle numbers indicate, whenever neighboring resource states are output by RSI circuits 1710 in different instances of interleaving module 1700, those resource states are output in the same RSI cycle, and delay lines on the network paths connecting different interleaving modules can be omitted. In this case, interleaving modules of types A, B, C, and D are configured with internal delay lines in different locations according to the direction of traversing the patch. For instance, where an interleaving module of type A (which can be implemented as shown for interleaving module 1700 of FIG. 17) delays the E qubit of a resource state by 1 RSI cycle, an interleaving module of type B would instead delay the W qubit of a resource state by 1 RSI cycle. Similarly, an interleaving module of type C would delay the N qubit by L cycles rather than delaying the S qubit. The appropriate modifications to interleaving module 1700 to delay the appropriate qubits are straightforward. Inset 1830 shows that the ABCD pattern of patches can be repeated to support a larger network with more interleaving modules, without using delay lines on the network paths.

### 4. FBQC Using Interleaving Modules

In some embodiments, a network array 1702 of interleaving modules 1700 can be used to implement FBQC. For example, a network array of interleaving modules can be used to implement the computation represented by the fusion graph of FIGS. 13A-13C.

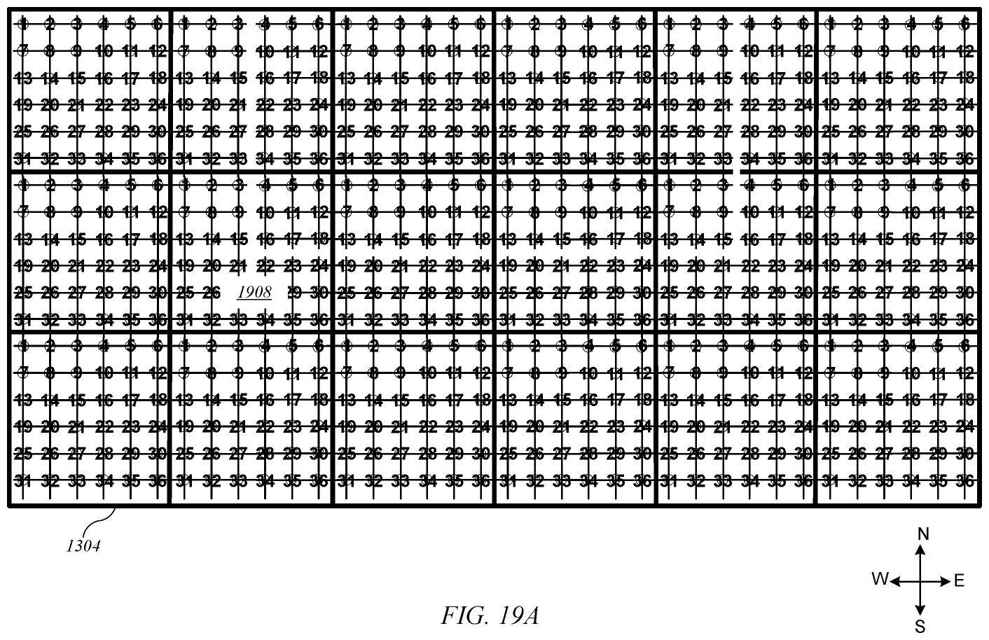

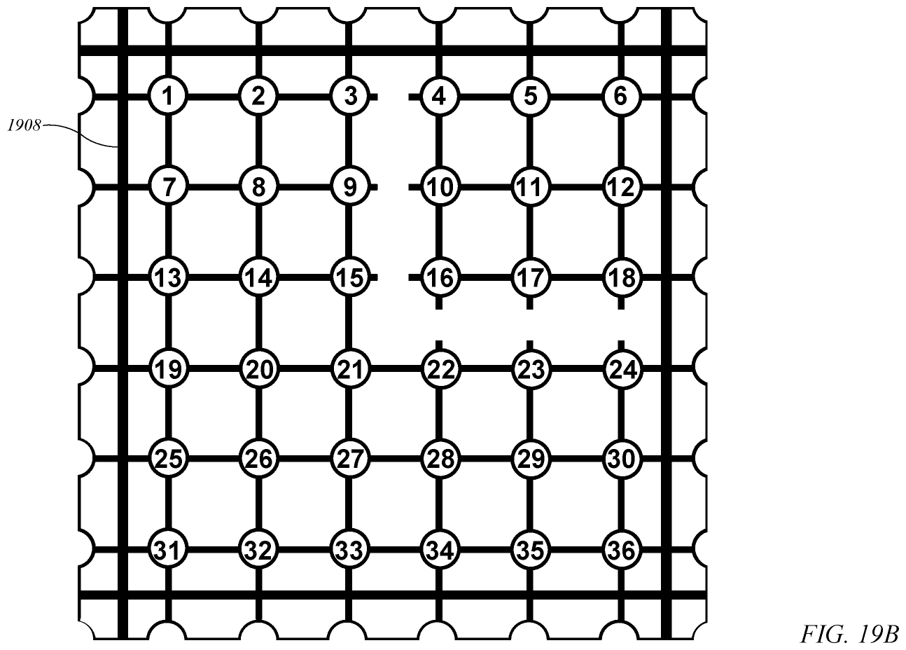

By way of example, FIG. 19A shows a view of representative layer 1304 of FIG. 13C, with interleaving coordinates overlaid thereon, according to some embodiments. In this example, network array 1700 is assumed to have dimensions 6×3 and an interleaving length L=6. Interleaving coordinates are assigned similarly to FIG. 18A, proceeding within each patch from W to E, and from N to S.

FIG. 19B shows a detailed view of patch 1908 of FIG. 19A. As can be seen, the patch boundaries need not align with logical qubits or any other boundary in the fusion graph. (Stated differently, code distance and interleaving length need not have any particular relationship.) In some embodiments, patch 1908 can be interpreted as a sequence of instructions for setting the states of switches 1716a-1716d and reconfigurable fusion circuits 1712a-1712e of interleaving module 1700 during each RSI cycle. For instance, in each RSI cycle, the state of switches 1716a-1716d, which control whether qubits are routed to local fusion circuits 1712a-1712b, to network fusion circuits 1712d-1712e, or to network delay lines 1730, 1740, can be determined from the interleaving coordinate associated with the current RSI cycle. The state of each reconfigurable fusion circuit 1712a-1712e (each of which can be an instance of reconfigurable fusion circuit 1400 of FIG. 14) can be determined based on the connectivity between vertices for the resource state at that interleaving coordinate.

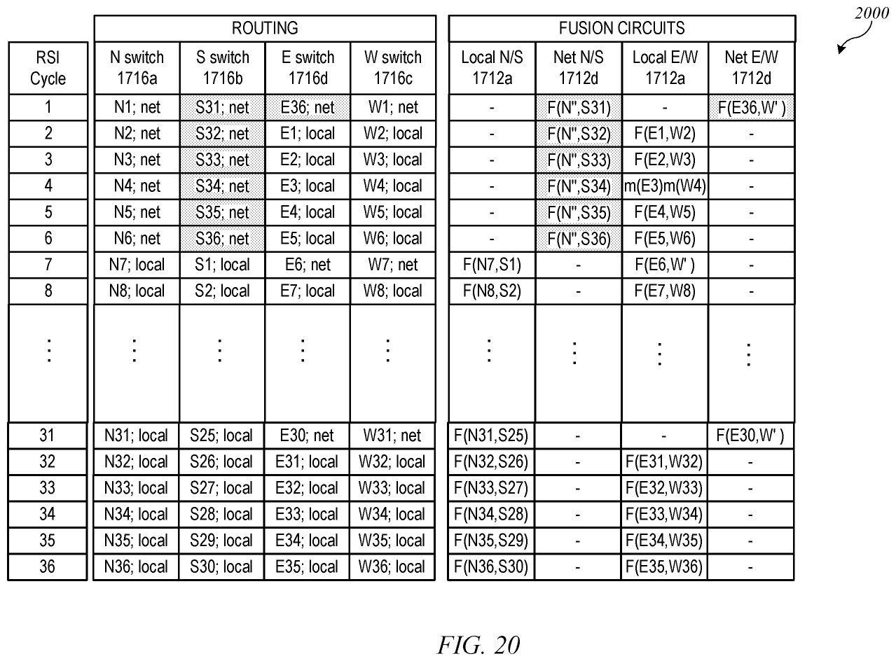

FIG. 20 shows a table 2000 illustrating settings of switches 1716a-1716d and reconfigurable fusion circuits 1712a, 1712b, 1712d, 1712e of interleaving module 1700 that can be determined from patch 1908 according to some embodiments. Qubits propagating through switches 1716a-1716d and reconfigurable fusion circuits 1712a, 1712b, 1712d, 1712e during a given RSI cycle are identified by an alphanumeric code such as N1 or W34; the letter is a directional label for the qubit (as used throughout this description), and the number indicates the RSI cycle during which the resource state including that qubit was output by RSI 1710. Qubits marked with prime (e.g., W′ or N″) are networked qubits received via network paths from neighboring interleaving modules 1700. Table cells shaded in gray indicate operations associated with resource states generated during processing of a previous layer. It should be noted that there does not need to be any “dead” time between layers; after generating all 36 (or, more generally, all L²) resource states associated with one layer of a fusion graph, interleaving module 1700 can immediately begin generating resource states associated with the next layer of the fusion graph.

For each RSI cycle, the state of each switch is indicated by a qubit identifier of the qubit propagating through the switch and either “net” or “local” to indicate whether the switch is set to select the “network” or “local” output path (as labeled in FIG. 17) for that qubit. The state of each reconfigurable fusion circuit is indicated by an operation—either “F( )” for fusion or “m( )” for single-qubit measurement; the operands are qubit identifiers. In this example, the type of single-qubit measurement (Pauli X, Y, or Z) is not specified. In some embodiments, the type of single-qubit measurement can be specified or inferred from the fusion graph. As shown in FIG. 14D, the selection of operations for a reconfigurable fusion circuit can be controlled by selecting the corresponding state for switches 1412, 1414.

As shown, for resource states output by RSI circuit 1710 during cycles 1 and 2, all qubits are routed to fusion operations with appropriate qubits of other resource states. (In the case of qubit W1, a network fusion operation is selected.) For the resource states generated during cycles 3 and 4, qubit E3 and qubit W4 are routed to single-qubit measurements, in accordance with the half-lines in patch 1908. Switch settings for other RSI cycles can likewise be determined based on the fusion graph.

The state of U/D reconfigurable fusion circuit 1712c is not shown in FIG. 20. In this example, U/D fusion circuit 1712c can perform fusion operations for each layer except for D qubits in the first layer and U qubits in the last layer, for which single-qubit measurements can be selected. Delay line 1714c provides an L² delay (in this case, 36 RSI cycles), so that U/D fusion circuit 1712 fuses the U1 qubit of one layer with the D1 qubit of the next layer. In some embodiments, other behaviors can be implemented, and operations for each U qubit and D qubit can be determined from the fusion graph.

As this example shows, switch settings for an interleaving module with reconfigurable fusion circuits can be determined based on a fusion graph. Accordingly, a data structure representing a fusion graph can be provided as input to classical control logic, and the classical control logic can determine a corresponding sequence of switch settings and control operation of a networked array of interleaving modules to execute the computation specified by the fusion graph. Other inputs can also be provided, including a set of instructions that lists the settings for each operating cycle.

It should be appreciated that a network of interleaving modules as shown in FIG. 17 can be used to generate layers of any size. (In some embodiments, the size may be fixed in the hardware design.) The number of interleaving modules (N) and the interleaving length L can be varied as desired; in an extreme case, N can be reduced to 1. For a given layer size, different choices of N and L will result in different computation times, and choices can be made to achieve a desired balance between hardware size and computational speed.

### 5. Interleaving Modules with Additional Capabilities

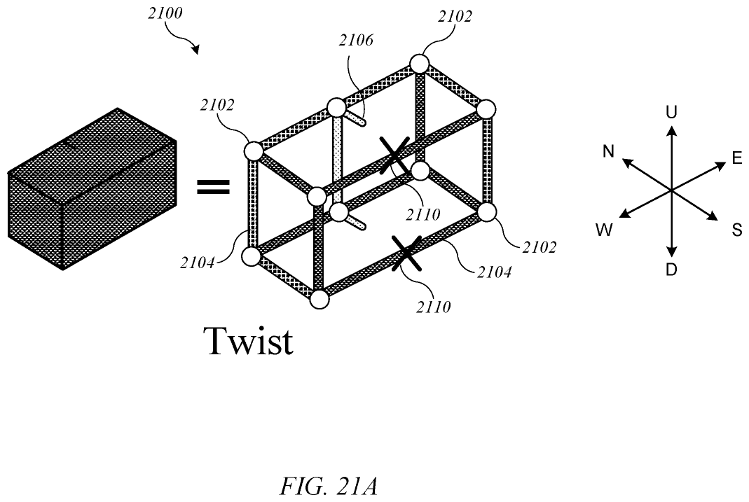

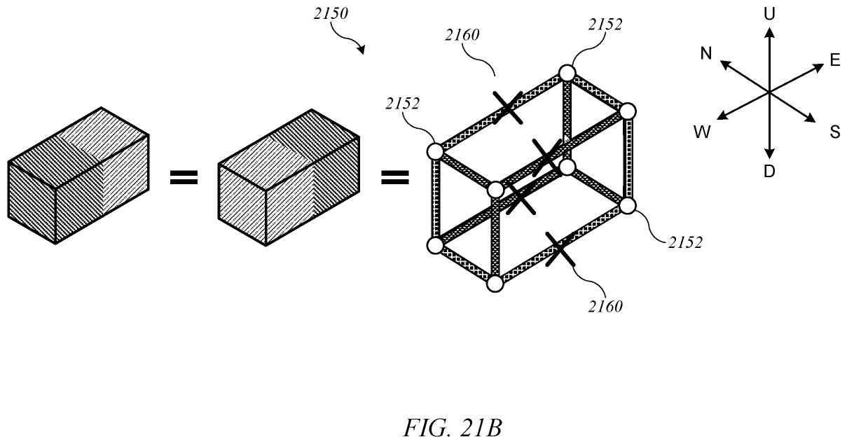

In examples described above, it is assumed that a fusion graph can be based on a regular bulk lattice in entanglement space. For instance, fusion graphs shown above have a structure that can be represented as layers, with each layer having an associated regular array (or 2D lattice) of resource states. For some logical operations, it may be desirable to introduce irregularities at selected locations in the lattice. (“Irregularity,” or “defect,” is used in this context to refer to a variation from the bulk lattice that changes the number of resource states (or vertices) in a layer.) By way of example, FIGS. 21A and 21B show examples of fusion graphs for operations that change the lattice structure. In these examples, only the portion of the fusion graph corresponding to a particular operation is shown. It should be understood that these operations can be incorporated into a larger fusion graph in which the operations shown create irregularities in a bulk lattice, e.g., as shown in fusion graph 1240c in FIG. 12D.

FIG. 21A shows a fusion graph 2100 for a “twist” operation. Ten resource states (vertices 2102, shown as circles) are involved in the twist operation, with five vertices 2102 in each of two different layers along the U-D axis. As in previous fusion graphs, lines 2104 connecting two vertices indicate type II fusion operations; half-lines 2106 connected to a single vertex indicate single qubit Pauli measurement. (The shading pattern is the same as in legend 1250 of FIG. 12E.) In this case, the single qubit measurements (half-lines 2106) are Pauli Y measurements. The two “X” marks 2110 correspond to lattice locations that are “skipped” by the twist operation. That is, qubits from any resource state that may be associated with the skipped location 2110 are not subject to any fusion or other measurement operations.

FIG. 21B shows a fusion graph 2150 for a “dislocation” operation, using the same notation as FIG. 21A. Eight resource states (vertices 2152) are involved in E-W fusion operations associated with the dislocation operation. However, the dislocation operation couples resource states that are not at adjacent lattice locations in the E-W direction. As indicated by “X” marks 2160, four lattice locations are skipped by the dislocation operation.

Whether a resource state is generated for a skipped lattice location 2110 or 2160 is a matter of design choice, as long as any qubits associated with the skipped lattice location do not interact with other qubits. In some embodiments, generation of a resource state for a skipped location 2110 can be prevented or avoided (e.g., by not providing a resource state to the RSI circuit during the corresponding RSI cycle or by not triggering the RSI circuit to generate a resource state during the corresponding RSI cycle). In other embodiments a resource state for a skipped location 2110 may be generated and its qubits thereafter absorbed. For example, an RSI circuit can include “terminal” routing paths that terminate in an opaque material and routing switches to selectably route qubits into either the terminal routing paths or the appropriate output paths.

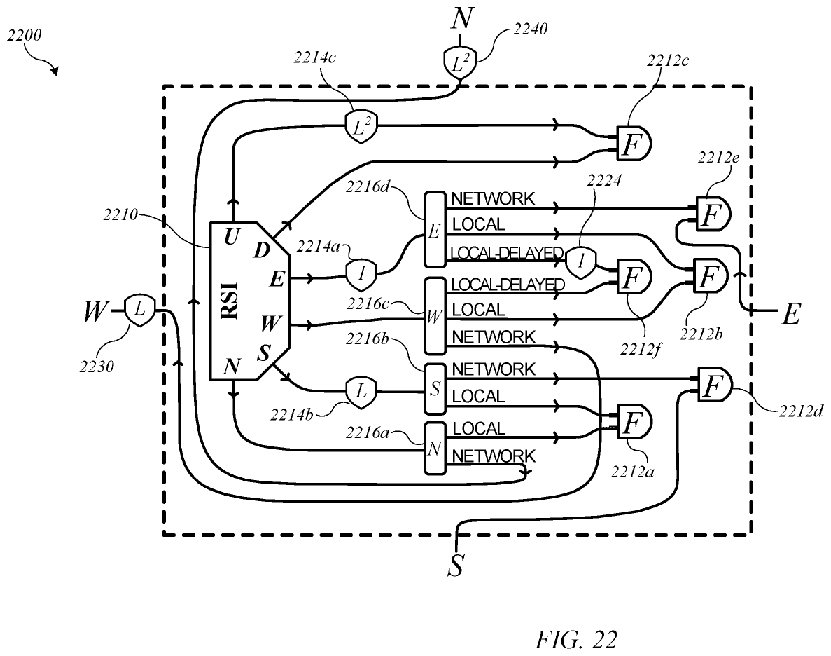

According to some embodiments, an interleaving module can include additional circuitry to support operations such as twists and dislocations. FIG. 22 shows a simplified schematic diagram of an interleaving module 2200 according to some embodiments. Interleaving module 2200 can be similar in structure and operation to interleaving module 1700, with an additional routing option for the E and W qubits. Reconfigurable fusion circuits 2212a, 2212b, 2212c, also referred to as “local” fusion circuits, can be instances of reconfigurable fusion circuit 1400 of FIG. 14D and can be used to selectably perform fusion measurements or single-qubit measurements on qubits of resource states output by RSI circuit 2210 within interleaving module 2200 on different RSI cycles. In addition, to allow entanglement between resource states provided by RSI circuits in neighboring instances of interleaving module 2200, additional “network” fusion circuits 2212d, 2212e can be provided. Network fusion circuits 2212d and 2212e can be additional instances of reconfigurable fusion circuit 1400 of FIG. 14D that selectably perform fusion operations or single-qubit measurements on a qubit of a locally generated resource state and a networked qubit received from a different instance of interleaving module 2200. Reconfigurable fusion circuit 2212f, also referred to as a “local-delayed” fusion circuit, can be another instance of reconfigurable fusion circuit 1400 of FIG. 14D and can be used to create lattice dislocations and twist defects of the kind shown in FIGS. 21A and 21B. Routing switches 2216a and 2216b can be reconfigurable optical switching circuits that are operated to selectably route the N and S qubits of a particular resource state to one of local fusion circuit 2212a or network fusion circuit 2212d, similarly to routing switches 1716a and 1716b of interleaving module 1700 of FIG. 17. Routing switches 2216c and 2216d can be reconfigurable optical switching circuits that are operated to select one of three output paths for the W and E qubits. Where a regular lattice is being processed, routing switches 2216c and 2216d can route the W and E qubits to one of local fusion circuits 2212b or network fusion circuit 2212e, similarly to routing switches 1716a and 1716b of interleaving module 1700 of FIG. 17. When a lattice defect (e.g., dislocation or twist) is to be processed, routing switches 2216c and 2216d can instead select the “local-delayed” paths. On the local-delayed paths, the E qubit (which was already delayed for one RSI cycle by delay line 2214a) can be delayed for an extra RSI cycle by delay line 2224, then delivered to reconfigurable fusion circuit 2212f. The W qubit is delivered to reconfigurable fusion circuit 2212f without additional delay, so that reconfigurable fusion circuit 2212f operates on a W qubit from the current resource state and an E qubit from the resource state output two cycles previously, thereby effecting the “skip” as shown in FIGS. 21A and 21B.

Operation of interleaving module 2200 can be similar or identical to that of interleaving module 1700 described above, except that interleaving module 2200 can support operations that introduce lattice defects.

In the example shown, interleaving module 2200 can introduce irregularities in the E-W direction. If the ability to introduce lattice irregularities in more than one direction is desired, similar routing paths, delay lines, and reconfigurable fusion circuits can be provided for multiple directions, including N-S and/or U-D directions.

### 6. Computational Efficiency Enhancements

In some embodiments, a network array of interleaving modules (e.g., array 1702 of FIG. 17) can provide a general-purpose quantum computer capable of executing any quantum computation that can be expressed using a fusion graph. (Interleaving module 1700 can be used to execute any quantum computation for which the fusion graph does not include lattice defect operations as described above. Interleaving module 2200 or other variations can be substituted into array 1702 as desired.) Any number of interleaving modules can be included in a network array, with each interleaving module generating a patch of a desired size L². For present purposes, it is assumed that the delay lines are fixed-length structures whose length is determined based on the interleaving length L.

For a network having a fixed number of interleaving modules, the use of larger L can increase the number of logical qubits that can be encoded (for a given code distance). However, larger L also can be expected to result in slower logical operations. In this sense, a design tradeoff exists between space (or hardware) and time. For a given quantum computation and a fixed number of interleaving modules, some minimum interleaving length Lₘᵢₙ is required to execute the computation, based on the number and code distance of logical qubits that need to be encoded. At the same time, larger L means longer delay lines, which can in turn imply increased propagation loss in the delay lines (since existing optical fibers and other waveguides are not perfectly transmissive), and at some point the interleaving length may reach a threshold (Lₘₐₓ) where the propagation loss exceeds the loss threshold of the error correcting code. If Lₘᵢₙ exceeds Lₘₐₓ, then additional interleaving modules would need to be added to execute the quantum computation. Thus, the chosen interleaving length L should be between Lₘᵢₙ and Lₘₐₓ. In some embodiments, L=Lₘᵢₙ may be the optimal choice. However, in some embodiments, additional physical qubits can be used to reduce the overall volume of the quantum computation (which can be measured by the size of the fusion graph) by taking advantage of better-than-linear space-time tradeoffs. Where this is the case, interleaving may increase the speed of executing a quantum computation relative to a non-interleaved approach (e.g., the fully networked unit cells of FIG. 15). In addition, because interleaving slows the rate of logical operations, increasing L can reduce the speed of classical processing needed to keep pace with the logical operations. For instance, conditional logic may require the classical processor to receive and decode a first set of measurements corresponding to a first logical operation in order to determine a subsequent logical operation to be executed. If the decoder is slower than the rate at which logical operations can be executed, then the computation may be stalled or slowed. In various embodiments, the interleaving length L can be optimized for a particular hardware implementation based on the foregoing design considerations and/or other considerations.

### 7. Connectivity Enhancements

In examples described above, logical qubits can be represented using square surface codes, which map well to planar topology. For instance, the fusion graph in FIG. 13A can be viewed as a sequence of planar layers coupled by fusion operations between successive layers. However, in some instances, fusion graphs using different topologies may allow more compact logical operations, where compactness can be defined in terms of the volume of a fusion graph corresponding to the logical operation. In some embodiments, a network of interleaving modules can have additional couplings to support execution of more compact fusion graphs. Examples will now be described.

### 7.1. Moving Logical Qubits

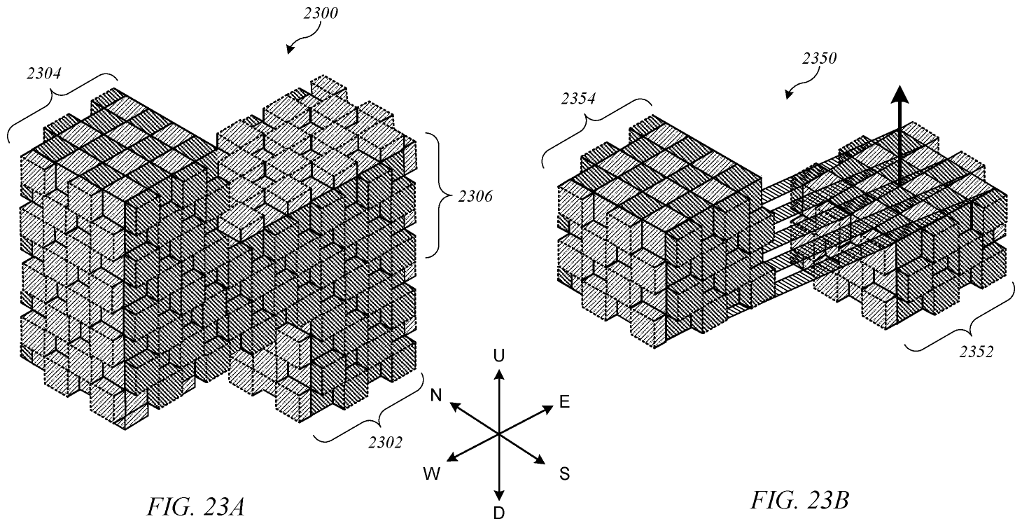

One example where a planar representation may be volume-intensive is the case of “moving” a logical qubit, a logical operation in which a bulk lattice region representing the logical qubit is shifted from one region to another within the fusion graph. For instance, logical qubits may need to be shifted to adjacent regions so that a two-qubit logical operation can be performed between them. FIG. 23A shows an example of a fusion graph 2300 for moving a logical qubit from a source region 2302 to a destination region 2304. The logical qubit is at rest (not interacting), and fusion graph 2300 represents a regular bulk lattice with single-qubit measurements at the boundaries. In this example, there are intermediate layers 2306 (along the U-D direction) associated with the move operation that simply teleport quantum information to the next layer, which can require extra computation time. FIG. 23B shows a fusion graph 2350 for a more efficient implementation of a move operation on a logical quit. In fusion graph 2350, the quantum information is shifted from W to E by the desired number of lattice locations in a single step along the U-D axis, using fusion operations between U qubits in the U-most layer of source region 2352 and D qubits in the D-most layer of destination region 2354.

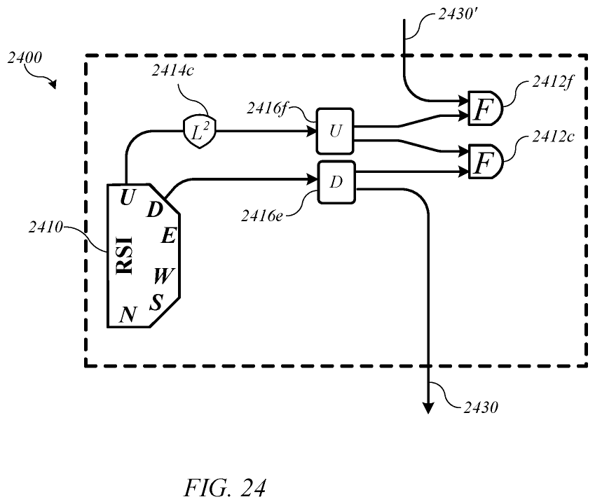

According to some embodiments, this type of “fast” move operation can be implemented using interleaving modules by adding additional routing switches for the U and D qubits. FIG. 24 shows a simplified schematic diagram of an interleaving module 2400 according to some embodiments. Interleaving module 2400 can be similar to interleaving module 2200 (or interleaving module 1700), with the addition of routing switches and a network fusion circuit for the U and D qubits, as shown. Routing switches and fusion circuits for the N, S, E, and W qubits are not shown in FIG. 24; these components and their operation can be similar or identical to components shown in FIG. 17 or 22. As shown in FIG. 24, interleaving module 2400 can include a RSI circuit 2410, which can be identical to other RSI circuits described herein. As with interleaving module 1700, the U qubit of each resource state is routed to delay line 2414c, which can provide L² cycles of delay. Unlike interleaving module 1700, interleaving module 2400 includes additional routing switches 2416e and 2416f. Routing switch 2416e operates to deliver the D qubit either to a local fusion circuit 2412c (which can be identical to local fusion circuit 1712c of FIG. 17) or to a network path 2430 that connects to an instance of interleaving module 2400 elsewhere in the network array. Routing switch 2416f operates to deliver the (delayed) U qubit either to local fusion circuit 2412c or to a network fusion circuit 2412f. Network fusion circuit 2412f can be an instance of reconfigurable fusion circuit 1400 of FIG. 14 that operates on the U qubit delivered by routing switch 2416f and a D qubit received via network path 2430′ from another instance of interleaving module 2400 elsewhere in the network.

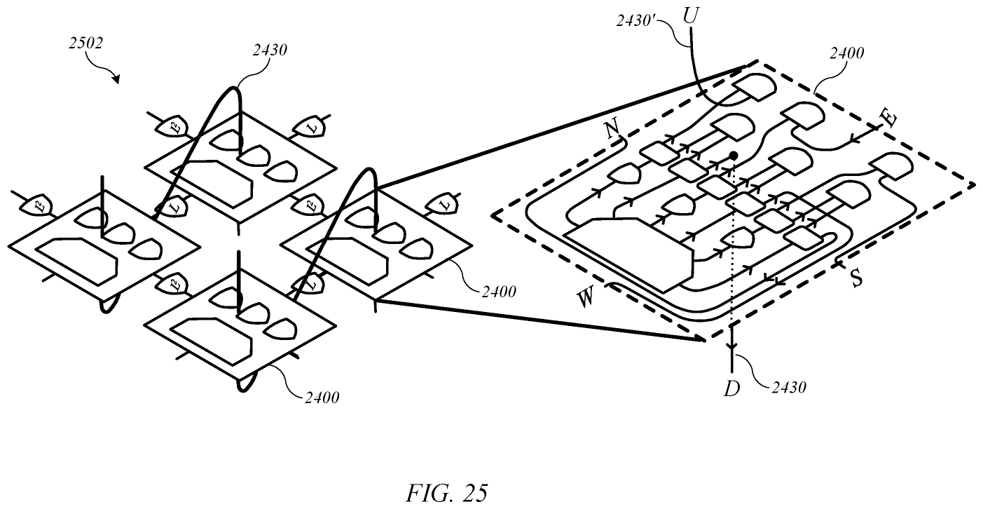

FIG. 25 shows a simplified schematic drawing of the connectivity of network paths 2430 and 2430′ between interleaving modules 2400 in a network array according to some embodiments. Shown is a network array 2502 of interleaving modules 2400. In this example, network paths 2430 transfer qubits between adjacent instances of interleaving module 2400. Accordingly, in consecutive layers, a logical qubit can be shifted by one interleaving length L in the E direction. To support larger shifts between consecutive layers and/or shifts in different directions, the connectivity can be varied as desired.

### 7.2. Periodic Boundary Conditions

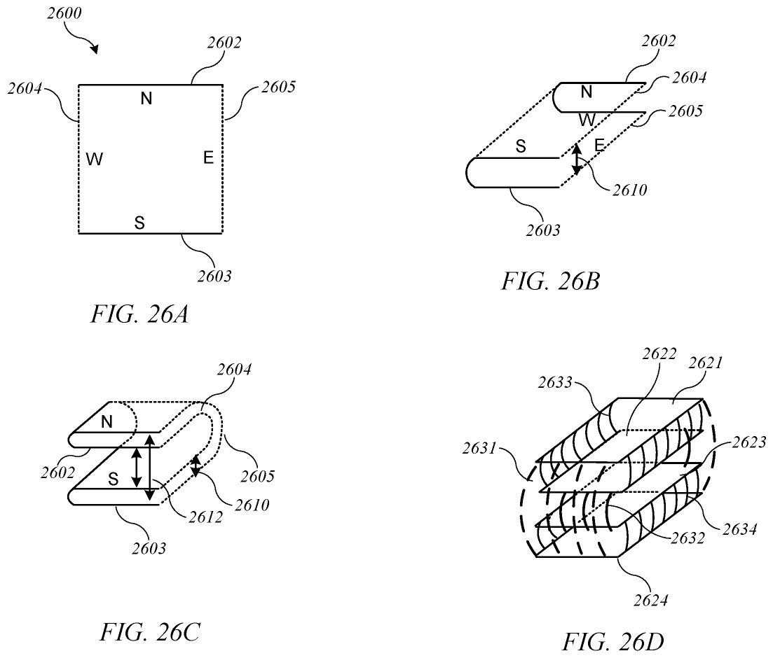

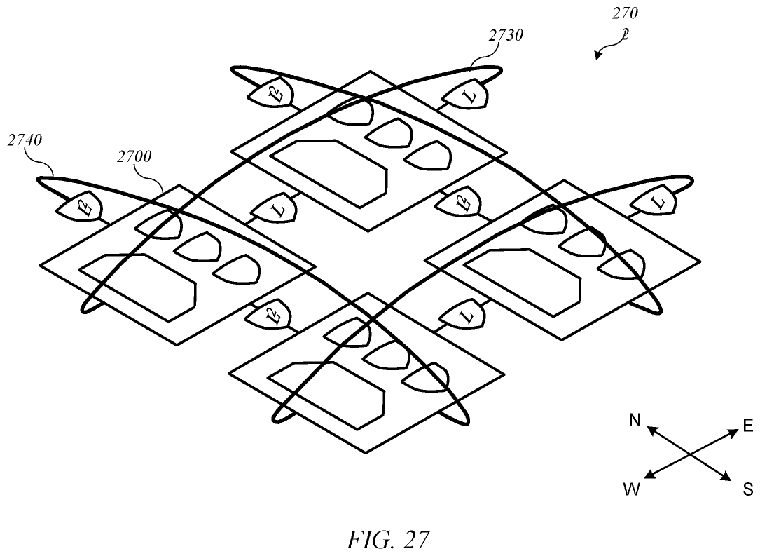

Examples described above use square surface-code patches, in which each logical qubit is mapped to a d×d lattice in a planar layer. However, embodiments are not limited to square surface codes or to planar surface codes. For example, a toric code can be defined by creating periodic boundary conditions in each layer. FIGS. 26A-26D are conceptual illustrations of a toric code with periodic boundary conditions. FIG. 26A shows a planar layer 2600 having boundaries 2602, 2603, 2604, 2605, which can be associated with N, E, W, and S directions in an entanglement space. To create a periodic boundary condition in the E-W direction, fusion operations 2610 can be performed between E qubits of resource states along boundary 2605 and W qubits of resource states along boundary 2604, as shown in FIG. 26B. To create a periodic boundary in the N-S direction, fusion operations 2612 can be performed between N qubits of resource states along boundary 2602 and S qubits of resource states along boundary 2603, as shown in FIG. 26C. FIG. 26D shows how the toric code of FIG. 26C can be mapped to a set of four planar patches 2621, 2622, 2623, 2624, with fusion operations (indicated by curved lines 2631, 2632, 2633, 2634) between resource states at the boundaries of different patches.

According to some embodiments, toric codes can be implemented using a network array of interleaving modules such as interleaving module 1700 (or interleaving module 2400). FIG. 27 shows a simplified schematic diagram of a network array 2702 of interleaving modules according to some embodiments. Network array 2702 can be generally similar to network array 1702, and interleaving modules 2700 can be generally similar to any of the interleaving modules described above. In network array 2702, however, each interleaving module 2700 at the E edge of array 2702 is connected to a corresponding interleaving module at the W edge of array 2702 by a path 2730, and each interleaving module at the N end of array 2702 is connected to a corresponding interleaving module at the S end of array 2702 by a path 2740. With appropriate time delays, generation of a toric code can be implemented, with each interleaving module 2700 generating one of patches 2621-2624 shown in FIG. 26D.

These examples of additional connectivity between interleaving modules are illustrative, and variations and modifications are possible. In various embodiments, connections between spatially separated interleaving modules can facilitate routing of logical qubits within a quantum computer. For instance, some architectures may include different logic units responsible for different types of operations, and logical qubits may need to be moved from one logic unit to another. With non-local spacelike connections between interleaving modules, movement of logical qubits can be performed with enhanced efficiency. The particular type and number of connections between interleaving modules can be adapted to suit a particular architecture and fusion graph topology.

### 7.3. Non-Euclidean Geometry

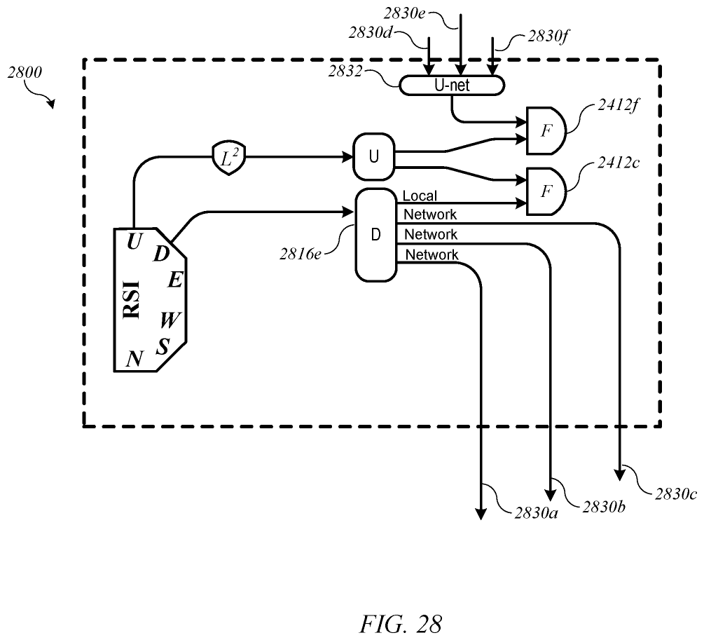

In examples described above, network arrays are formed by connecting interleaving modules such that every interleaving module has a unique neighbor (or in some instances no neighbor) in each of the N, E, W, and S directions. In some embodiments, by adding more selectable routing paths and reconfigurable fusion devices, one can perform network fusion between qubits produced in different (but fixed) combinations of interleaving modules. By way of example, FIG. 28 shows a simplified schematic diagram of an interleaving module 2800 according to some embodiments. Interleaving module 2800 can be similar to interleaving module 2400 of FIG. 24, except that routing switch 2816e provides more than two output paths. A local path delivers the D qubit to local fusion circuit 2412c. The other paths are alternative network paths 2830a-2830c, each of which can be coupled to a different instance of interleaving module 2800. Similarly, an additional “U-net” switch 2832 is provided to select among alternative networked D qubits received via network paths 2830d-2830f. The alternative networked D qubits may be from resource states generated in other interleaving modules 2800. The selected networked D qubit is delivered to network fusion circuit 2412f. Operation can be similar to interleaving module 2400, with the additional routing paths allowing logical qubits to be selectably moved in different directions and/or by different distances between adjacent layers and/or delayed by different numbers of RSI cycles. It should be understood that alternative network paths are not limited to U and D qubits and that any routing switch in an interleaving module can be selectably coupled to any number of network paths. Similarly, switches such as U-net switch 2832 can be provided to select among any number of input network paths.

In some embodiments, one or more routing switches in an interleaving module can allow selection not only among different network paths but also among different local paths that couple to delay lines of different lengths and/or to different reconfigurable fusion circuits within the interleaving module. An appropriate combination of local and network routing paths can enable more complex surface codes and/or other potential efficiencies.

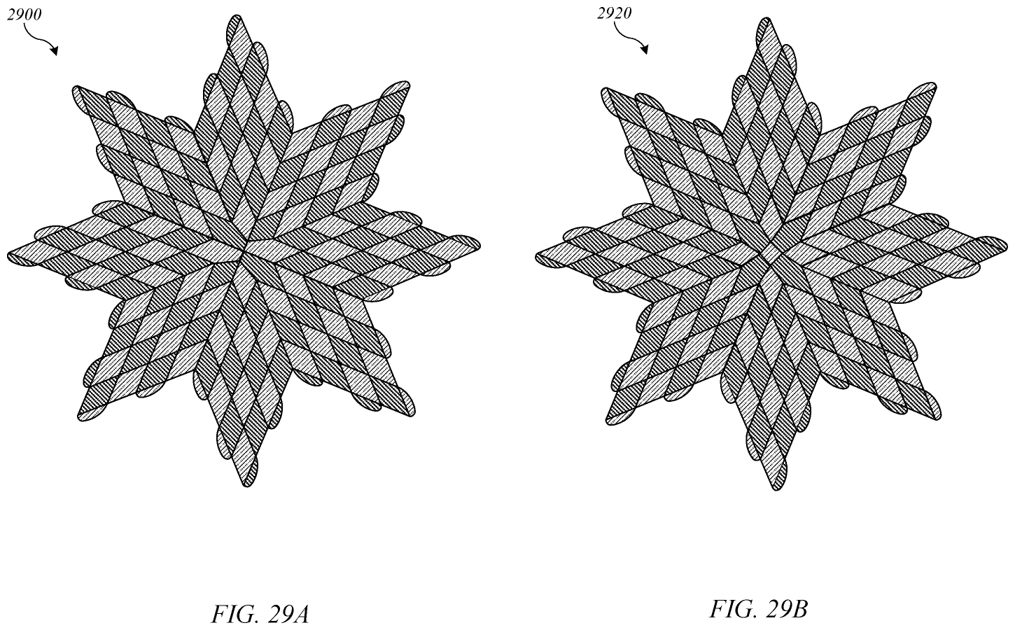

By way of example, FIGS. 29A and 29B show two examples of fusion graphs for stellated surface code patch 2900 and 2920. A stellated surface code patch can be understood as an n-gon generalization of triangular (n=3) and square (n=4) surface code patches. In stellated surface code patch 2900, n=8. For large n, stellated surface code patches use approximately half the number of physical qubits per logical qubit as square surface code patches. However, the shape of stellated surface code patches makes them difficult to implement in a regular two-dimensional array of physical qubits.

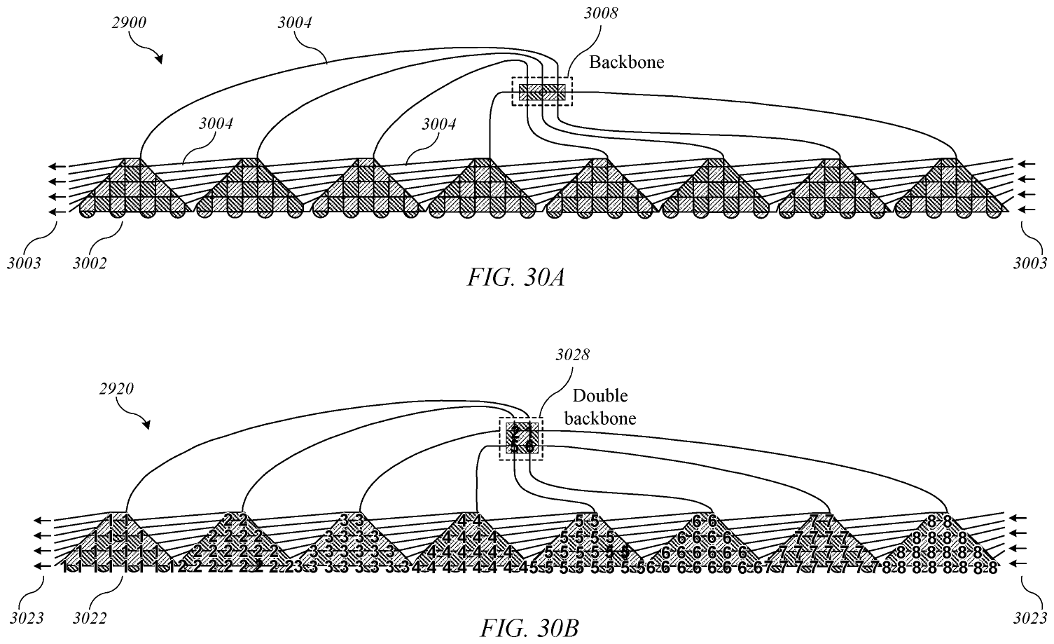

According to some embodiments, interleaving modules with switchable network connections can be used to implement stellated surface code patches. FIGS. 30A and 30B show examples of connectivity structures supporting stellated surface code patches that can be implemented using a network of interleaving modules according to some embodiments. FIG. 30A shows a decomposition of stellated surface code patch 2900 into a triangular truncated lattice pattern 3002 that repeats eight times. Connectivity (fusion operations) between instances of pattern 3002 are shown as lines 3004. It should be understood that the arrows 3003 at the left and right edges indicate a periodic boundary condition. In addition, a “backbone” 3008 (which corresponds to the center portion of stellated surface code 2900) is connected to each instance of pattern 3002.

FIG. 30B shows a decomposition of stellated surface code patch 2920 into a triangular truncated lattice pattern 3022 that repeats eight times. A “double backbone” 3028 connects to each instance of lattice pattern 3022. It should be understood that the arrows 3023 at the left and right edges indicate a periodic boundary condition. In FIG. 30B, interleaving coordinates (numbers 1-8) are assigned to each vertex to suggest an interleaving pattern that can be used to generate stellated surface code patch 2900.

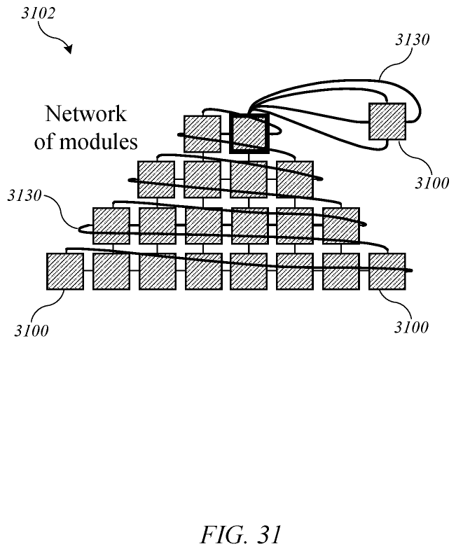

FIG. 31 shows a simplified schematic of a network array 3102 of interleaving modules 3100 that can be used to produce the lattice pattern shown in FIG. 30B according to some embodiments. Each interleaving module 3100 can be similar to interleaving modules described above and can include switchable network connections (e.g., similar to those shown in FIG. 28) to enable the desired connectivity. Lines 3130 connecting interleaving modules 3100 represent selectable network paths between different instances of interleaving module 3100.

It will be appreciated that the various surface topologies described herein are illustrative and that suitably connected interleaving modules can implement a wide variety of surface codes.

### 8. Computing System Implementing FBQC

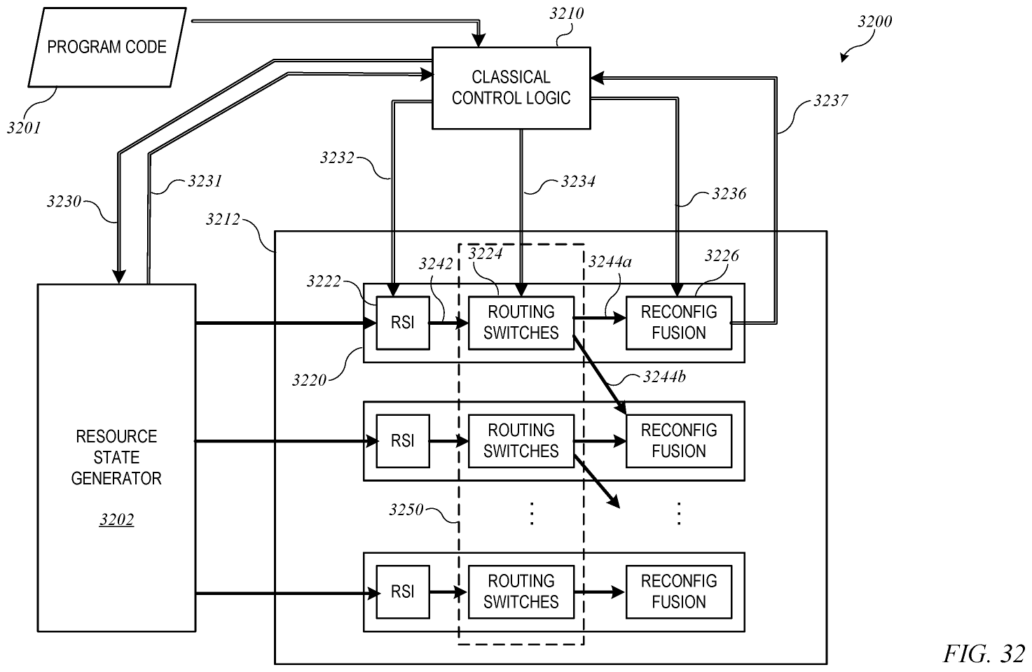

FIG. 32 shows an example system architecture for a quantum computer system 3200 that can implement FBQC according to some embodiments. Using photonic physical qubits, some embodiments of quantum computer system 3200 can generate measurement data reflecting entanglement structures (e.g. fusion graphs) for fault-tolerant FBQC. System 3200 includes classical control logic 3210, a resource state generator 3202, and a network 3212 of interleaving modules 3220. For clarity of illustration, classical signal paths 3232-3237 are shown connected to only one instance of interleaving module 3220. It should be understood that classical control logic 3210 can communicate with components in each instance of interleaving module 3220 in the manner described herein.

Classical control logic 3210 can be implemented as a digital logic circuit with an arrangement of classical logic gates (AND, OR, NOR, XOR, NAND, NOT, etc.), such as a field programmable gate array (FPGA) or system-on-a-chip (SOC) having a programmable processor and memory, or an on-chip hard-wired circuit, such as an application specific integrated circuit (ASIC). In some embodiments, classical control logic 3210 (or portions thereof) can be implemented in an off-chip classical computer having a processor and a memory, and the off-chip classical computer can be programmed to perform some or all of the operations of classical control logic 3210.

In operation, classical control logic 3210 (which can include a classical computer) can receive “program code” 3201 specifying a quantum computation to be executed. For example, the program code can include a machine-readable data file defining a fusion graph as illustrated in figures above. Classical control logic 3210 can read the program code and generate control signals for resource state generator 3202 and interleaving modules 3220 to perform the computation.

Resource state generator 3202 can include any circuit(s) or other components capable of generating resource states, which can be systems of photonic qubits (e.g., using dual-rail encoding as described above). For instance, resource state generator 3202 can be an implementation of qubit entangling system 1000 of FIG. 10. In various embodiments, resource state generator 3202 can generate 6-ring resource states or other resource states having an appropriate number of qubits and entanglement pattern. In some embodiments, resource state generator 3202 can be reconfigurable to generate resource states having different entanglement patterns during different operating cycles, and classical control unit 3210 can send classical control signals via signal path 3230 to resource state generator 3202, e.g., to start and stop resource state generation and/or to select the number or type of resource states to generate during each operating cycle. In some embodiments, resource state generator 3202 may succeed in generating the desired number of resource states for a given operating cycle with probability less than 1, and resource state generator 3202 can provide classical heralding signals to classical control logic 3210 via signal path 3231. The classical heralding signals can include, e.g., signals from detectors associated with heralded photon sources and/or entanglement-generating circuits such as the Bell state generator and/or fusion circuits described above. Classical control logic 3210 can use heralding signals received via signal path 3231 to determine whether each instance of resource state generation succeeded or failed. For instance, particular patterns of presence or absence of photons in detectors can be indicative of success or failure. In some embodiments, resource state generator 3202 can be maintained at cryogenic temperature (e.g., 4 K) while interleaving modules 3220 can operate at higher temperatures (e.g., 300 K). Resource state generator 3202 can be coupled to interleaving module network 3212 using optical fiber or other waveguides and can provide one resource state per operating cycle to each interleaving module 3220.

Each interleaving module 3220 can be an instance of interleaving module 1700 of FIG. 17, interleaving module 2400 of FIG. 24, or any other interleaving module, including any of the examples described above. As shown in FIG. 32, each interleaving module 3220 can include an RSI circuit 3222, a set of routing switches 3224, and a set of reconfigurable fusion circuits 3226. Details of couplings between components within each interleaving module 3220 and between interleaving modules 3220 are not shown in FIG. 32. It should be understood that any of the coupling schemes described above or other schemes that support execution of fusion graphs having a particular topological form can be used.

Each RSI 3222 can receive resource states as described above. In some embodiments, the RSIs 3222 can operate autonomously, with no data input required, and each RSI 3222 circuit can receive one resource state per operating cycle (also referred to as an RSI cycle or clock cycle). Any of the RSI circuit configurations described above or other configurations can be used. If desired, resource state generation can be implemented internally to each RSI 3222 rather than in a separate resource state generator 3202.

Optical fibers (or other waveguides) 3242 can be used to couple each RSI 3222 to its associated routing switches 3224. In some embodiments, the optical fibers (or other waveguides) 3242 can introduce appropriate relative delay into the propagation paths of different qubits of the same resource state. For example, optical fibers 3242 can implement delay lines 1714a-1714c shown in FIG. 17.

Classical control logic 3210 can generate control signals for routing switches 3224 in each instance of interleaving module 3220 and send the control signals to routing switches 3224 via classical signal path 3234. As described above, in some embodiments routing switches 3224 can route qubits from RSI 3222 to either a local path 3244a or a network path 3244b. Local path 3244a and network path 3244b transfer the qubits to reconfigurable fusion circuits 3226. As described above, local path 3244a connects to reconfigurable fusion circuit 3226 in the same interleaving module 3220 while network path 3244a connects to reconfigurable fusion circuit 3226 in a different interleaving module 3220. For clarity of illustration, FIG. 32 shows one local path and one network path; however, it should be understood that multiple paths of either type can be provided and that the routing paths for different qubits of a given resource state can be selected independently of each other. In some embodiments, classical control logic 3210 can select routing paths and corresponding control signals for routing switches 3224 based on a fusion graph representation of a quantum computation. An example of cycle-by-cycle setting of routing switches to execute a fusion graph is described above with reference to FIGS. 19A, 19B and 20. Other selection logic can also be implemented.

In some embodiments, the set of all routing switches 3224 across all instances of interleaving module 3212 can provide a fusion network router 3250. In some embodiments, fusion network router 3250 can be a reconfigurable fusion network router that supports different layer topologies, including examples described above, without requiring changes to the underlying hardware. For instance, as described above with reference to FIG. 28, alternative network routing paths 3244b can be provided between a routing switch 3224 in one interleaving module 3220 and reconfigurable fusion circuits 3226 in each of two or more other interleaving modules 3220. In various embodiments, network routing paths can be provided between any routing switch and any reconfigurable fusion circuit. In an extreme case, every routing switch can be connected to every reconfigurable fusion circuit; however, for fusion graphs having regular lattice structures (as in examples described above), not all possible connections are useful connections, and the set of local paths 3244a and network paths 3244b in a given implementation can be based on the fusion graph topologies that system 3200 is intended to support.

Classical control logic 3210 can also generate control signals for reconfigurable fusion circuits 3226 in each instance of interleaving module 3220 and send the control signals to reconfigurable fusion circuits 3226 via classical signal path 3236. As described above, in some embodiments each reconfigurable fusion circuit 3226 can be an implementation of circuit 1400 of FIG. 14D that operates on two input qubits. Circuit 1400 can be controlled by providing classical control signals to select the state of switches 1410 and 1412, which has the effect of routing the two input qubits to the desired measurement operation(s), which can include either a two-qubit joint measurement operation (e.g., a type II fusion operation) or individual qubit measurements (e.g., in a particular Pauli basis) on each of the two input qubits. In some embodiments, classical control logic can select the desired measurement operations based on a fusion graph representation (or other representation) of a quantum computation. An example of cycle-by-cycle selection of measurement operations to execute a fusion graph is described above with reference to FIGS. 19A, 19B and 20. Other selection logic can also be implemented.

Measurement outcome data (also referred to as “measurement results”) generated by reconfigurable fusion circuit 3226 can be provided to classical control logic 3210 via classical signal path 3237. As described above, in some embodiments, the measurement outcome data can include photon counts (or a binary-valued signal indicating presence or absence of a photon) for each detector in the reconfigurable fusion circuit or for the detector(s) on the active path(s) in a given cycle.

Classical control logic 3210 can decode the measurement outcome data received via classical control path 3237 to determine a result of the quantum computation. In some embodiments, classical control logic 3210 can also incorporate the heralding signals received via signal paths 3233 into the decoding. Further description of decoding operations that can be implemented in classical control logic 3210 can be found in above-referenced WO 2021/155289.

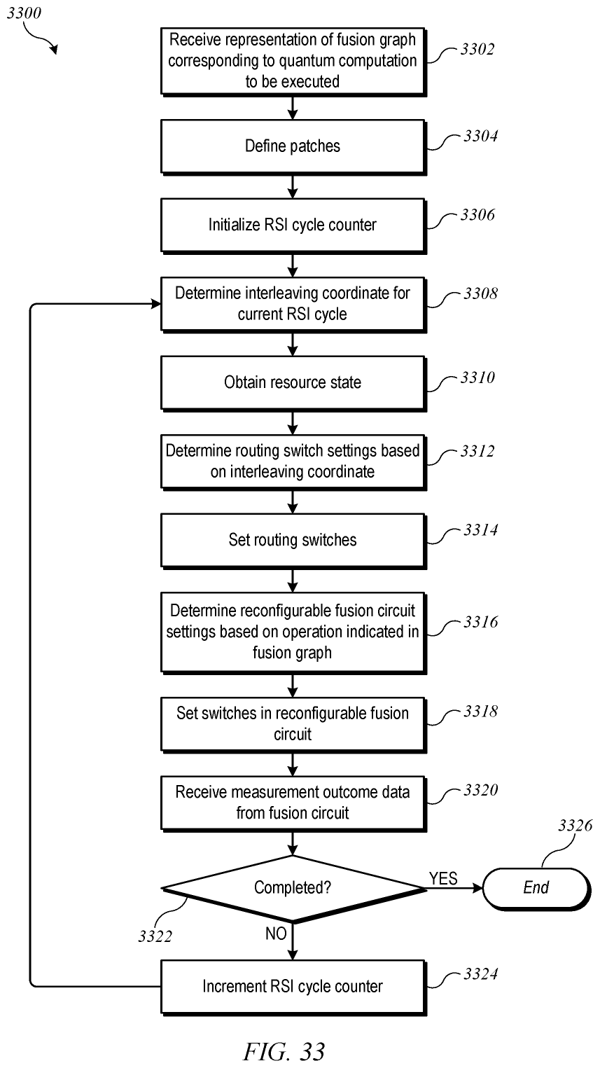

FIG. 33 is a flow diagram of a process 3300 for operating an array of interleaving modules (e.g., interleaving modules 3220) according to some embodiments. Process 3300 can be implemented, e.g., in classical control logic 3210. At block 3302, classical control logic 3210 can obtain a machine-readable representation of a fusion graph corresponding to a quantum computation (or other operation on logical qubits) to be executed. At block 3304, classical control logic 3210 can define patches of the fusion graph to be generated by each interleaving module 3210. For instance, as described above, if the interleaving length is L, each layer of the fusion graph can be divided into patches of size L², and each patch can be assigned to a different instance of interleaving module 3210. At block 3306, classical control logic 3210 can initialize an RSI cycle counter. The RSI cycle counter can be, for example, a conventional clock circuit that operates at a rate corresponding to the rate at which resource states are provided to RSIs 3222. At block 3308, classical control logic 3210 can determine an interleaving coordinate for the current RSI cycle. One example of determining interleaving coordinates is described above with reference to FIG. 19A.

At block 3310, each RSI 3222 can obtain a resource state. For example, a signal generated by classical control logic 3210 in response to the RSI cycle counter can trigger generation of resource states in resource state generator 3202, and resource state generator 3202 can provide a resource state to each RSI 3222. At block 3312, classical control logic 3210 can determine setting for routing switches 3224 based on the interleaving coordinate. For example, as described above, classical control logic 3210 can determine whether each qubit should be directed to a local fusion circuit or a network fusion circuit based on the interleaving coordinate (or position of the resource state within a patch). At block 3314, classical control logic 3210 can generate control signals to routing switches 3224 to route the qubits into local or network paths based on the determinations at block 3312. At block 3316, classical control can determine switch settings for reconfigurable fusion circuits 3226 based on the measurement operation indicated in the fusion graph. For example, as described above, classical control logic 3210 can determine from the fusion graph whether to perform a fusion operation or single-qubit measurements (and, if applicable, which single-qubit measurements to perform). At block 3318, classical control logic 3210 can generate control signals to reconfigurable fusion circuits 3226 to implement the settings determined at block 3316. At block 3320, classical control logic 3210 can receive measurement outcome data from reconfigurable fusion circuits 3226. Measurement outcome data can be used as described above.

At block 3322, classical control logic 3210 can determine whether the quantum computation has been completed, e.g., whether the entire fusion graph has been executed. If not, then at block 3324, the RSI cycle counter can be incremented, and process 3300 can return to block 330 to determine the next interleaving coordinate and process the next set of resource states. Process 300 can continue to iterate until the computation is completed, ending at block 3326. It should be understood that all instances of interleaving module 3220 can be operated in parallel, with photons propagating between different interleaving modules 3220 based on the settings of routing switches 3224. Delay lines within or between interleaving modules can be provided so that qubits from different resource states arrive at reconfigurable fusion circuits 3226 with the correct relative timing to execute the fusion graph.

System 3200 of FIG. 32 and process 3300 of FIG. 33 are illustrative, and variations and modifications are possible. Blocks shown separately can be combined, or a single block can be implemented using multiple distinct components or operators. Order of operations can be varied to the extent that logic permits, and operations described as sequential can be performed concurrently. Interleaving modules 3200 can be implemented according any of the interleaving module arrays described above or variations or modifications thereof.

System 3200 is just one example of a quantum computer systems that can incorporate interleaving modules as described herein to perform operations on logical qubits or other operations that can be defined using fusion graphs, including operations related to quantum computation, quantum communication, and other applications. Those skilled in the art with access to this disclosure will appreciate that many different systems can be implemented. Further, determination of interleaving coordinates and operations to be performed for a given interleaving coordinate can be based on a fusion graph or any other input that specifies a set of operations to be performed on a set of resource states. Accordingly, interleaving modules can be used in a variety of applications, including but not limited to FBQC.

### 9. Additional Embodiments

The foregoing examples of interleaving modules and processes are illustrative and can be modified as desired. The use of directional labels (e.g., N, E, W, S, U, D) is for convenience of description and should be understood as referring to entanglement space, not as requiring or implying a particular physical arrangement of components or physical qubits. All numerical examples are for purposes of illustration and can be modified. In addition, while layers and patches are described with reference to square numbers, it should be understood that non-square layers and/or non-square patches can also be used. For example, patches or layers can be rectangular. Triangular patches or layers (or patches or layers having other shapes) can also be generated, e.g., by varying the number of resource states per row. Further, while examples described above assume that all instances of a resource state have the same entanglement pattern, such uniformity is not required. For instance, in some embodiments, resource state generators can be reconfigurable to generate resource states having different entanglement patterns in different clock cycles. In addition, resource state generators may operate in a non-deterministic manner, and this may introduce stochastic variation among resource states.

In some embodiments, resource state generation is non-deterministic, meaning that in a given operating cycle, a particular resource state generator might or might not succeed in producing the desired resource state. Accordingly, some embodiments can provide a number (M) of resource state generator circuits. If N is the total number of instances of an interleaving module, then M can be greater than N, and M can be chosen to provide a sufficiently high probability that at least N resource states will be generated during a given operating cycle. (“Sufficiently high probability” in a given implementation can be determined based on the particular implementation of fault tolerance.) Active multiplexing techniques, examples of which are known in the art, can be used to select N of the M resource state generators on each clock cycle to deliver resource states to N different instances of the interleaving module. Thus, each interleaving module can but need not have its own dedicated instance(s) of a resource state generator.

Embodiments described above provide examples of systems and methods for generating entanglement structures that can be used to perform FBQC. However, embodiments are not limited to FBQC and may be used in a variety of contexts, including measurement-base quantum computing (MBQC), other quantum computing systems, quantum communication systems, and any other context where it is desirable to perform measurements on a system involving a large number of physical qubits having a specified entanglement structure. The particular size (number of qubits) and entanglement pattern of the resource states can be varied as appropriate for a particular use case. In addition or instead, the number of resource states and entanglement geometry between resource states can be varied according to the particular use-case. For instance, while the foregoing description uses examples of fusion graphs having three-dimensional geometry, fusion graphs having more or fewer dimensions can be executed by providing an appropriate source of resource states and a suitably connected network of interleaving modules.

Further, embodiments described above include references to specific materials and structures (e.g., optical fibers), but other materials and structures capable of producing, propagating, and operating on photons can be substituted. As noted above, resource states can be generated using photonic circuits, or a resource state can be created using matter-based qubits, after which an appropriate transducer technology can be applied to swap the state of the matter-based qubits onto a photonic state. Interleaving as described herein exploits the propagation of photonic qubits, and similar techniques may be applicable to systems of physical qubits that are realized using entities that propagate along well-defined hardware paths.

It should be understood that the resource states, interleaving modules, and networks of interleaving modules shown herein are illustrative and that variations and modifications are possible. In some embodiments, resource states having different sizes and/or entanglement patterns can be used at different vertex positions within a fusion graph, and position-dependent selection of resource state configurations can be used to implement logical operations. Further, while FBQC is an example use-case for the interleaving techniques described herein, it should be understood that interleaving techniques are generally applicable to construction of larger-scale entangled quantum systems from small-scale entangled quantum systems (resource states). Accordingly, interleaving modules and techniques of the kind described herein can be applied in a variety of contexts, including but not limited to FBQC and other quantum computing systems.

Classical control logic can be implemented on-chip with the waveguides, beam splitters, detectors and/or and other photonic circuit components or off-chip as desired.

It should be understood that all numerical values used herein are for purposes of illustration and may be varied. In some instances ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure can be modified or omitted and that other elements not shown or described can be added.

This disclosure provides a description of the claimed invention with reference to specific embodiments. Those skilled in the art with access to this disclosure will appreciate that the embodiments are not exhaustive of the scope of the claimed invention, which extends to all variations, modifications, and equivalents.

1. An apparatus comprising:
a resource state interconnect having a plurality of output paths to output a resource state during each of a plurality of operating cycles, wherein each resource state is a quantum system of multiple entangled qubits, wherein different qubits of the resource state are output on a different ones of the output paths;
a plurality of routing switches, each routing switch having an input path coupled to a different one of the output paths of the resource state interconnect and a plurality of output paths, wherein each routing switch is configured to receive a different qubit of the resource state on the input path and to selectably route the received qubit to one of the plurality of output paths;
a plurality of reconfigurable fusion circuits, each of the plurality of reconfigurable fusion circuits being configured to receive two input qubits and to selectably perform either a projective entangling measurement between the two input qubits or one of a plurality of single-qubit measurements on each of the two input qubits, thereby producing measurement outcome data;
a plurality of delay lines having different delay lengths, wherein different delay lines are coupled between respective output paths of the resource state interconnect and respective input paths of different ones of the routing switches; and
a plurality of routing paths including a plurality of local routing paths and a plurality of network routing paths, wherein the local routing paths are coupled between the routing switches and the reconfigurable fusion circuits such that each of the routing switches is coupled to at least one of the reconfigurable fusion circuits and wherein each of the network routing paths exits the apparatus.

2. The apparatus of claim 1 wherein each of the network routing paths couples to a reconfigurable fusion circuit in another instance of the apparatus.

3. The apparatus of claim 1 wherein each of the reconfigurable fusion circuits is configured such that the plurality of single-qubit measurements includes at least two of:
a Pauli X measurement;
a Pauli Y measurement;
a Pauli Z measurement; or
a phase rotation of e^{-iπ/8} followed by a Pauli Z measurement.

4. (canceled)

5. The apparatus of claim 1 wherein the plurality of delay lines includes:
a first delay line having a delay length corresponding to one operating cycle;
a second delay line having a delay length corresponding to a number (L) of operating cycles, wherein L is greater than 1; and
a third delay line having a delay length corresponding to a number L² of operating cycles.

6. The apparatus of claim 5 wherein:
the plurality of reconfigurable fusion circuits includes:
a first local fusion circuit;
a second local fusion circuit;
a third local fusion circuit;
a first networked fusion circuit; and
a second networked fusion circuit;
the plurality of network paths includes a first network path and a second network path; and
the plurality of routing switches includes:
a first routing switch configured to selectably direct a first qubit of each resource state from the first delay line to either a first input of the first local fusion circuit or a first input of the first networked fusion circuit;
a second routing switch configured to selectably direct a second qubit of each resource state to either a second input of the first local fusion circuit or the first network path;
a third routing switch configured to selectably direct a third qubit of each local resource state from the second delay line to either a first input of the second local fusion circuit or a first input of the second networked fusion circuit; and
a fourth routing switch configured to selectably direct a fourth qubit of each resource state to either a second input of the second local fusion circuit or the second network path.

7. (canceled)

8. (canceled)

9. The apparatus of claim 5 wherein:
the plurality of reconfigurable fusion circuits includes:
a first local fusion circuit;
a second local fusion circuit;
a third local fusion circuit;
a fourth local fusion circuit;
a first networked fusion circuit; and
a second networked fusion circuit;
the plurality of network paths includes a first network path and a second network path; and
the plurality of routing switches includes:
a first routing switch configured to selectably direct a first qubit of each resource state from the first delay line to one of a first input of the first local fusion circuit, a first input of the first networked fusion circuit, or a fourth delay line coupled to a first input of the fourth local fusion circuit, wherein the fourth delay line has a delay length corresponding to one operating cycle;
a second routing switch configured to selectably direct a second qubit of each resource state to one of a second input of the first local fusion circuit, the first network path, or a second input of the fourth local fusion circuit;
a third routing switch configured to selectably direct a third qubit of each local resource state from the second delay line to either a first input of the second local fusion circuit or a first input of the second networked fusion circuit; and
a fourth routing switch configured to selectably direct a fourth qubit of each resource state to either a second input of the second local fusion circuit or the second network path.

10. The apparatus of claim 9 wherein the plurality of routing paths includes:
a first routing path to direct a fifth qubit of each resource state to the third delay line, wherein an output of the third delay line is coupled to a first input of the third local fusion circuit; and
a second routing path to direct a sixth qubit of each resource state to a second input of the third local fusion circuit.

11. The apparatus of claim 9 wherein
the plurality of reconfigurable fusion circuits further includes a third networked fusion circuit;
the plurality of network paths further includes a third network path; and
the plurality of routing switches further includes:
a fifth routing switch configured to selectably direct a fifth qubit of each resource state to either a first input of the third local fusion circuit or a first input of the third networked fusion circuit; and
a sixth routing switch configured to selectably direct a sixth qubit of each resource state to either a second input of the third local fusion circuit or the third network path.

12. (canceled)

13. The apparatus of claim 5 wherein:
the plurality of reconfigurable fusion circuits includes:
a first local fusion circuit; and
a first networked fusion circuit;
the plurality of network paths includes a first group of network paths, the first group of network paths including two or more network paths; and
the plurality of routing switches includes:
a first routing switch configured to selectably direct a first qubit of each resource state from one of the delay lines to either a first input of the first local fusion circuit or a first input of the first networked fusion circuit; and
a second routing switch configured to selectably direct a second qubit of each resource state to a second input of the first local fusion circuit or to any one network path in the first group of network paths.

14. (canceled)

15. (canceled)

16. (canceled)

17. (canceled)

18. (canceled)

19. The apparatus of claim 1 wherein each of the reconfigurable fusion circuits is configured such that the projective entangling measurement is a type II fusion operation that provides a joint XX measurement outcome and a joint ZZ measurement outcome.

20. The apparatus of claim 1 further comprising:
classical control logic coupled to the plurality of reconfigurable fusion circuits and to the plurality of routing switches, the classical control logic being configured to select operations for each of the plurality of reconfigurable fusion circuits and the plurality of routing switches.

21. (canceled)

22. (canceled)

23. (canceled)

24. The apparatus of claim 1 wherein the resource state interconnect includes a plurality of waveguides coupled between an external source of resource states and the output paths of the resource state interconnect.

25. (canceled)

26. A system comprising:
a network of interleaving modules, wherein each interleaving module includes:
a resource state interconnect having a plurality of output paths to output a resource state during each of a plurality of operating cycles, wherein each resource state is a quantum system of multiple entangled qubits, wherein different qubits of the resource state are output on a different ones of the output paths;
a plurality of routing switches, each routing switch having an input path coupled to a different one of the output paths of the resource state interconnect and a plurality of output paths, wherein each routing switch is configured to receive a different qubit of the resource state on the input path and to selectably route the received qubit to one of the plurality of output paths;
a plurality of reconfigurable fusion circuits, each of the plurality of reconfigurable fusion circuits being configured to receive two input qubits and to selectably perform either a projective entangling measurement between the two input qubits or one of a plurality of single-qubit measurements on each of the two input qubits, thereby producing measurement outcome data;
a plurality of delay lines having different delay lengths, wherein different delay lines are coupled between respective output paths of the resource state interconnect and respective input paths of different ones of the routing switches; and
a plurality of routing paths including a plurality of local routing paths and a plurality of network routing paths, wherein the local routing paths are coupled between the routing switches and the reconfigurable fusion circuits such that each of the routing switches is coupled to at least one of the reconfigurable fusion circuits and wherein each of the network routing paths is coupled to a reconfigurable fusion circuit in a different interleaving module within the network; and
classical control logic coupled to the network of interleaving modules and configured to control the routing switches and the reconfigurable fusion circuits and to receive classical data signals representing the measurement outcome data from the reconfigurable fusion circuits.

27. (canceled)

28. (canceled)

29. The system of claim 26 wherein the plurality of delay lines in each interleaving module includes:
a first delay line having a delay length corresponding to one operating cycle;
a second delay line having a delay length corresponding to a number (L) of operating cycles, wherein L is greater than 1; and
a third delay line having a delay length corresponding to a number L² of operating cycles.

30. (canceled)

31. (canceled)

32. (canceled)

33. The system of claim 29 wherein, in the at least one of the interleaving modules:
the plurality of reconfigurable fusion circuits includes:
a first local fusion circuit;
a second local fusion circuit;
a third local fusion circuit;
a fourth local fusion circuit;
a first networked fusion circuit; and
a second networked fusion circuit;
the plurality of network paths includes a first network path and a second network path; and
the plurality of routing switches includes:
a first routing switch configured to selectably direct a first qubit of each resource state from the first delay line to one of a first input of the first local fusion circuit, a first input of the first networked fusion circuit, or a fourth delay line coupled to a first input of the fourth local fusion circuit, wherein the fourth delay line has a delay length corresponding to one operating cycle;
a second routing switch configured to selectably direct a second qubit of each resource state to one of a second input of the first local fusion circuit, the first network path, or a second input of the fourth local fusion circuit;
a third routing switch configured to selectably direct a third qubit of each local resource state from the second delay line to either a first input of the second local fusion circuit or a first input of the second networked fusion circuit; and
a fourth routing switch configured to selectably direct a fourth qubit of each resource state to either a second input of the second local fusion circuit or the second network path.

34. (canceled)

35. (canceled)

36. (canceled)

37. The system of claim 29 wherein, in at least one of the interleaving modules:
the plurality of reconfigurable fusion circuits includes:
a first local fusion circuit; and
a first networked fusion circuit;
the plurality of network paths includes a first group of network paths, the first group of network paths including two or more network paths, wherein each of the network paths in the first group of network paths is coupled to a different interleaving module in the network of interleaving modules; and
the plurality of routing switches includes:
a first routing switch configured to selectably direct a first qubit of each resource state from one of the delay lines to either a first input of the first local fusion circuit or a first input of the first networked fusion circuit; and
a second routing switch configured to selectably direct a second qubit of each resource state to a second input of the first local fusion circuit or to any one network path in the first group of network paths,
wherein the at least one of the interleaving modules further includes an input switch having a plurality of external input paths and an output path coupled to a second input of the first networked fusion circuit, wherein each of the external input paths is coupled to a network path of a different interleaving module in the network of interleaving modules.

38. (canceled)

39. (canceled)

40. (canceled)

41. (canceled)

42. (canceled)

43. (canceled)

44. The system of claim 26 wherein the interleaving modules are connected to form an array of dimension nₓ×n_{y}=N where nₓ and n_{y} are integer numbers.

45. (canceled)

46. The system of claim 26 wherein the classical control logic is further configured to determine a sequence of control settings for the routing switches and the reconfigurable fusion circuits based at least in part on a fusion graph representing a quantum computation to be executed.

47. The system of claim 26 further comprising a plurality of resource state generator circuits to generate resource states and to provide the resource states to the resource state interconnects of the interleaving modules.

48. (canceled)

49. (canceled)

50. (canceled)

51. A method comprising:
determining a current cycle counter;
determining an interleaving coordinate based at least in part on the current cycle counter;
obtaining a resource state, wherein the resource state comprises a system of entangled photonic qubits;
determining, based at least in part on the interleaving coordinate, a plurality of routing switch settings for a plurality of routing switches arranged such that each routing switch receives one of the photonic qubits of the resource state, wherein at least some outputs of each of the routing switches are coupled to delay lines;
determining, based at least in part on the interleaving coordinate, a plurality of operation selections for a plurality of reconfigurable fusion circuits, each of the plurality of reconfigurable fusion circuits being configured to receive two input qubits from two of the routing switches, wherein at least one of the two input qubits is received via one of the delay lines, and to selectably perform either a projective entangling measurement operation between the two input qubits or one of a plurality of single-qubit measurements on each of the two input qubits, thereby producing measurement outcome data;
sending control signals to the routing switches based on the routing switch settings;
sending control signals to the reconfigurable fusion circuits based on the operation selections; and
receiving the measurement outcome data from the reconfigurable fusion circuits.

52. The method of claim 51 further comprising:
incrementing the current cycle counter; and
repeating the acts of determining an interleaving coordinate, obtaining a resource state, determining the routing switch settings, determining the operation selections, sending the control signals to the routing switches and the reconfigurable fusion circuit, and receiving the measurement outcome data.

53. The method of claim 52 further comprising:
receiving data representing a fusion graph that defines a set of measurement operations to be performed on qubits of a plurality of resource states,
wherein the interleaving coordinate and the routing switch settings are determined based in part on the fusion graph and in part on the cycle counter.

54. The method of claim 51 wherein the plurality of single-qubit measurements includes at least two of:
a Pauli X measurement;
a Pauli Y measurement;
a Pauli Z measurement; and
a phase rotation of e^{-iπ/8} followed by a Pauli Z measurement.

55. (canceled)

56. The method of claim 51 wherein the projective entangling measurement operation includes a destructive measurement on both of the input qubits.

57. (canceled)
